(19) United States
(12) Patent Application Publication
(10) Pub. No.: US 2023/0062417 A1
(43) Pub. Date: Mar. 2, 2023

(54) CARTRIDGE INCLUDING DEVELOPING DEVICE AND TONER CONTAINER BETWEEN WHICH TONER CAN BE CIRCULATED

(71) Applicant: BROTHER KOGYO KABUSHIKI KAISHA, Nagoya-shi (JP)

(72) Inventors: Yasutada KATO, Nagoya (JP); Yasuo FUKAMACHI, Nagoya (JP); Shougo SATO, Seto (JP); Koji OGAWA, Owariasahi (JP)

(73) Assignee: BROTHER KOGYO KABUSHIKI KAISHA, Nagoya-shi (JP)

(21) Appl. No.: 17/821,825

(22) Filed: Aug. 24, 2022

(30) Foreign Application Priority Data
Aug. 27, 2021 (JP) 2021-139404
Oct. 26, 2021 (JP) 2021-174719
Oct. 28, 2021 (JP) 2021-176920

(51) Int. Cl. G03G 21/18; G03G 21/00; G03G 15/08

(52) U.S. Cl. CPC G03G 21/1814; G03G 21/0005; G03G 15/0887

(57) ABSTRACT

A cartridge includes: a photosensitive drum; a drum cleaner for cleaning the photosensitive drum; a toner pipe for conveying collected toner; a toner container storing therein toner; and a developing device for supplying toner in the toner container to the photosensitive drum. The cartridge is detachably attachable to an image forming apparatus. The collected toner is toner removed from the photosensitive drum by the drum cleaner. The developing device includes a developing housing for storing therein toner supplied from the toner container and the collected toner conveyed by the toner pipe. The toner container has: a toner discharge port for discharging toner stored in the toner container; and a returned toner receiving port for receiving toner returned from the developing device. The developing housing has: a toner receiving port for receiving toner discharged from the toner discharge port; and a toner return port for returning toner to the toner container.

### REFERENCE TO RELATED APPLICATIONS

This application claims priorities from Japanese Patent Application No. 2021-139404 filed Aug. 27, 2021, Japanese Patent Application No. 2021-174719 filed Oct. 26, 2021, and Japanese Patent Application No. 2021-176920 filed Oct. 28, 2021. The entire contents of the priority applications are incorporated herein by reference.

### BACKGROUND ART

There has been conventionally known a process cartridge including a drum cartridge and a toner cartridge. The drum cartridge includes a photosensitive drum, a developing device, a cleaner, and a conveying pipe. The toner cartridge includes a waste toner storage part and a toner storage part. The cleaner removes toner from the peripheral surface of the photosensitive drum. The conveying pipe conveys the toner that has been removed by the cleaner. The waste toner storage part stores therein the toner that has been conveyed through the conveying pipe. The toner storage part stores therein toner to be supplied to the photosensitive drum.

### DESCRIPTION

In a conventional image forming apparatus, there is a demand for increasing the capacity of the toner storage part while suppressing an increase in the entire size of the process cartridge.

In view of the foregoing, a cartridge and an image forming apparatus in which the capacity of the toner storage part can be increased while suppressing an increase in the entire size of the cartridge.

In order to attain the above and other object, the present disclosure provides a cartridge attachable to and detachable from an image forming apparatus. The cartridge includes a photosensitive drum, a drum cleaner, a toner pipe, a toner container, and a developing device. The photosensitive drum is rotatable about a first axis extending in a first direction. The drum cleaner is configured to clean the photosensitive drum. The toner pipe is a pipe for conveying collected toner. The collected toner is toner that has been removed from the photosensitive drum by the drum cleaner. The toner container is configured to store therein toner including the collected toner conveyed by the toner pipe. The developing device is configured to supply toner stored in the toner container to the photosensitive drum. The developing device includes a developing housing and a developing roller. The developing housing is configured to store therein toner supplied from the toner container and the collected toner conveyed by the toner pipe. The developing roller is rotatably supported by the developing housing. The toner container has a toner discharge port and a returned toner receiving port. The toner discharge port is a port for discharging toner stored in the toner container. The returned toner receiving port is a port for receiving returned toner. The returned toner is toner that is returned from the developing device to the toner container. The developing housing has a toner receiving port and a toner return port. The toner receiving port is a port for receiving toner discharged from the toner discharge port. The toner return port is a port for returning toner to the toner container.

According to another aspect, the present disclosure provides a cartridge attachable to and detachable from an image forming apparatus. The cartridge includes a photosensitive drum, a drum cleaner, a toner pipe, a toner container, and a developing device. The photosensitive drum is rotatable about a first axis extending in a first direction. The drum cleaner is configured to clean the photosensitive drum. The toner pipe is a pipe for conveying collected toner. The collected toner is toner that has been removed from the photosensitive drum by the drum cleaner. The toner container is configured to store therein toner including the collected toner conveyed by the toner pipe. The developing device is configured to supply toner stored in the toner container to the photosensitive drum. The developing device includes a developing housing and a developing roller. The developing housing is configured to store therein toner supplied from the toner container and the collected toner conveyed by the toner pipe. The developing roller is rotatably supported by the developing housing. The toner container has a toner passage port. The toner passage port is a port both for discharging toner stored in the toner container and for receiving returned toner. The returned toner is toner that is returned from the developing device to the toner container. The developing housing has a developing passage port. The developing passage port is a port both for receiving toner discharged from the toner passage port and for returning toner to the toner passage port.

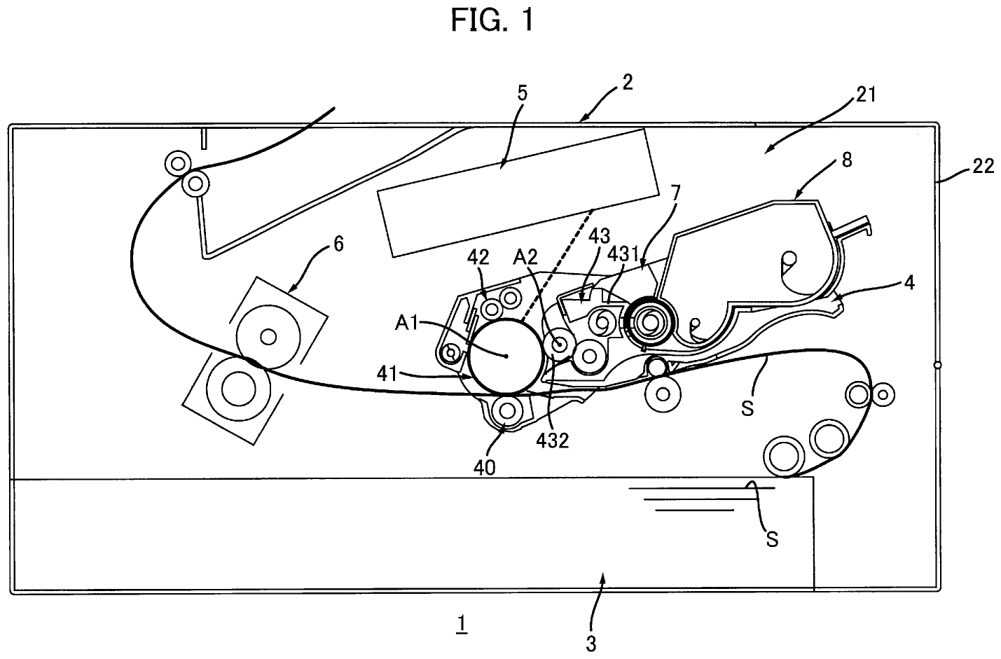

FIG. 1 is an outline view illustrating the structure of an image forming apparatus.

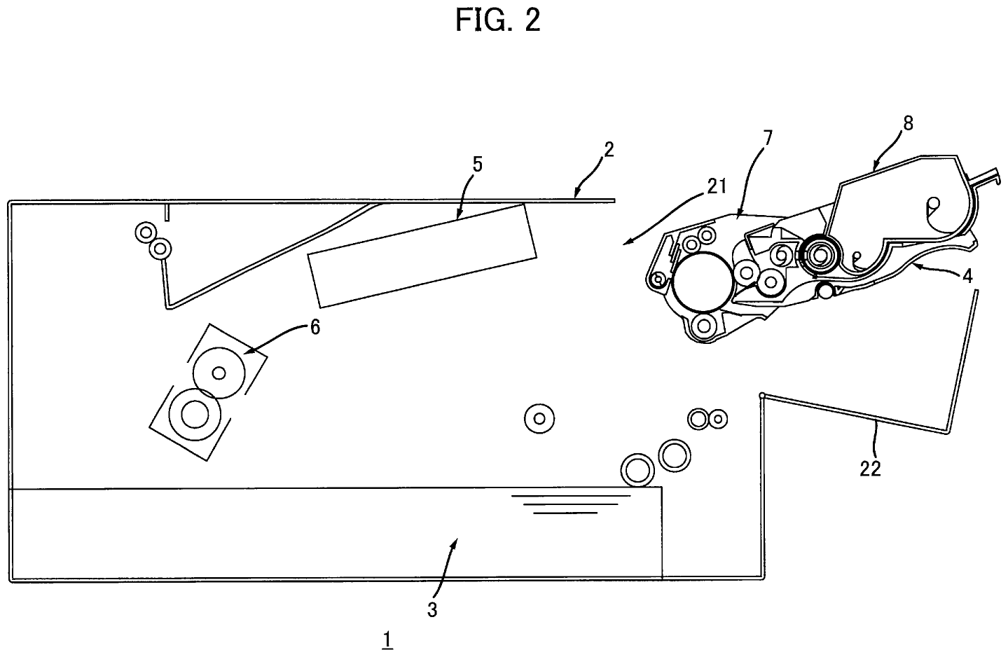

FIG. 2 is a view for explaining replacement of a cartridge.

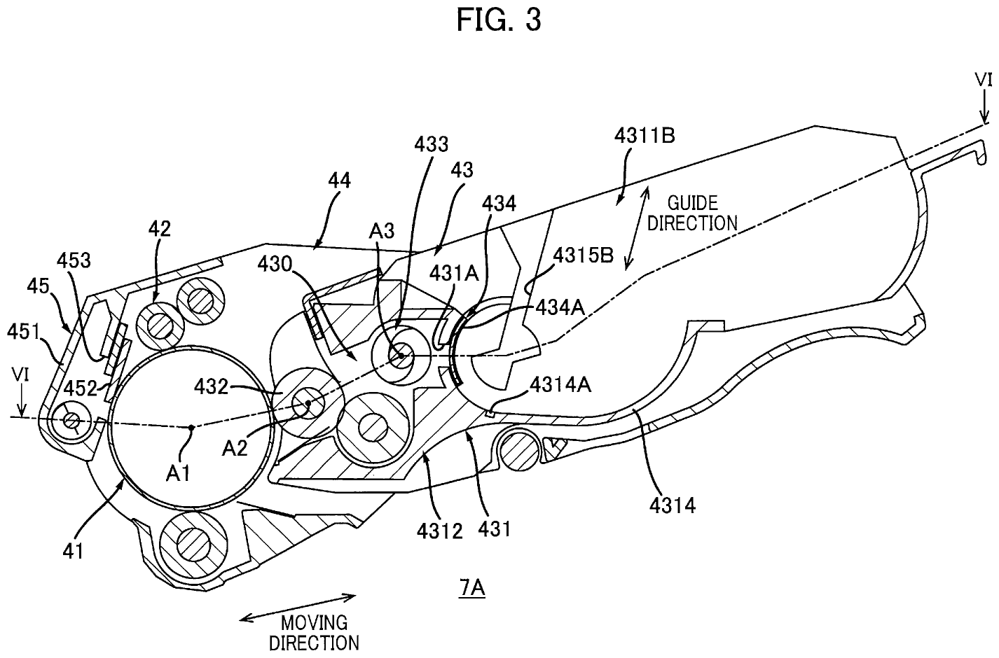

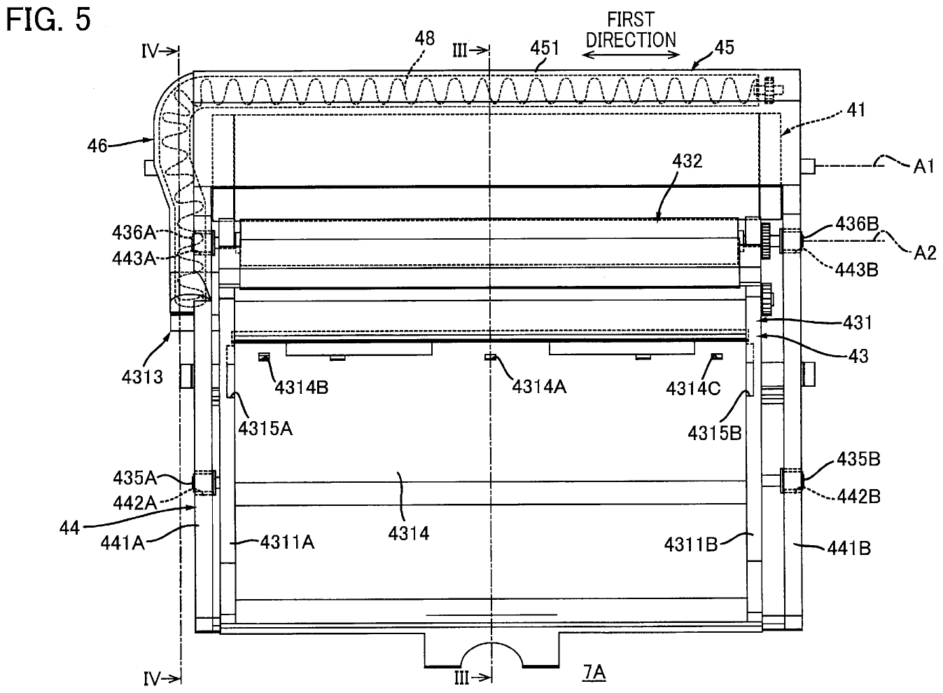

FIG. 3 is a cross-sectional view of a drum cartridge taken along line III-III of FIG. 5.

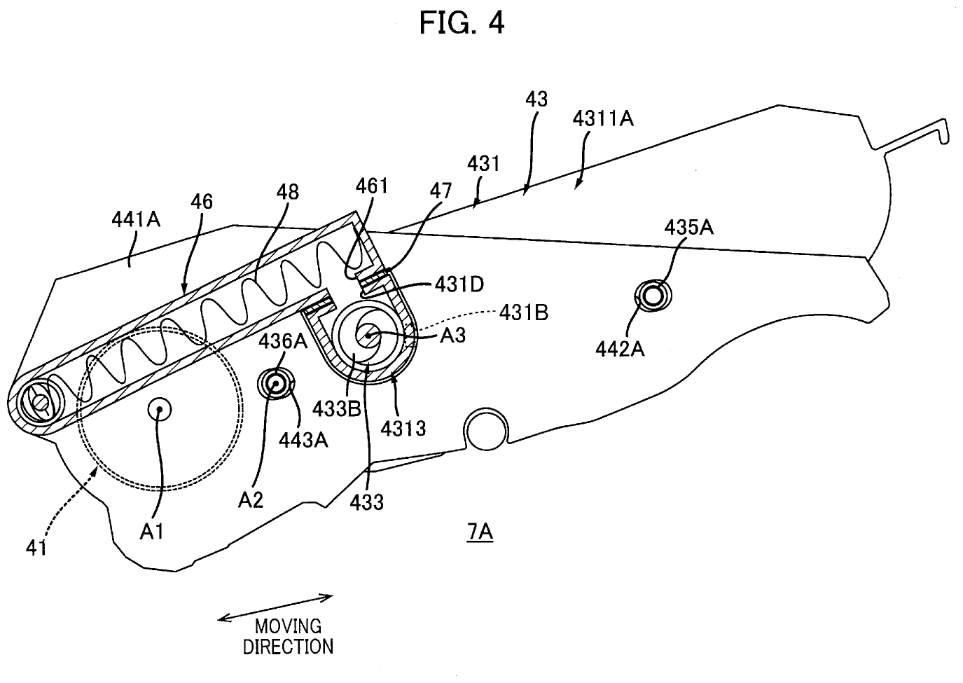

FIG. 4 is a cross-sectional view of the drum cartridge of FIG. 3 taken along line IV-IV of FIG. 5.

FIG. 5 is a plan view of the drum cartridge of FIG. 3.

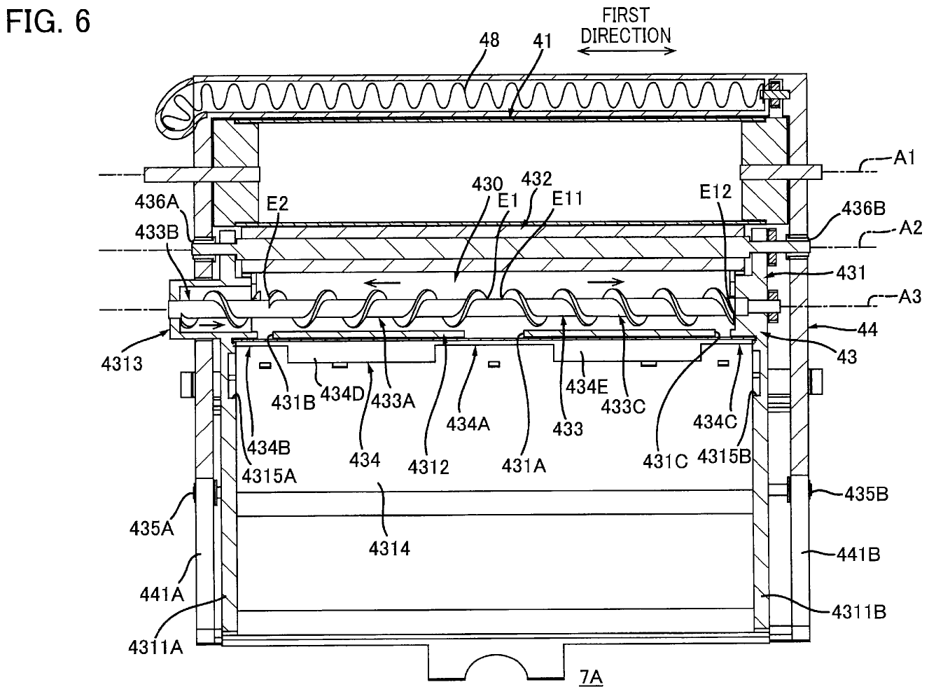

FIG. 6 is a cross-sectional view of the drum cartridge of FIG. 3 taken along line VI-VI of FIG. 5.

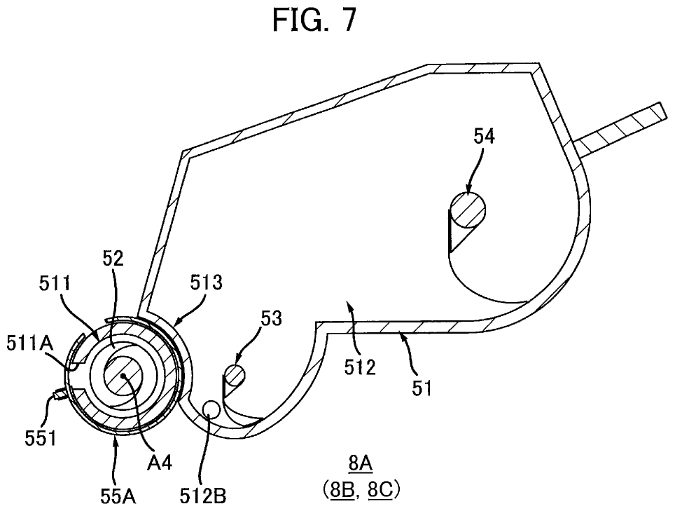

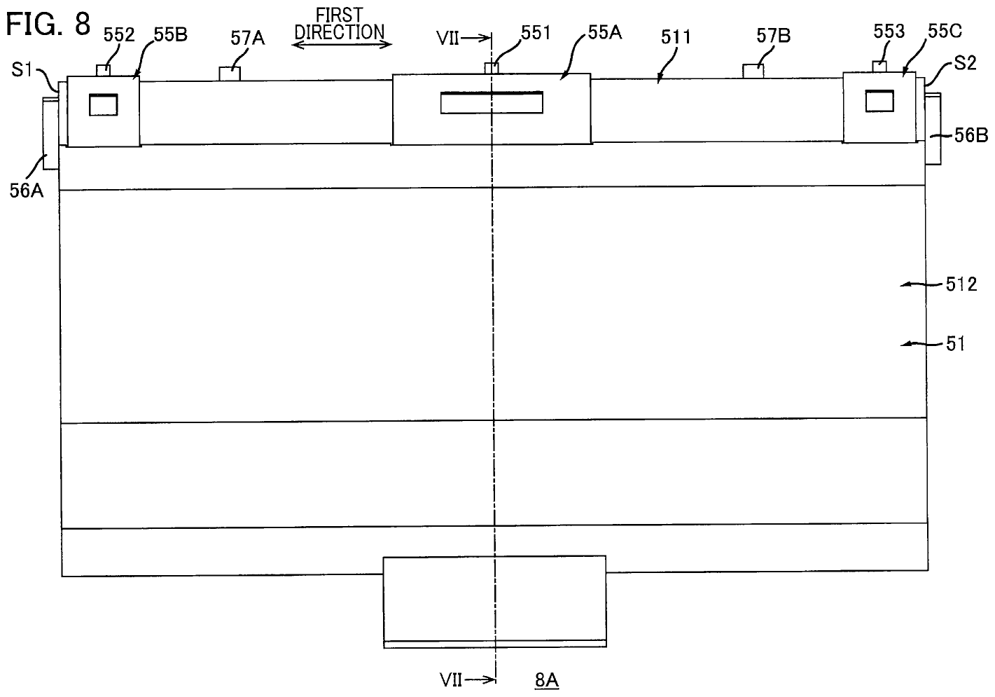

FIG. 7 is a cross-sectional view of a toner container taken along line VII-VII of FIG. 8, and specifically illustrating a state where a toner shutter is at its closing position.

FIG. 8 is a plan view of the toner container of FIG. 7.

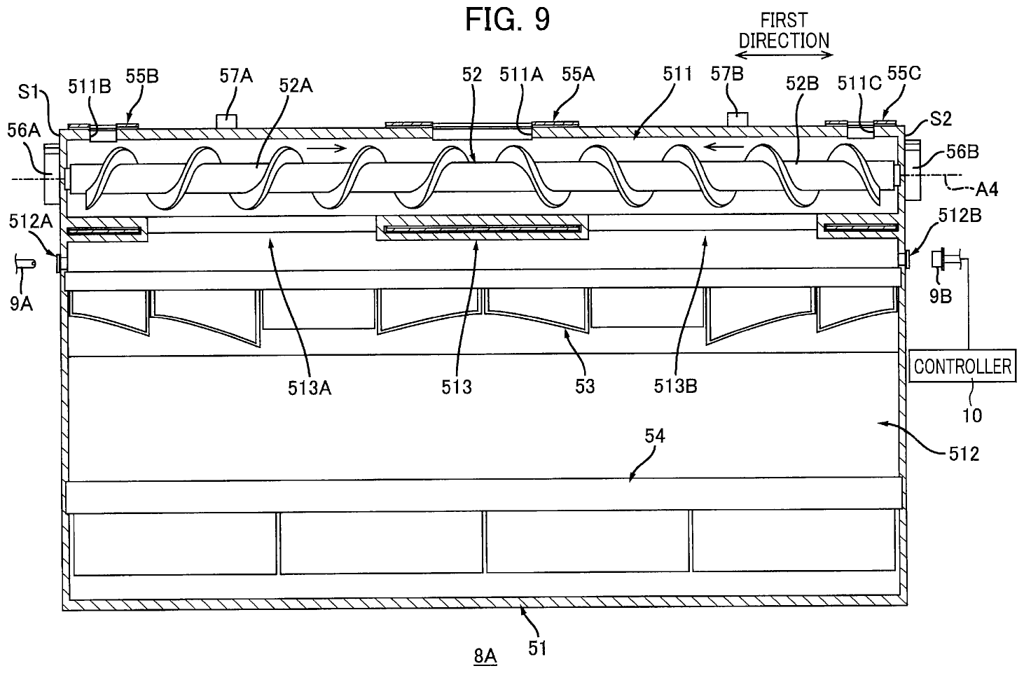

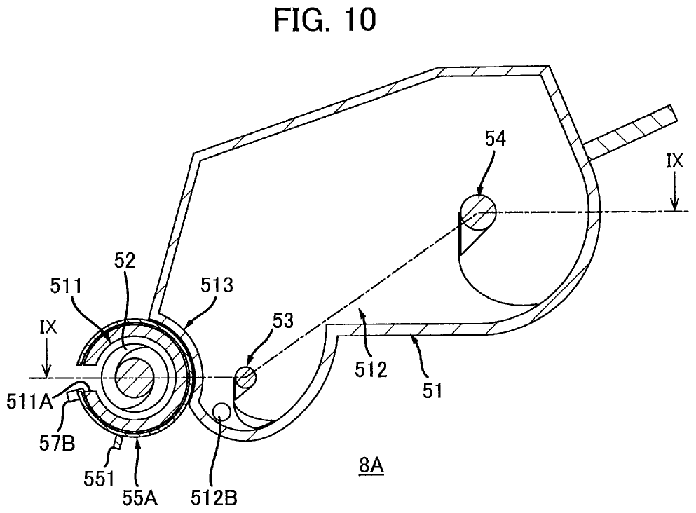

FIG. 9 is a cross-sectional view of the toner container of FIG. 7 taken along line IX-IX of FIG. 10.

FIG. 10 is a view of the toner container of FIG. 7, and specifically illustrating a state where the toner shutter is at its opening position.

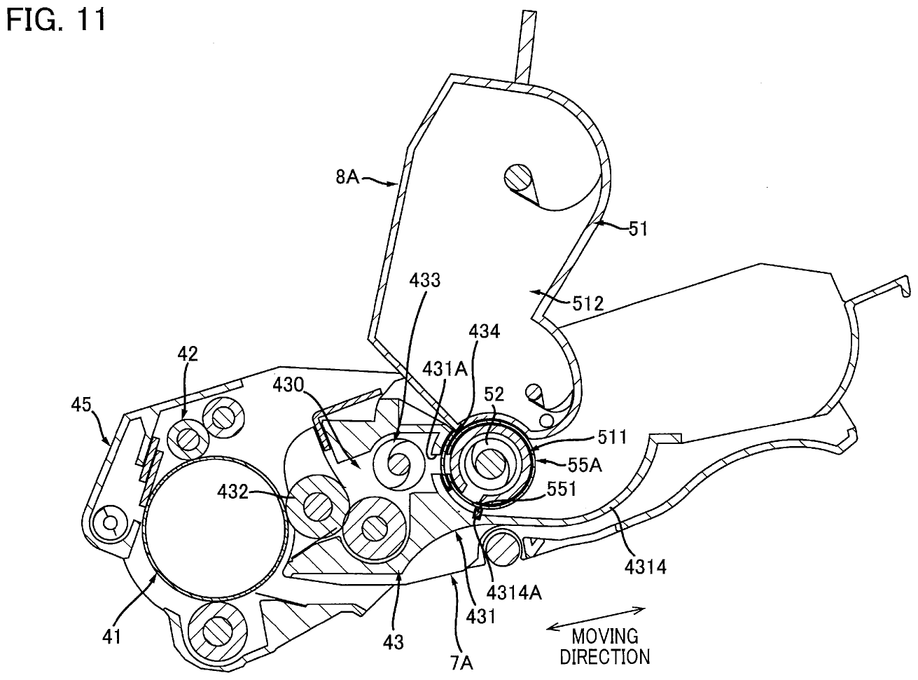

FIG. 11 is a view for explaining attachment of the toner container to the drum cartridge, and specifically illustrating a state where a first toner storage part of the toner container is positioned relative to the drum cartridge.

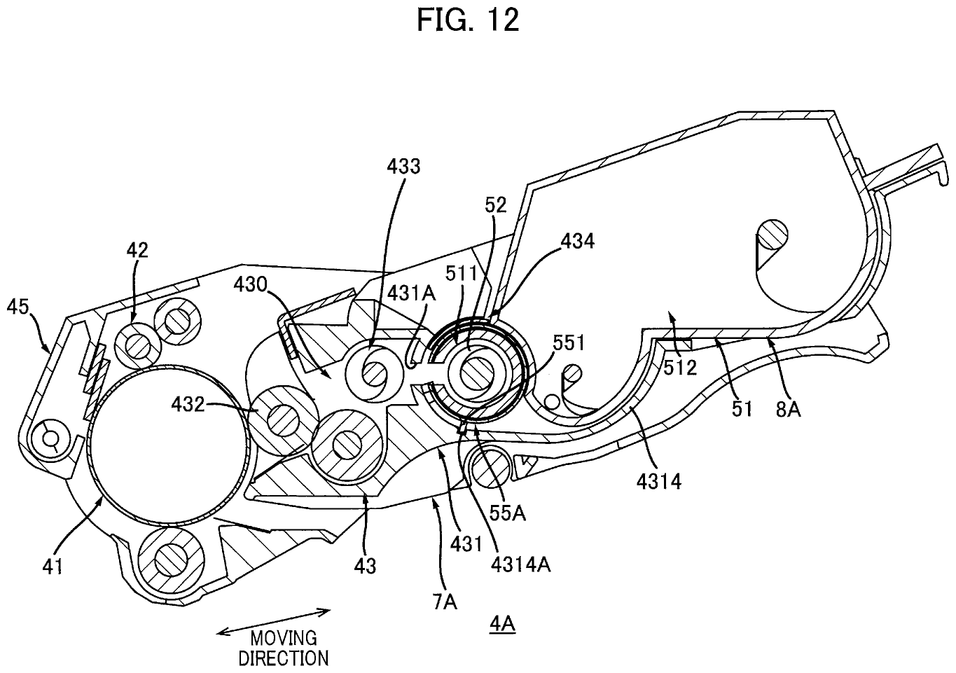

FIG. 12 is a view for explaining, subsequently to FIG. 11, the attachment of the toner container to the drum cartridge, and specifically illustrating a state where the attachment of the toner container to the drum cartridge is completed.

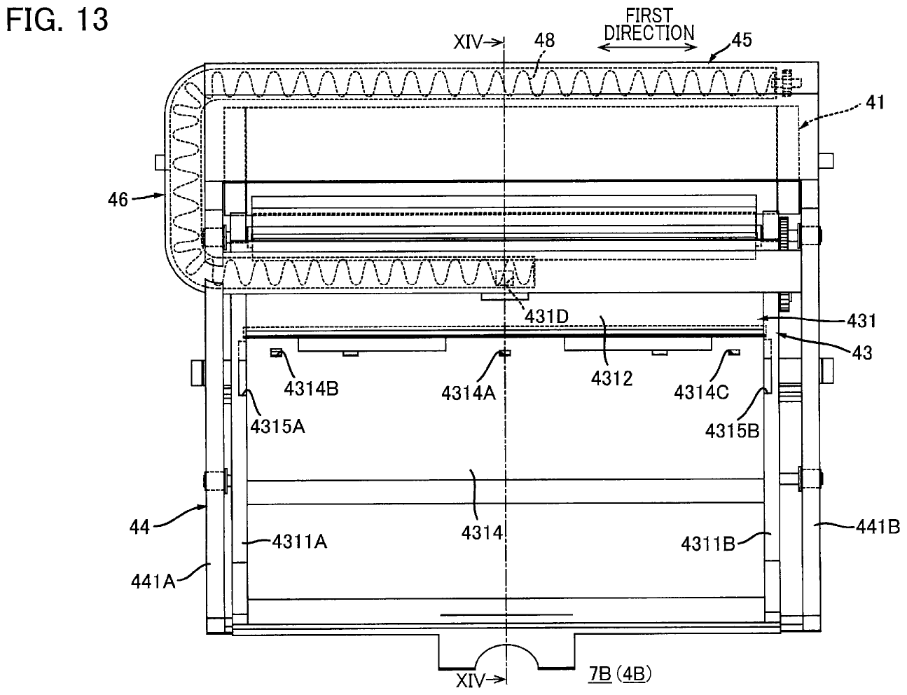

FIG. 13 is a plan view of a drum cartridge.

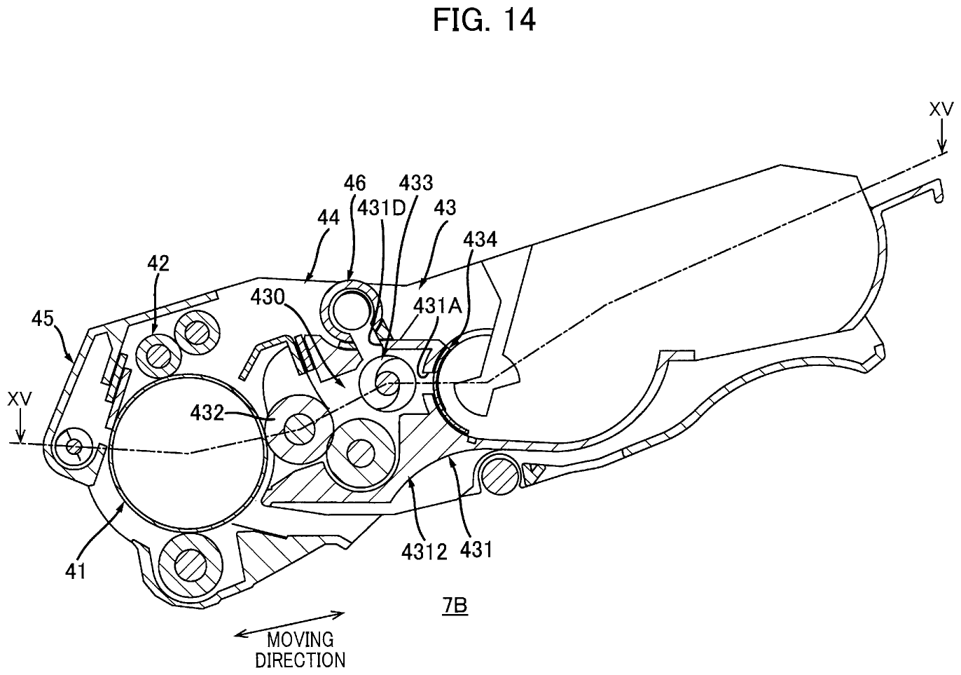

FIG. 14 is a cross-sectional view of the drum cartridge of FIG. 13 taken along line XIV-XIV of FIG. 13.

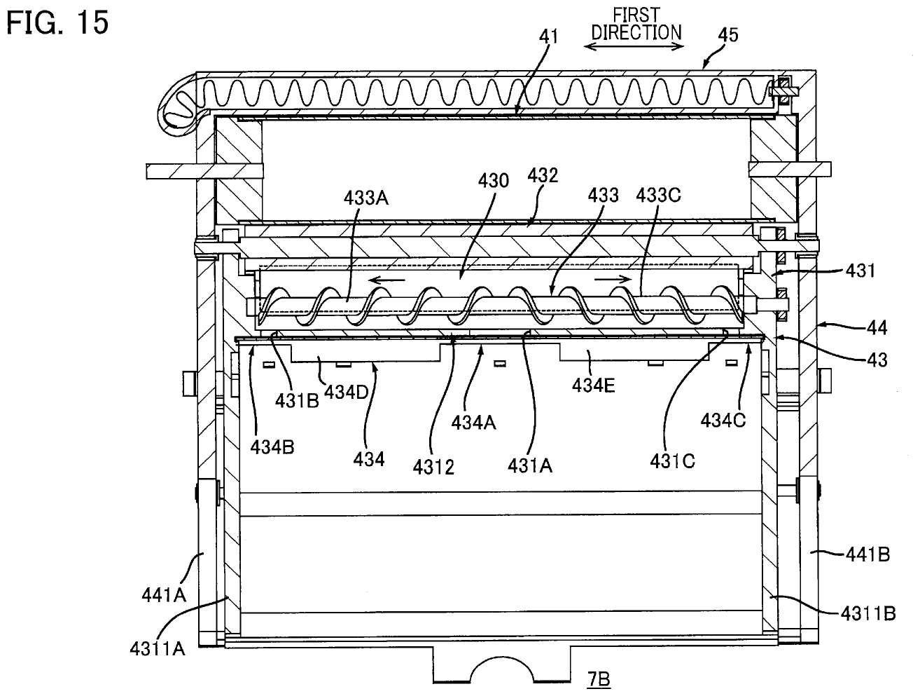

FIG. 15 is a cross-sectional view of the drum cartridge of FIG. 14 taken along line XV-XV of FIG. 14.

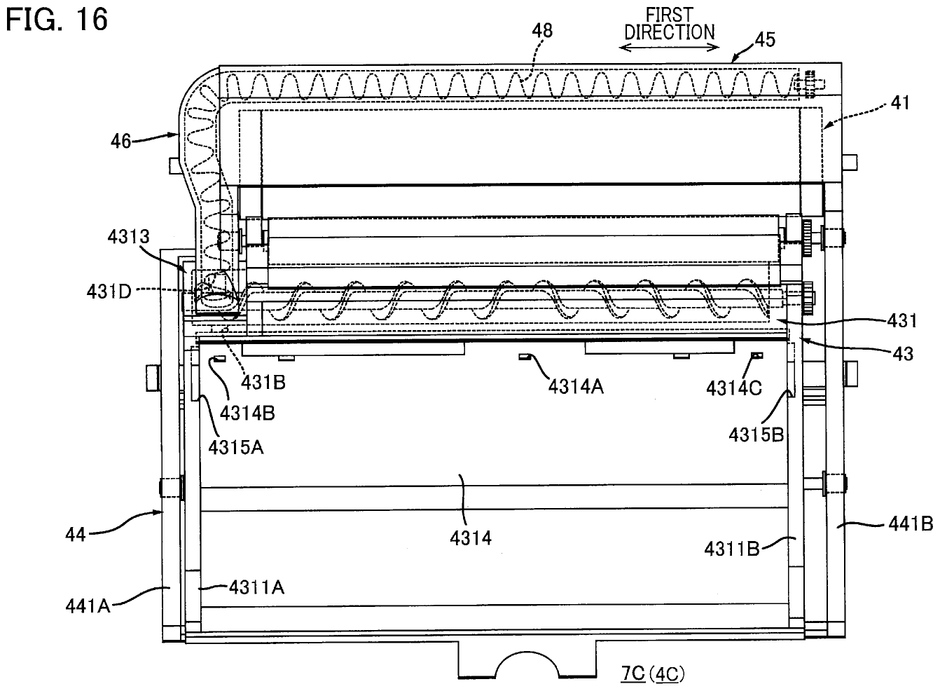

FIG. 16 is a plan view of a drum cartridge.

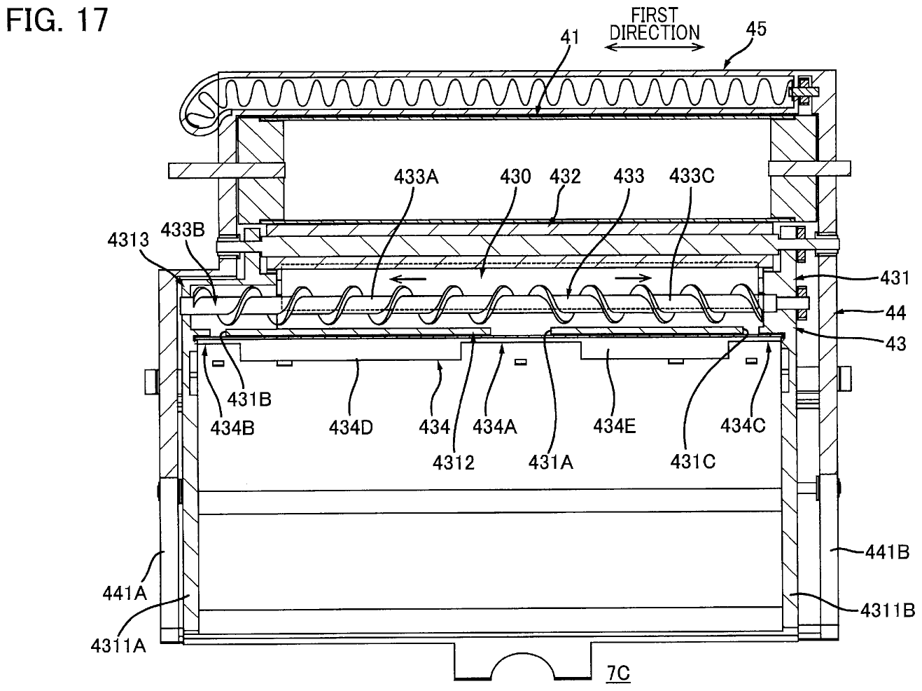

FIG. 17 is a cross-sectional view of the drum cartridge of FIG. 16.

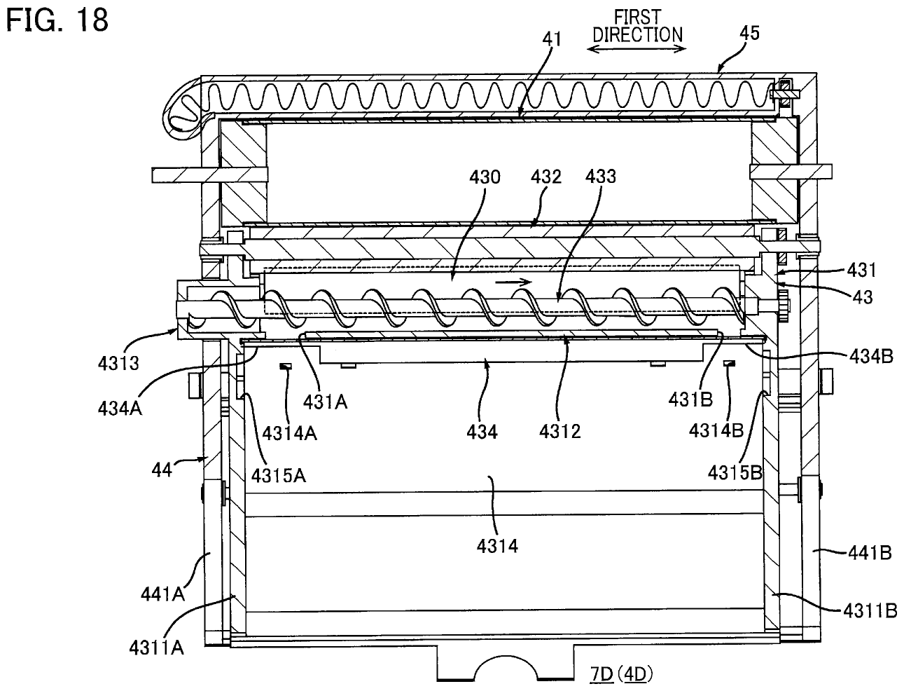

FIG. 18 is a cross-sectional view of a drum cartridge.

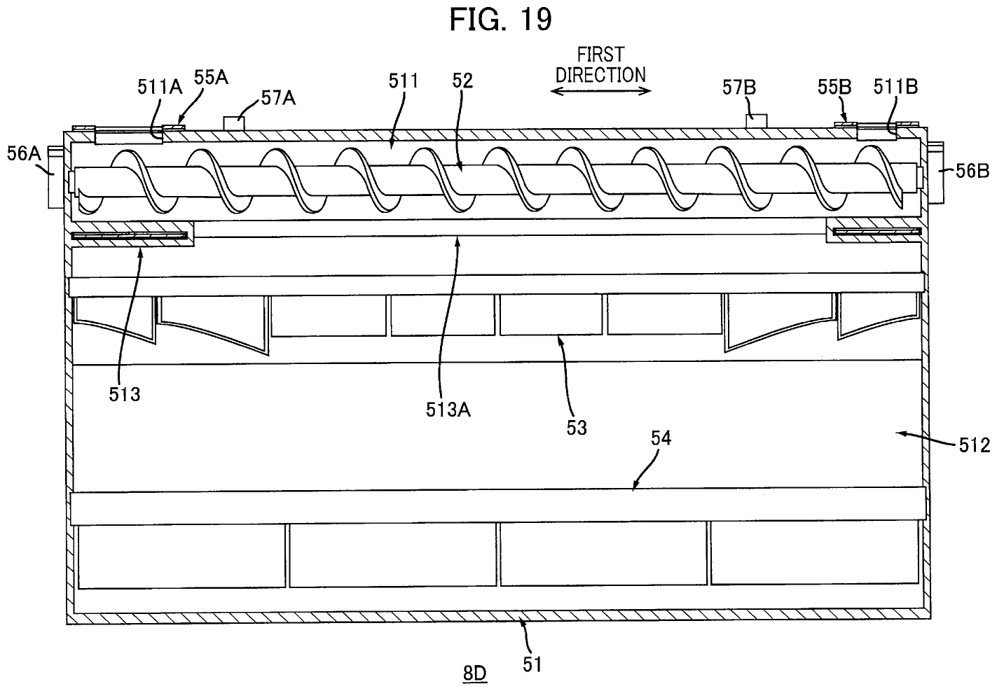

FIG. 19 is a cross-sectional view of a toner storage part.

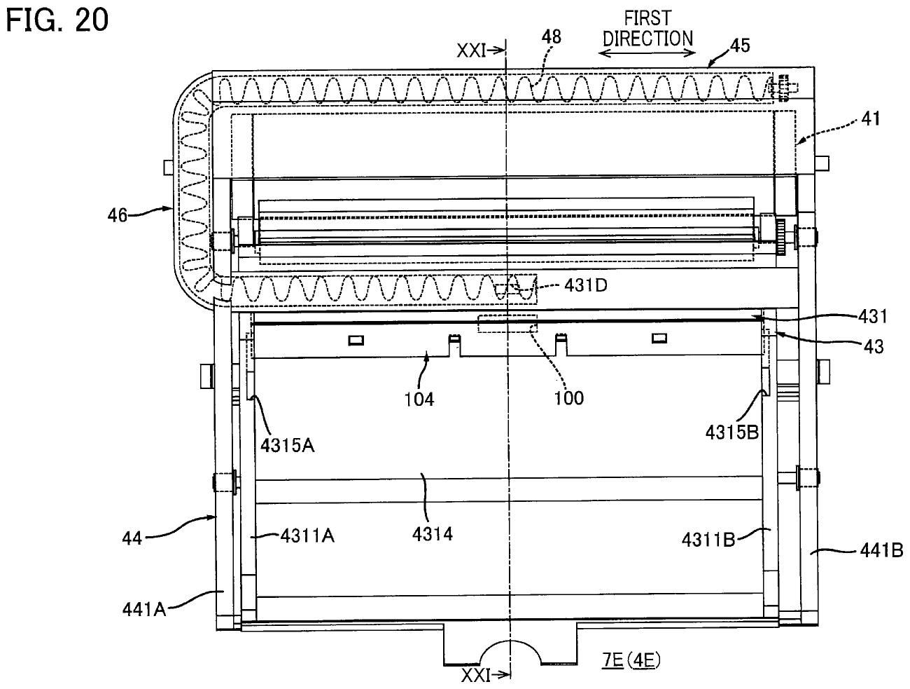

FIG. 20 is a plan view of a drum cartridge.

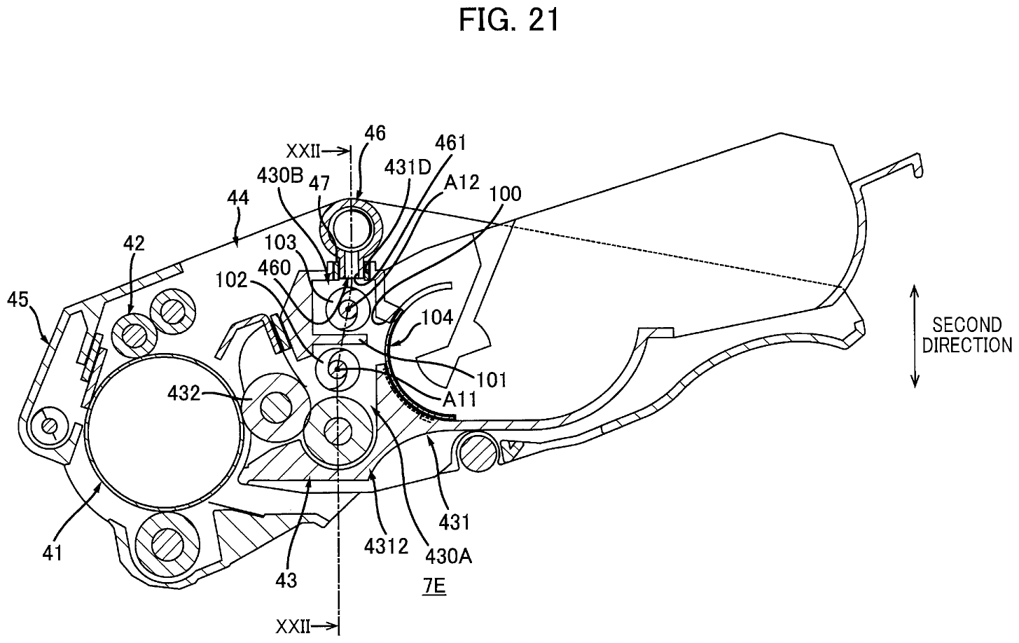

FIG. 21 is a cross-sectional view of the drum cartridge of FIG. 20 taken along line XXI-XXI of FIG. 20.

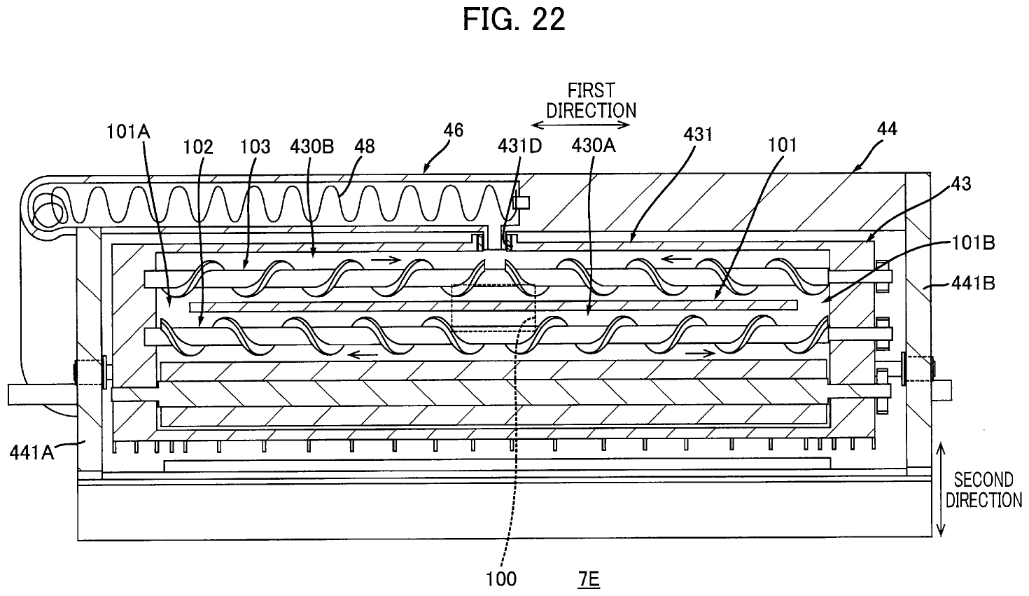

FIG. 22 is a cross-sectional view of the drum cartridge of FIG. 21 taken along line XXII-XXII of FIG. 21.

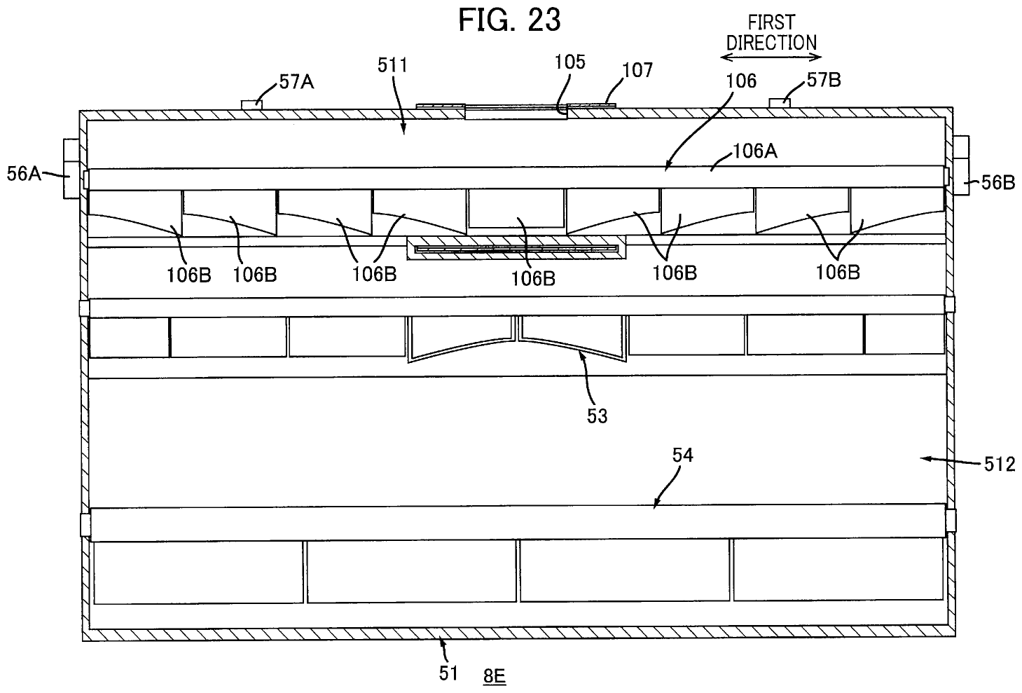

FIG. 23 is a cross-sectional view of a toner container.

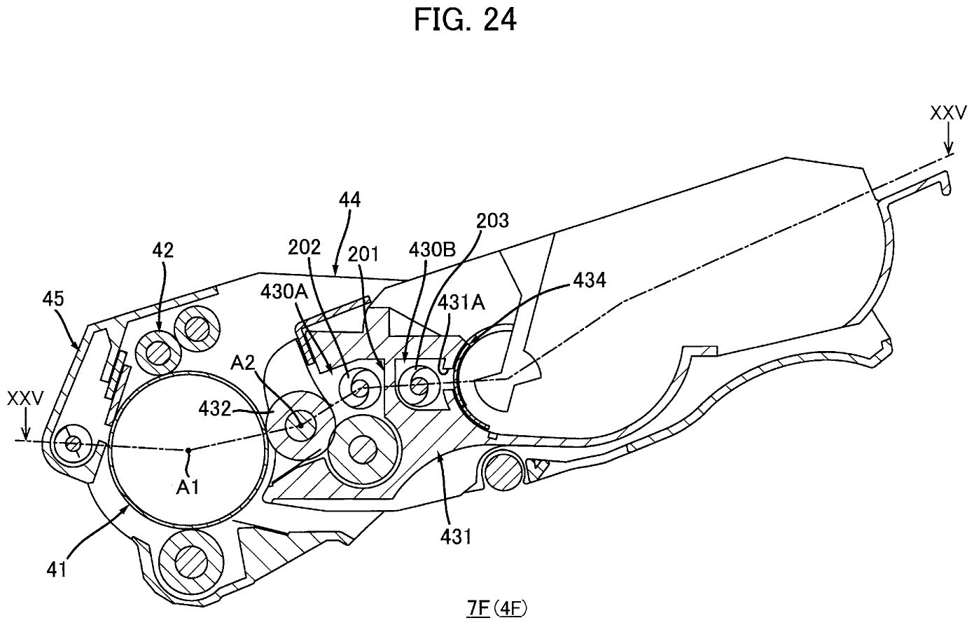

FIG. 24 is a cross-sectional view of a drum cartridge.

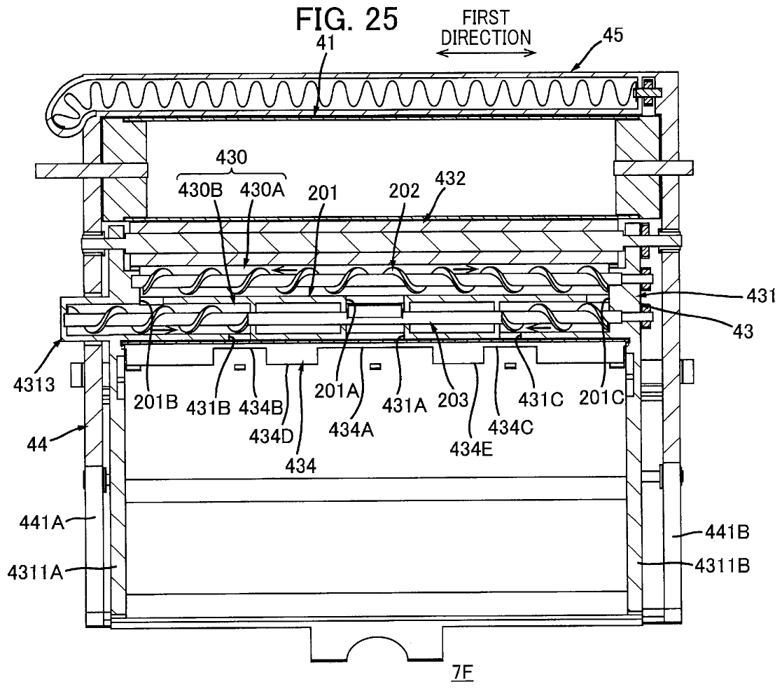

FIG. 25 is a cross-sectional view of the drum cartridge of FIG. 24 taken along line XXV-XXV of FIG. 24.

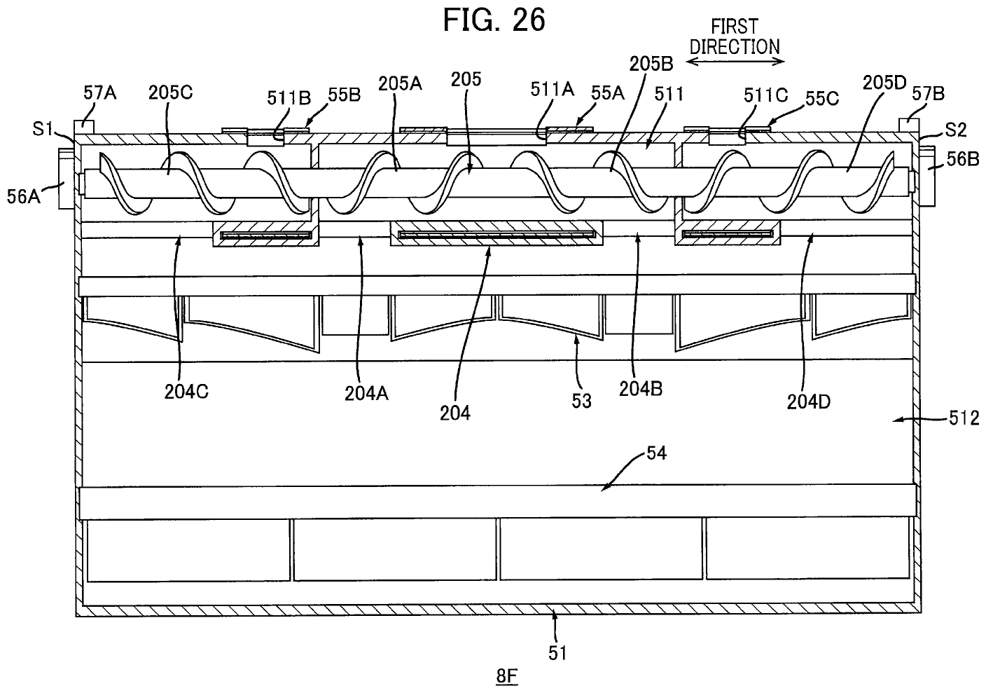

FIG. 26 is a cross-sectional view of a toner container.

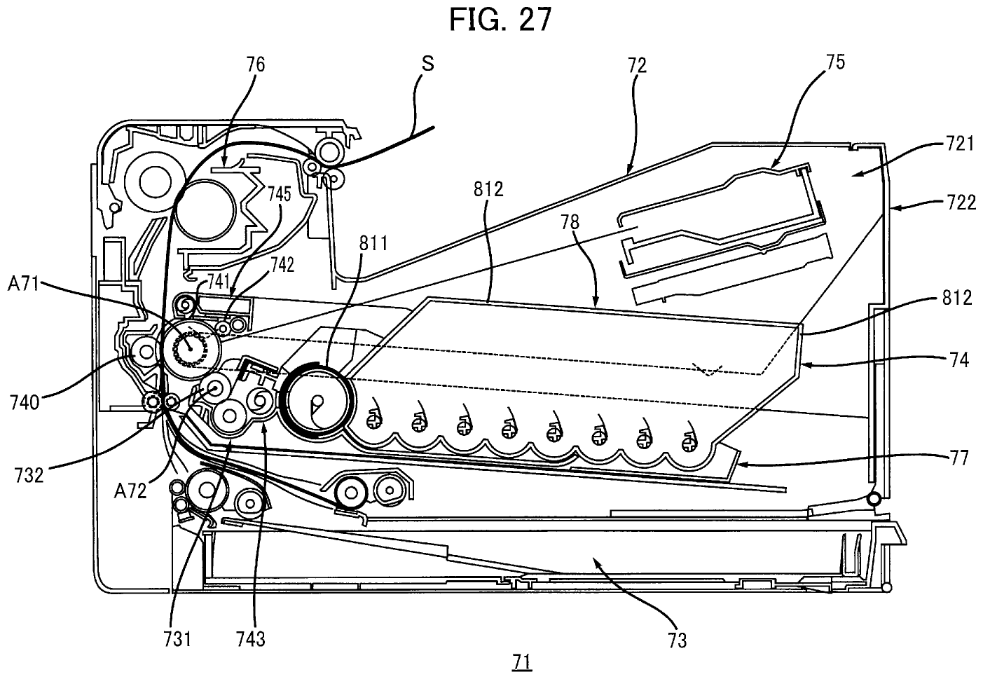

FIG. 27 is an outline view of an image forming apparatus.

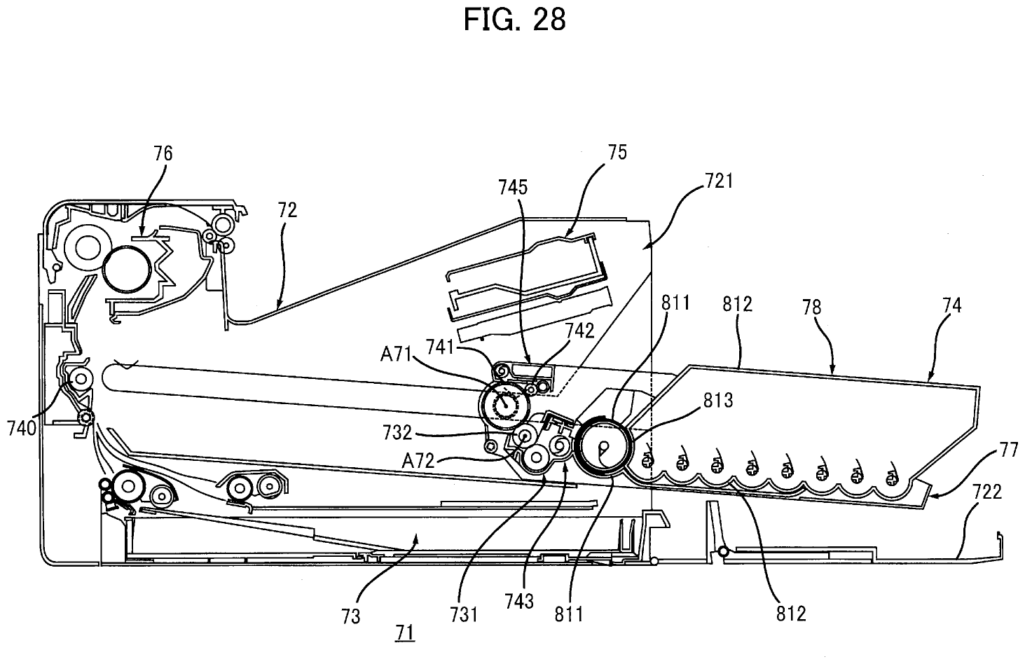

FIG. 28 is a view for explaining attachment and detachment of a cartridge.

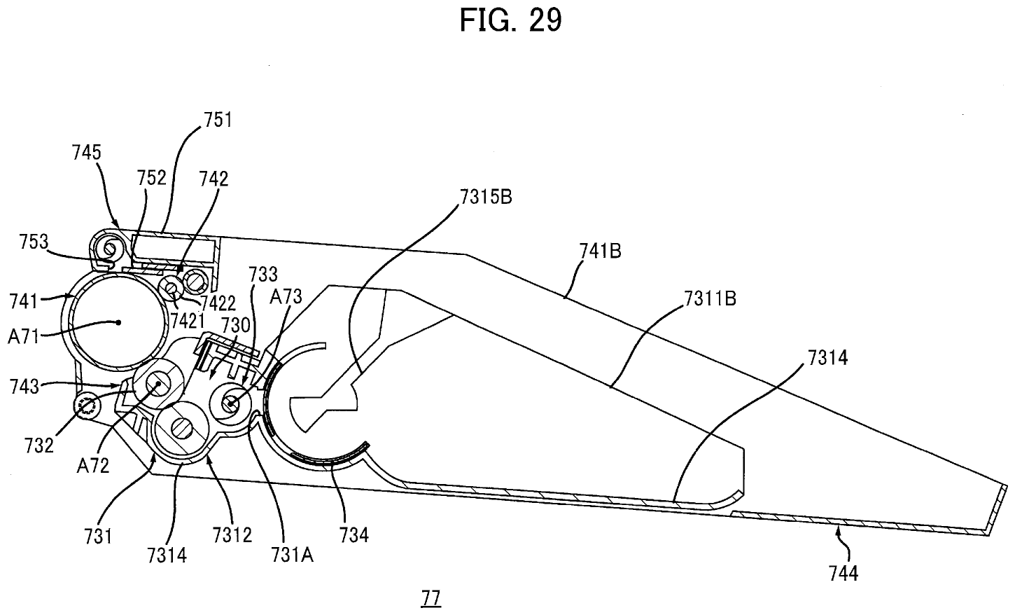

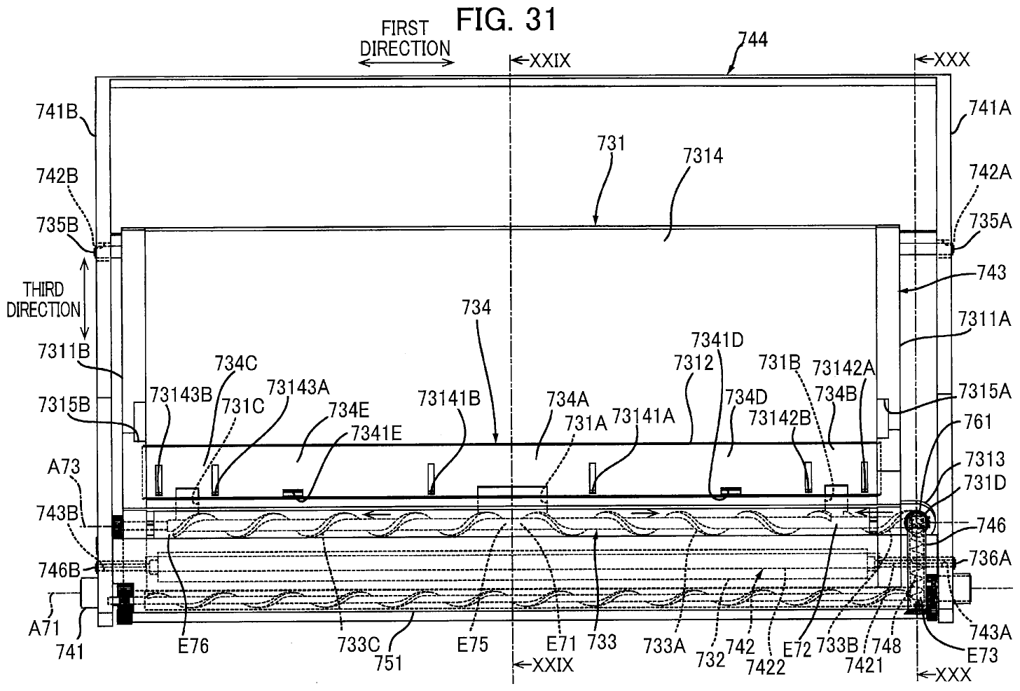

FIG. 29 is a cross-sectional view of a drum cartridge taken along line XXIX-XXIX of FIG. 31.

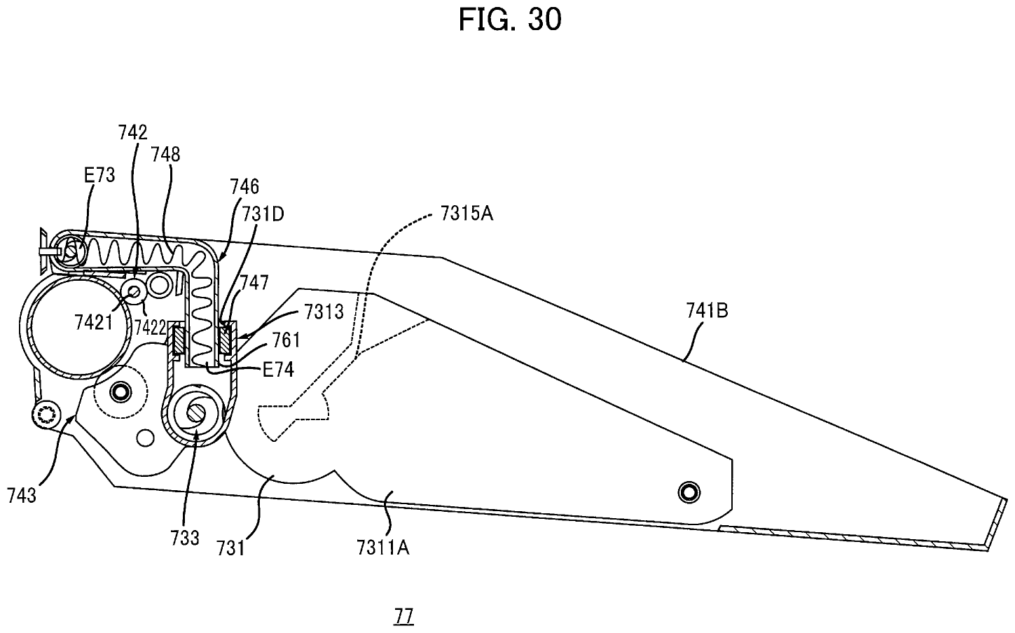

FIG. 30 is a cross-sectional view of the drum cartridge of FIG. 29 taken along line XXX-XXX of FIG. 31.

FIG. 31 is a plan view of the drum cartridge of FIG. 29.

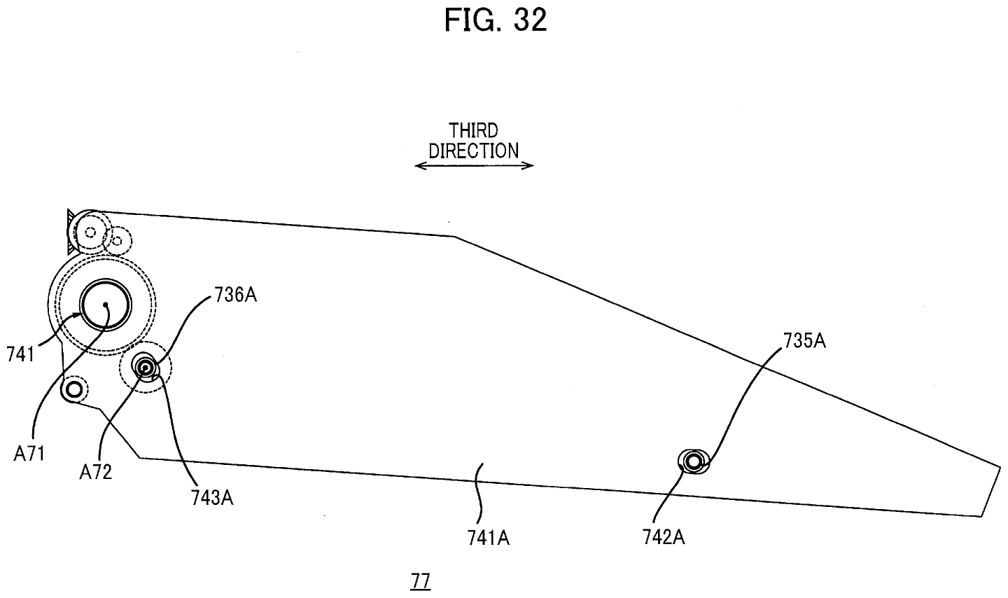

FIG. 32 is a side view of the drum cartridge of FIG. 29.

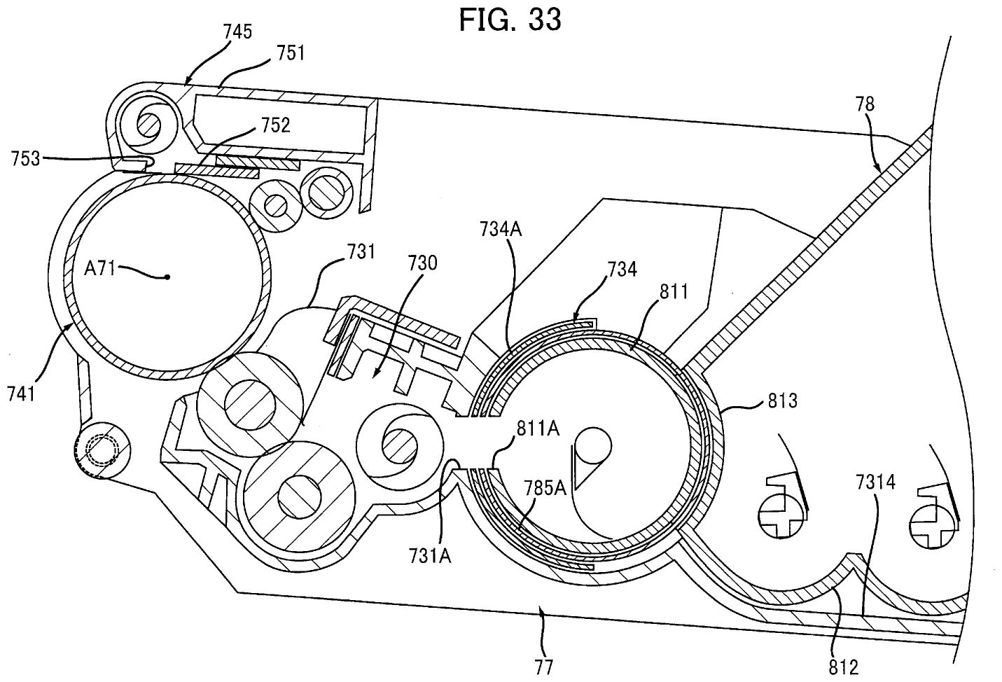

FIG. 33 is a view of the drum cartridge of FIG. 29, and specifically illustrating a state where a toner shutter and a developing shutter are at their opening positions.

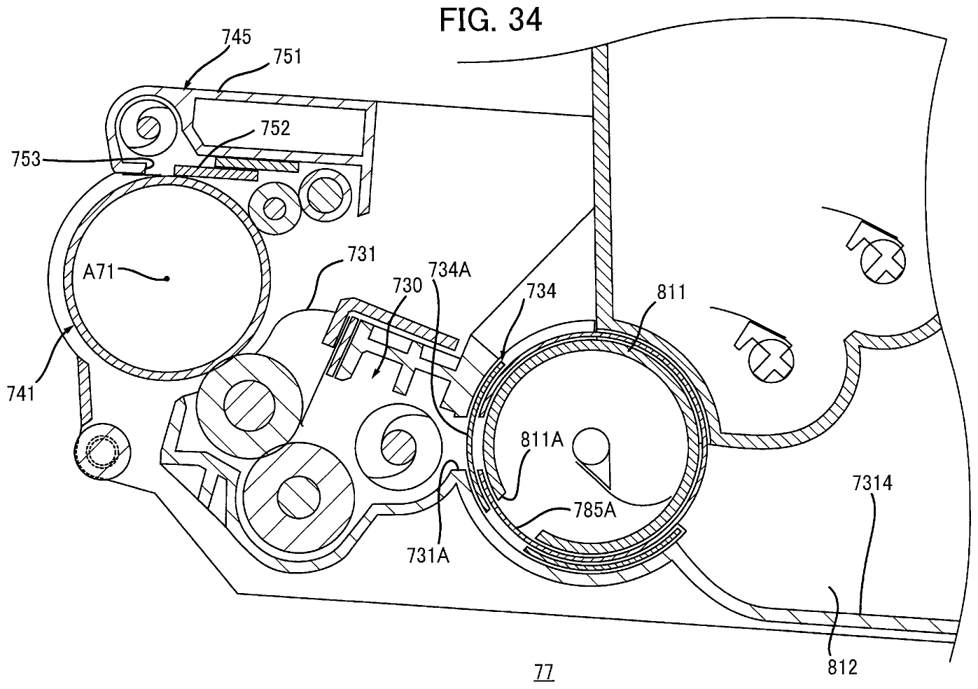

FIG. 34 is a view of the drum cartridge of FIG. 29, and specifically illustrating a state where the toner shutter and the developing shutter are at their closing positions.

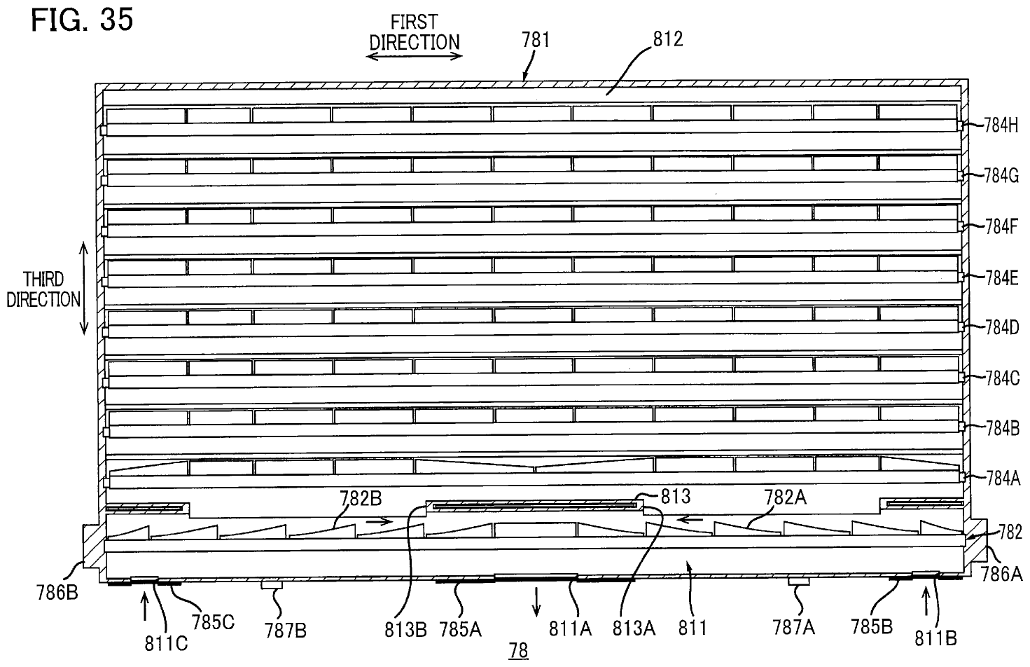

FIG. 35 is a cross-sectional view of a toner container.

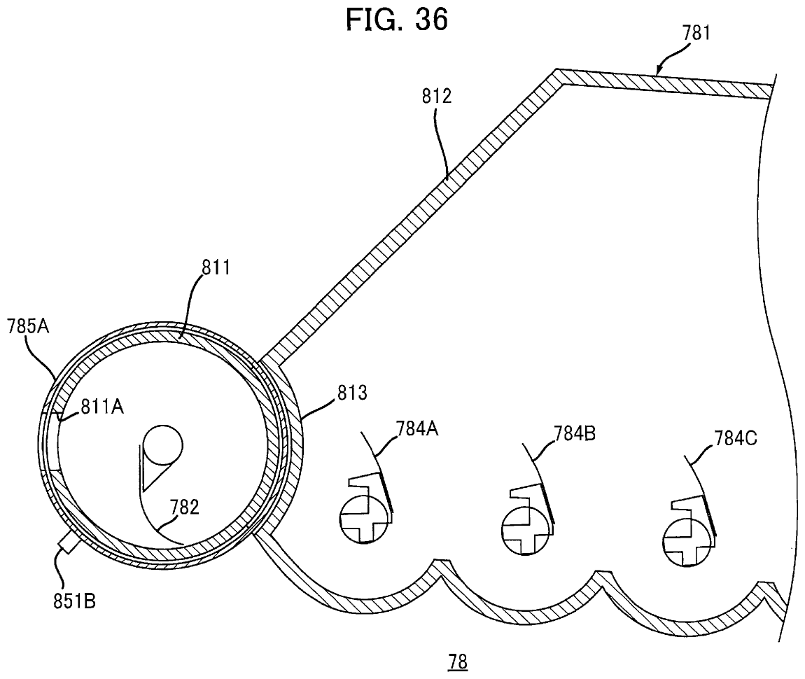

FIG. 36 is a view of a toner storage part, and specifically illustrating a state where the developing shutter is at its closing position.

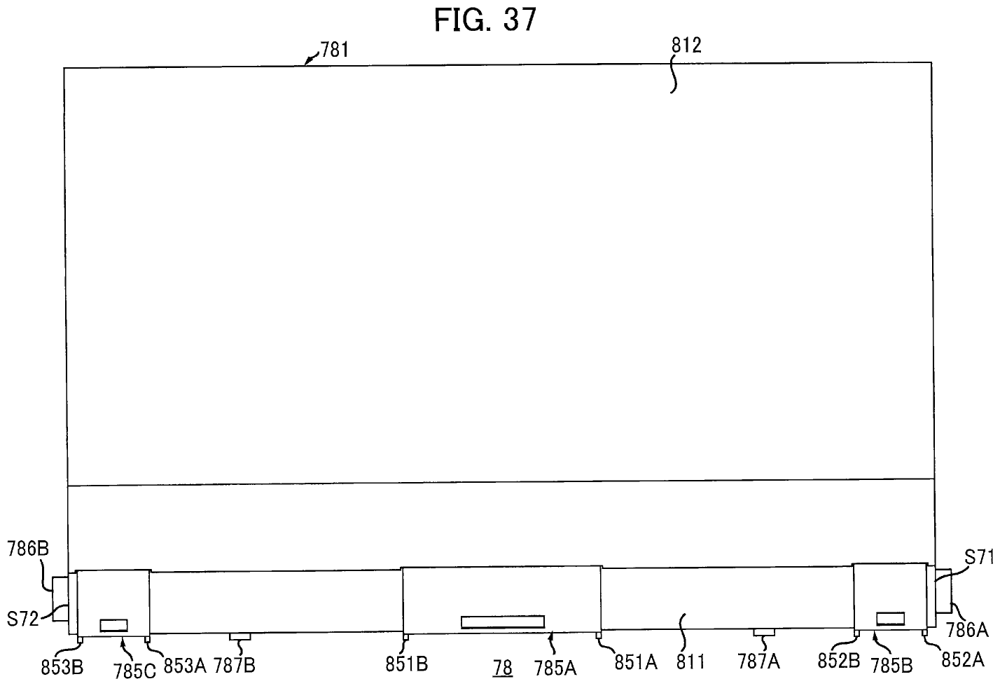

FIG. 37 is a plan view of the toner container of FIG. 35.

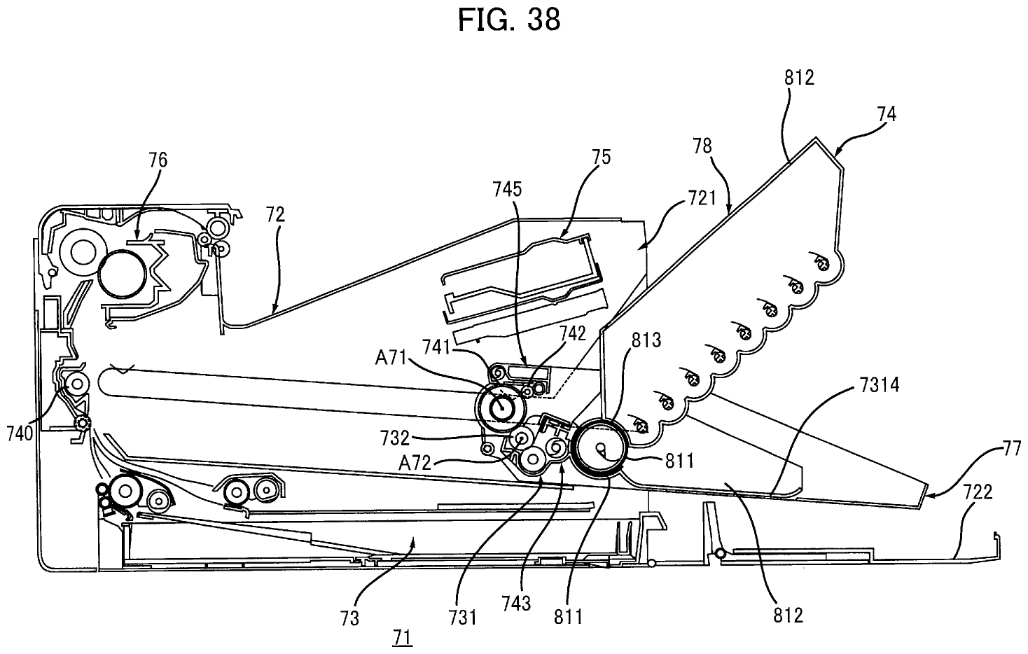

FIG. 38 is a view illustrating a state where a first toner storage part is positioned relative to a developing housing.

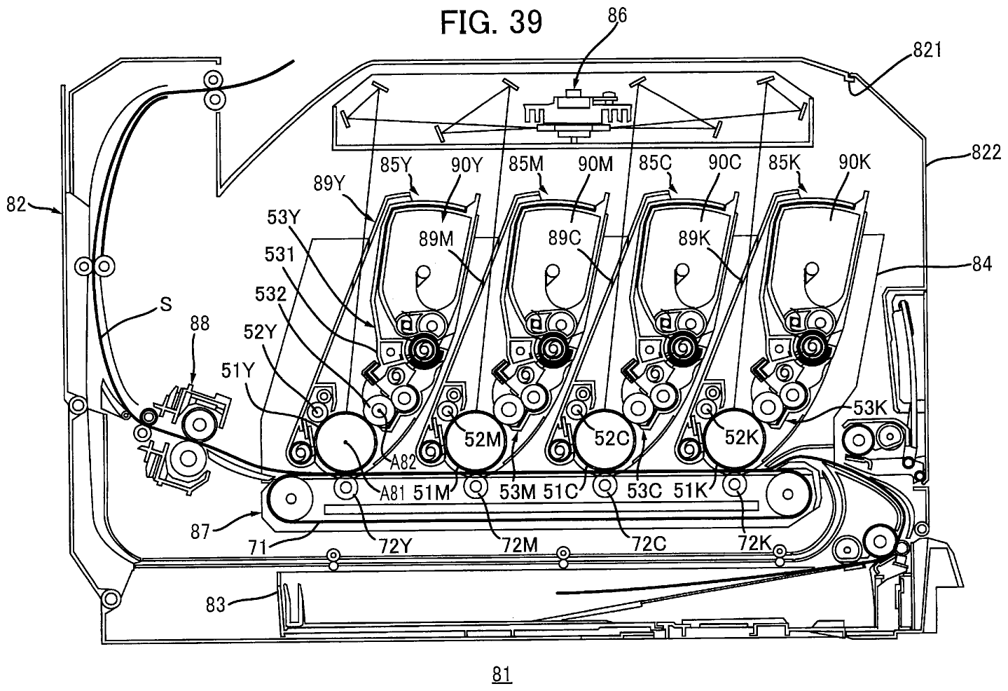

FIG. 39 is an outline view of an image forming apparatus.

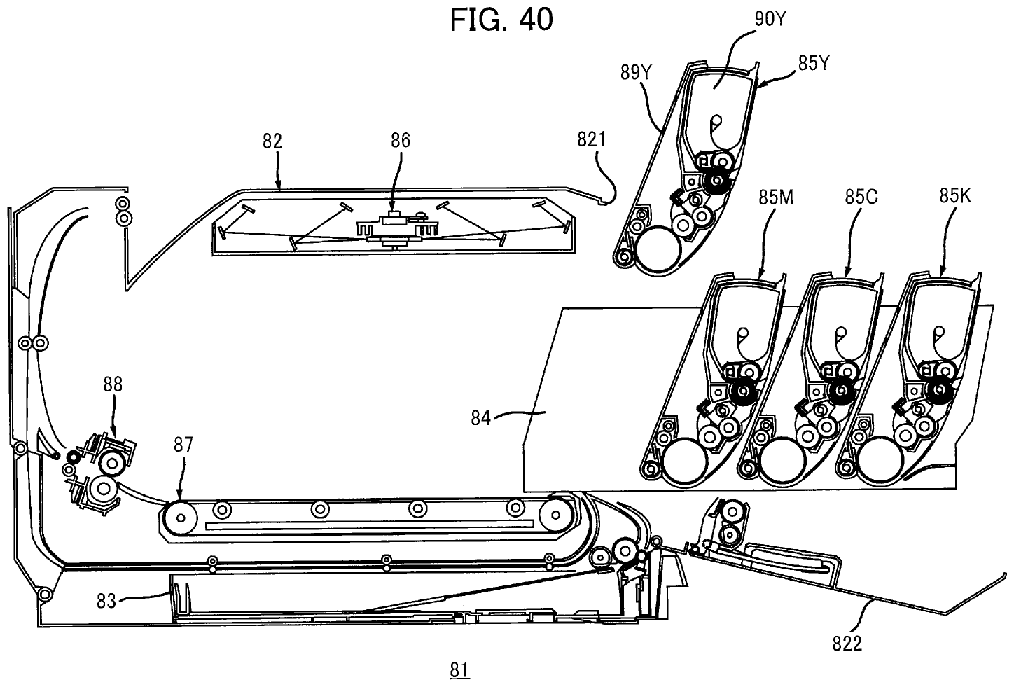

FIG. 40 is a view for explaining replacement of a cartridge.

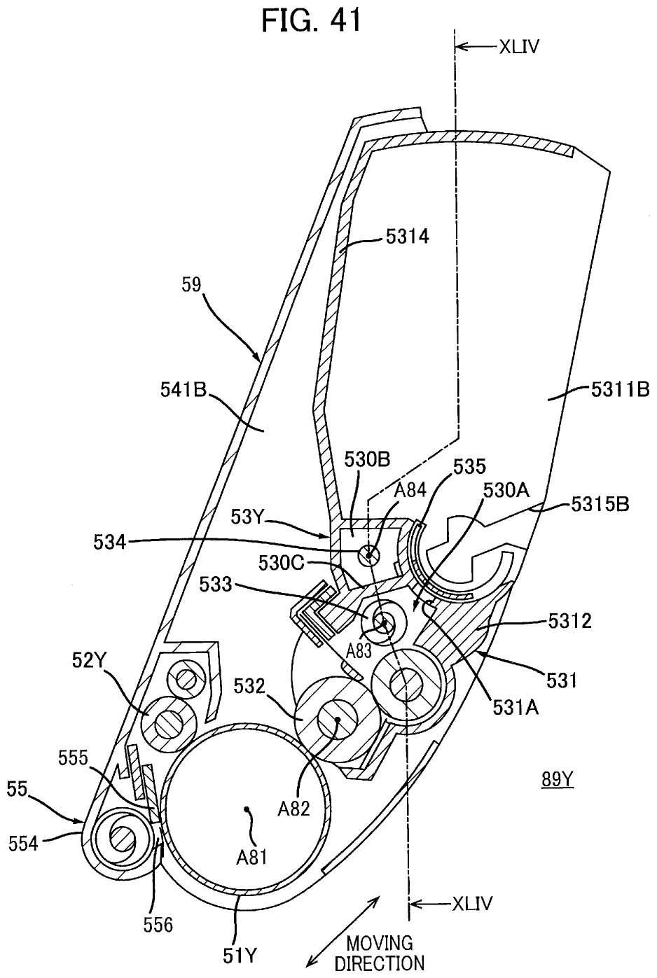

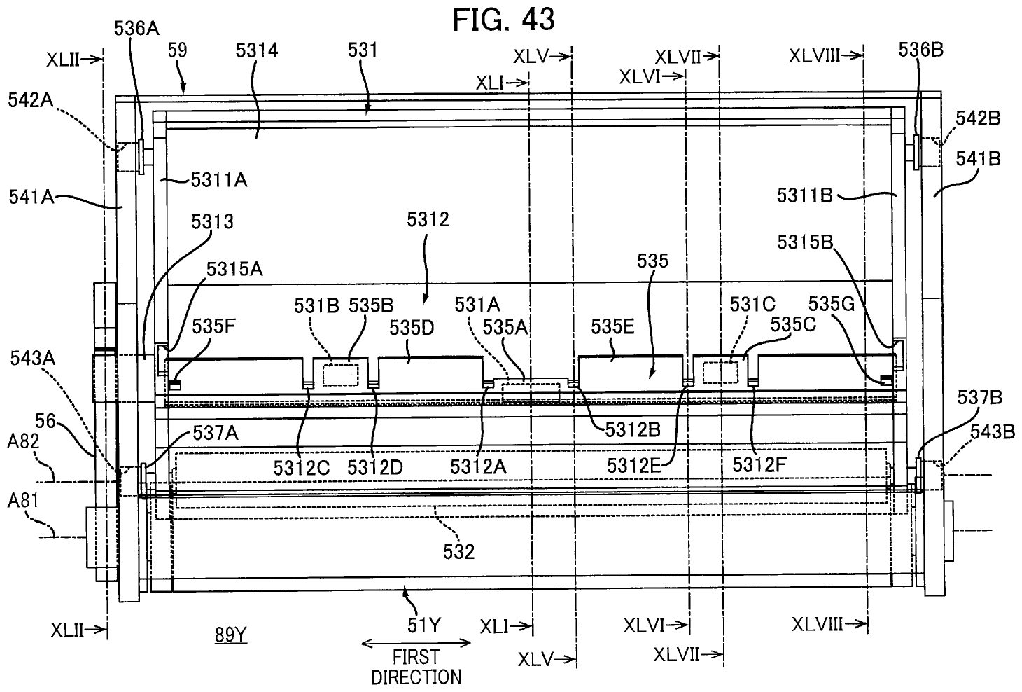

FIG. 41 is a cross-sectional view of a drum cartridge taken along line XLI-XLI of FIG. 43.

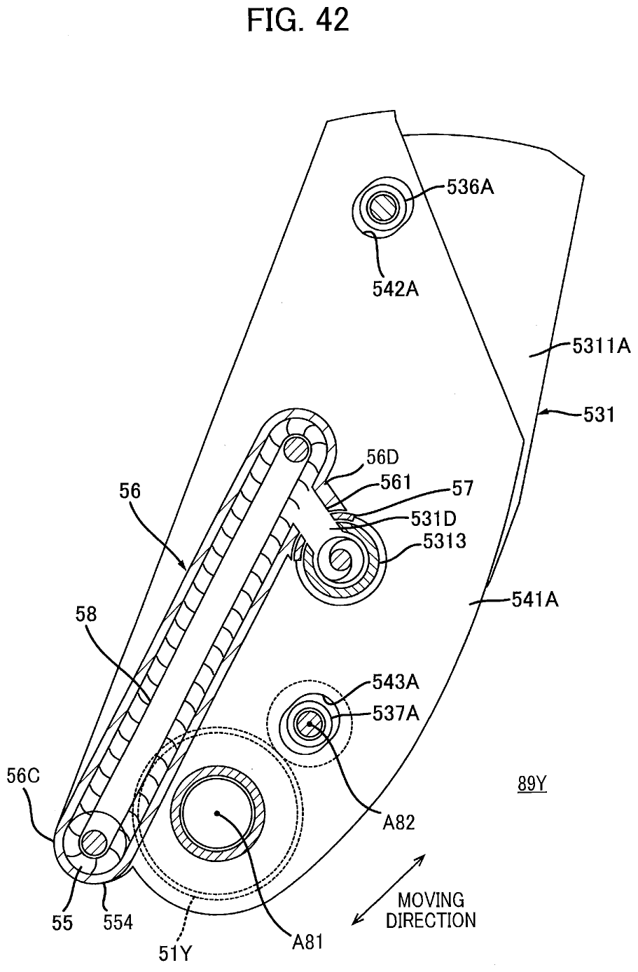

FIG. 42 is a cross-sectional view of the drum cartridge taken along line XLII-XLII of FIG. 43.

FIG. 43 is a plan view of the drum cartridge.

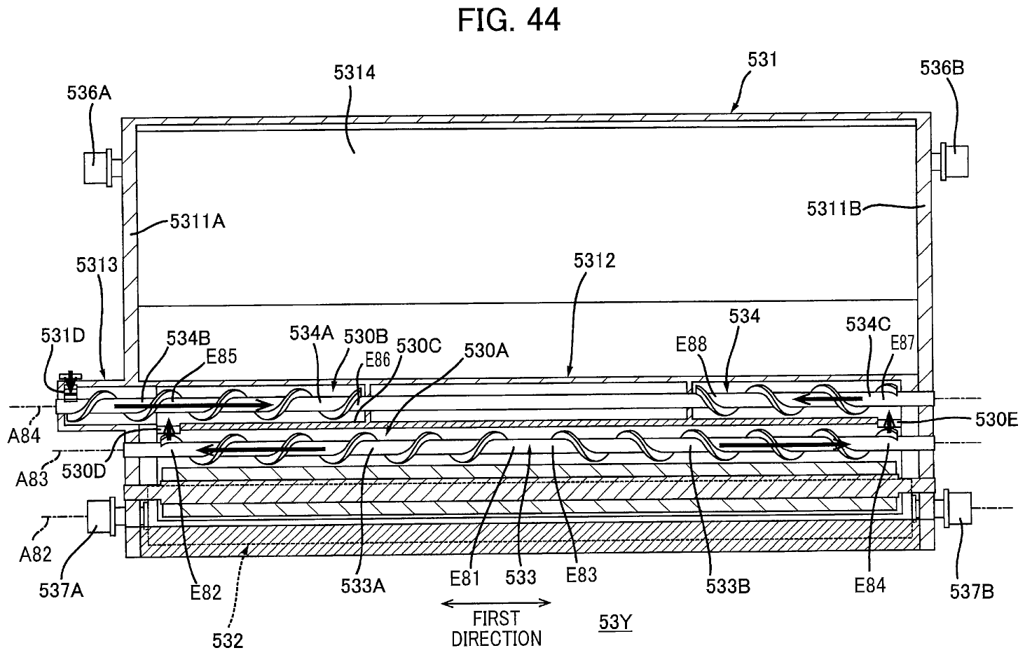

FIG. 44 is a cross-sectional view of the drum cartridge of FIG. 41 taken along line XLIV-XLIV of FIG. 41.

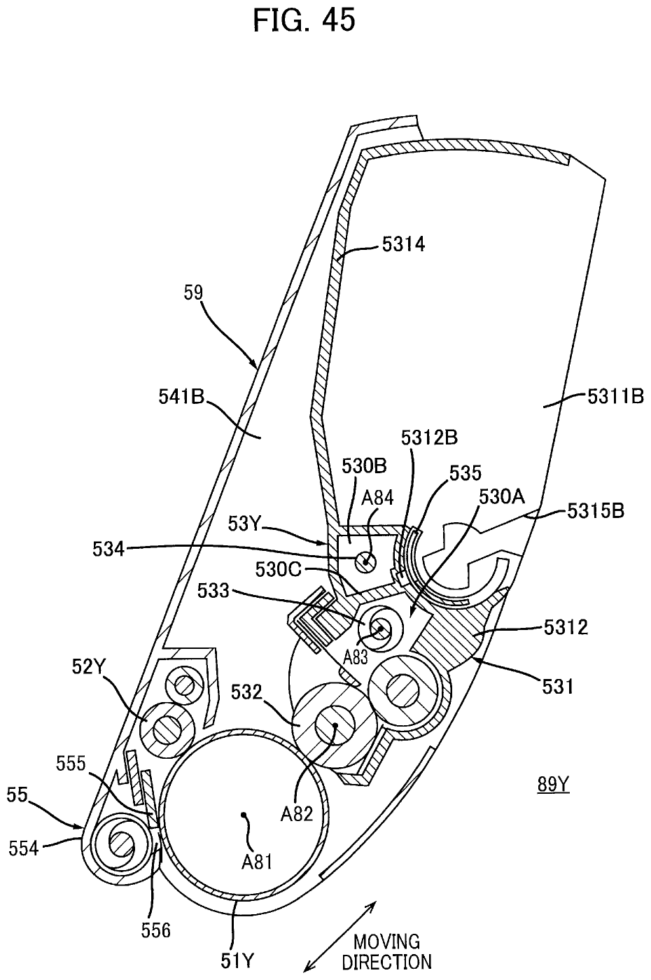

FIG. 45 is a cross-sectional view of the drum cartridge of FIG. 43 taken along line XLV-XLV of FIG. 43.

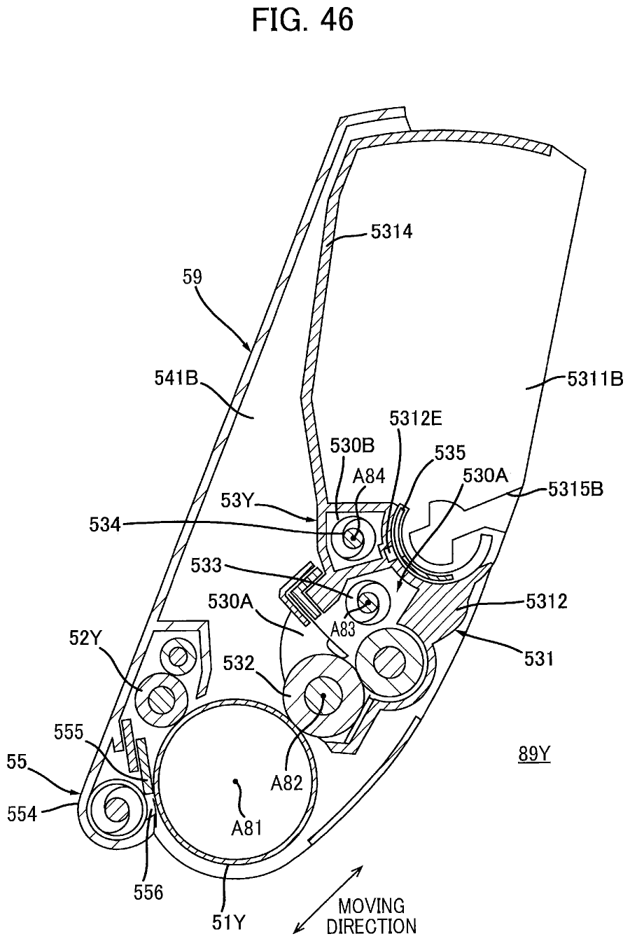

FIG. 46 is a cross-sectional view of the drum cartridge of FIG. 43 taken along line XLVI-XLVI of FIG. 43.

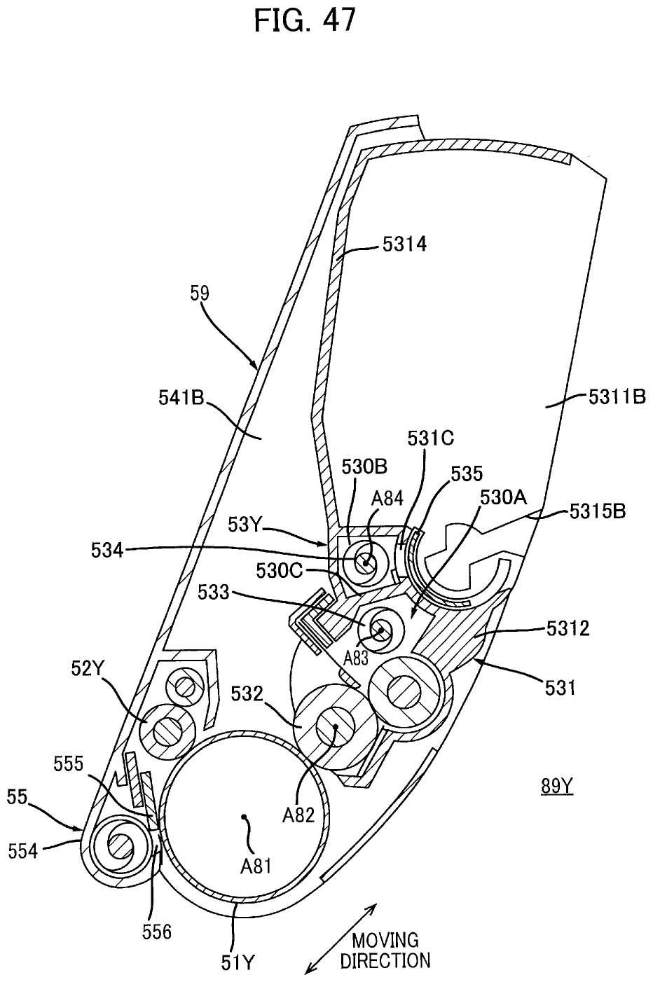

FIG. 47 is a cross-sectional view of the drum cartridge of FIG. 43 taken along line XLVII-XLVII of FIG. 43.

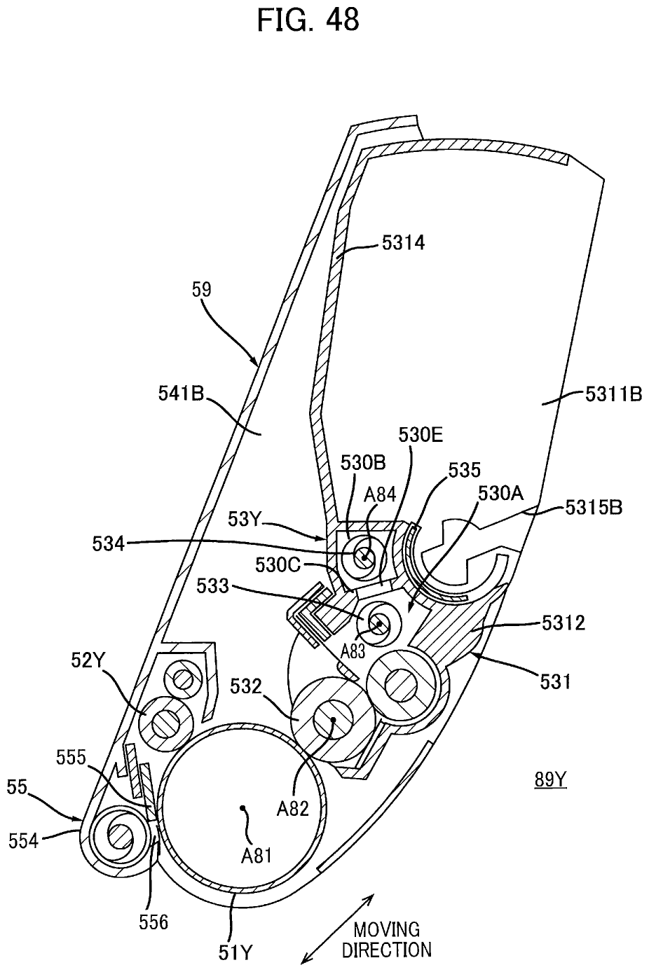

FIG. 48 is a cross-sectional view of the drum cartridge of FIG. 43 taken along line XLVIII-XLVIII of FIG. 43.

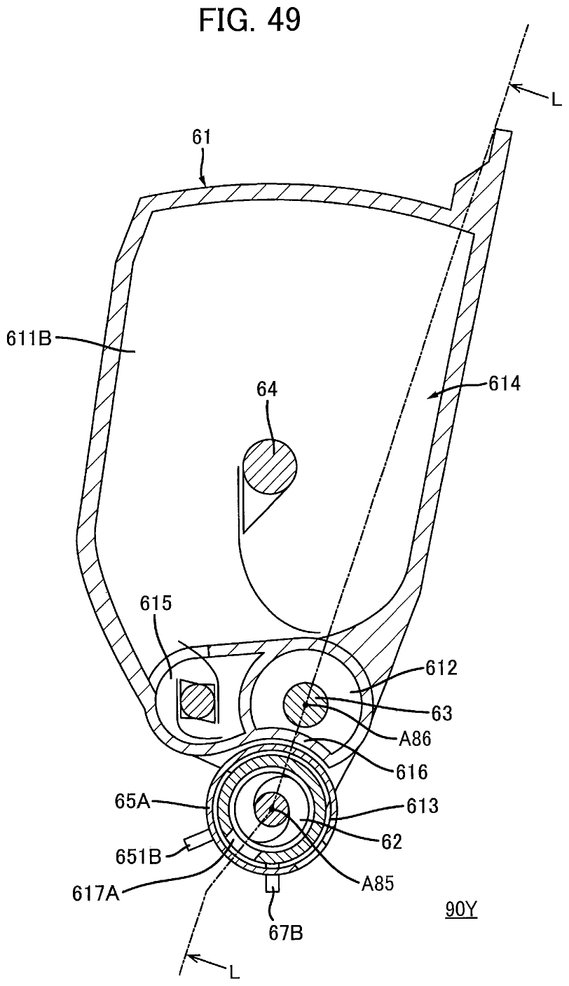

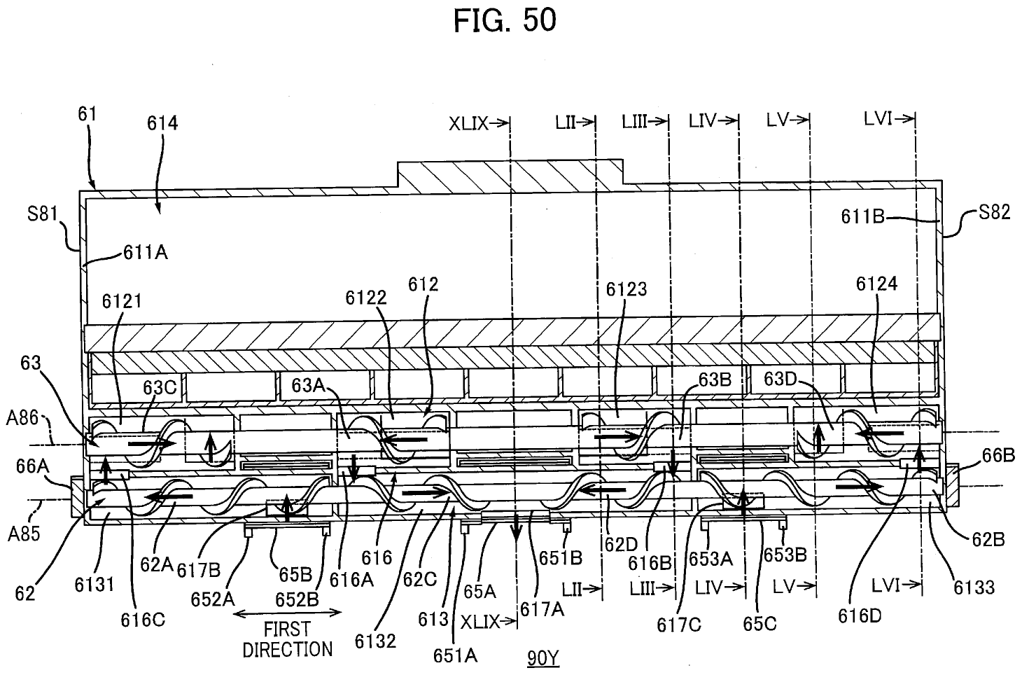

FIG. 49 is a cross-sectional view of a toner container taken along line XLIX-XLIX of FIG. 50.

FIG. 50 is a cross-sectional view of a toner cartridge of FIG. 49 taken along line L-L of FIG. 49.

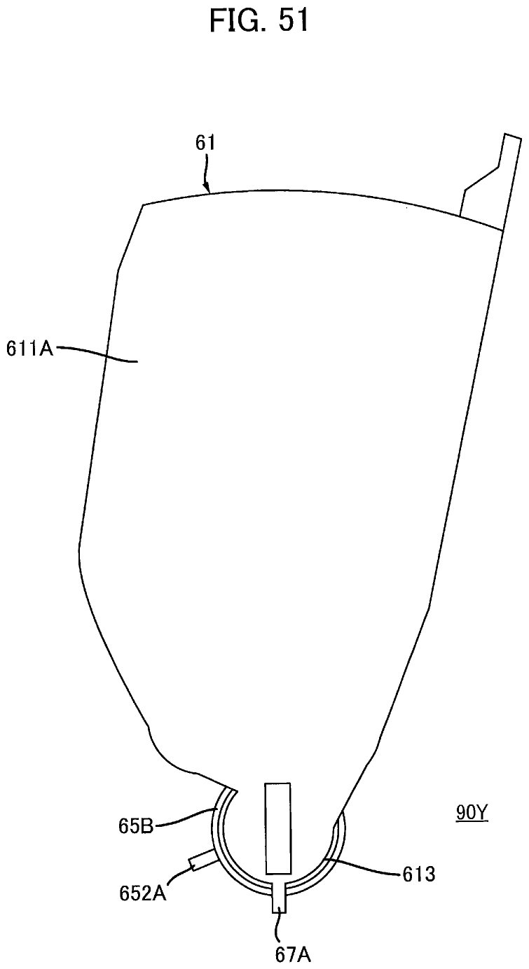

FIG. 51 is a side view of the toner container.

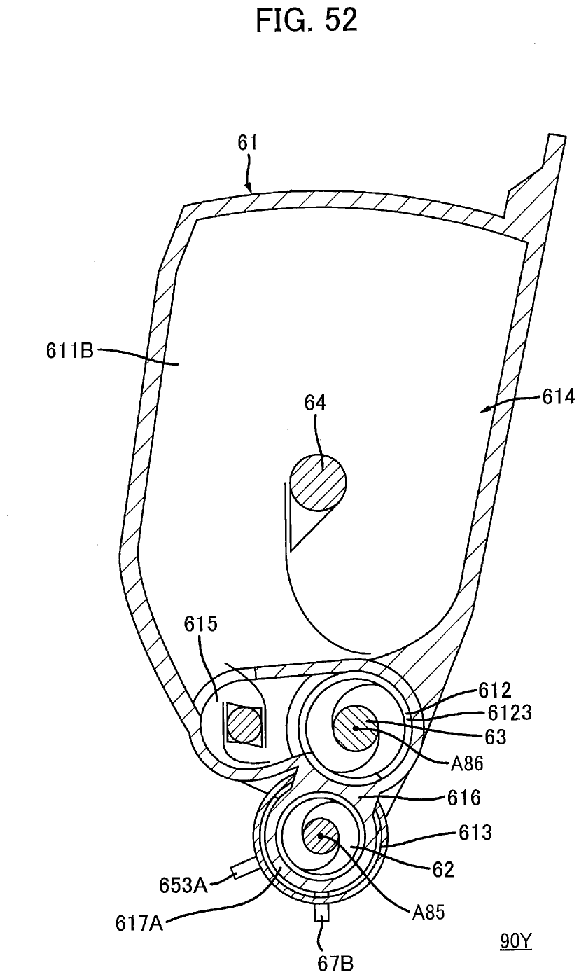

FIG. 52 is a cross-sectional view of the toner container taken along line LII-LII of FIG. 50.

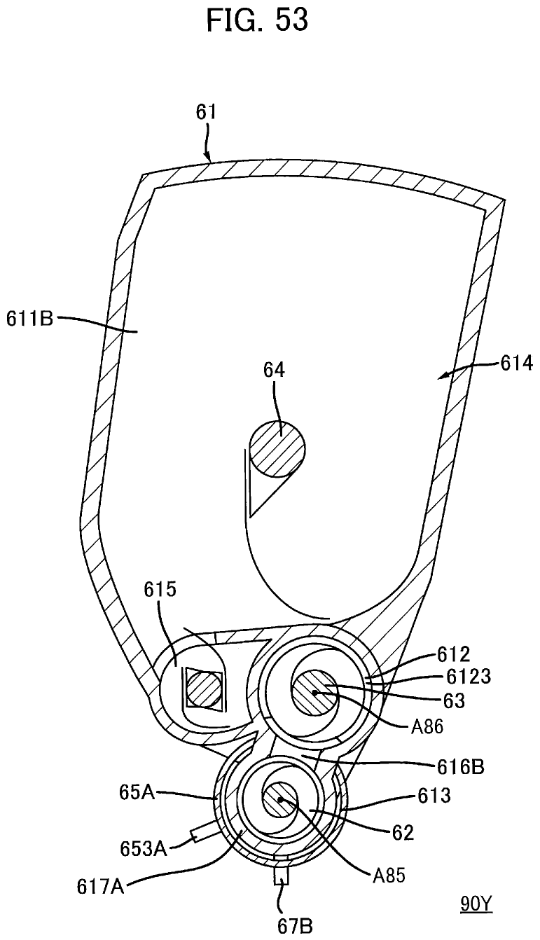

FIG. 53 is a cross-sectional view of the toner container taken along line LIII-LIII of FIG. 50.

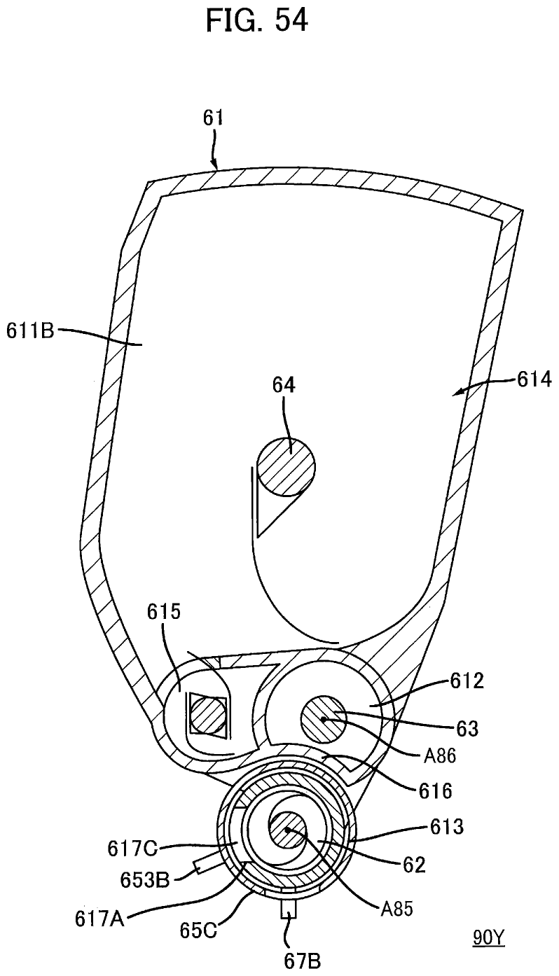

FIG. 54 is a cross-sectional view of the toner container taken along line LIV-LIV of FIG. 50.

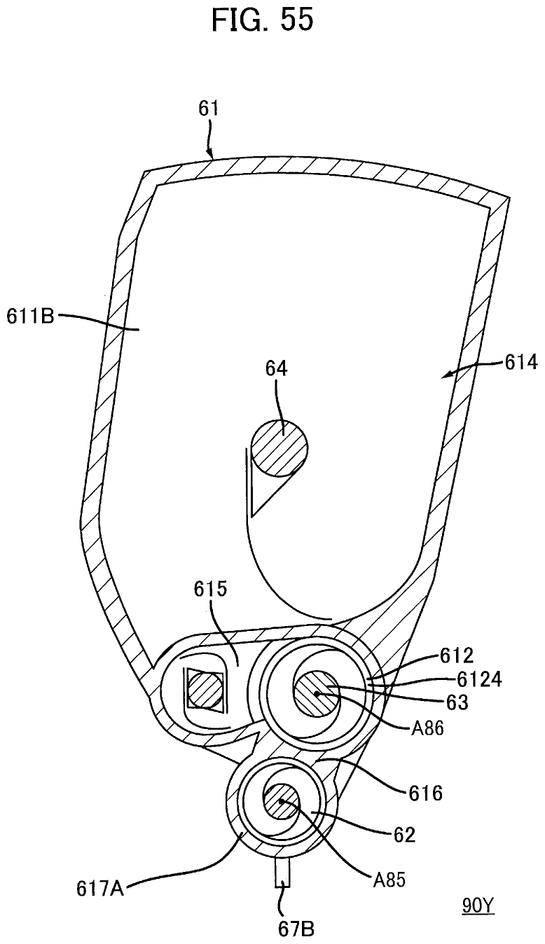

FIG. 55 is a cross-sectional view of the toner container taken along line LV-LV of FIG. 50.

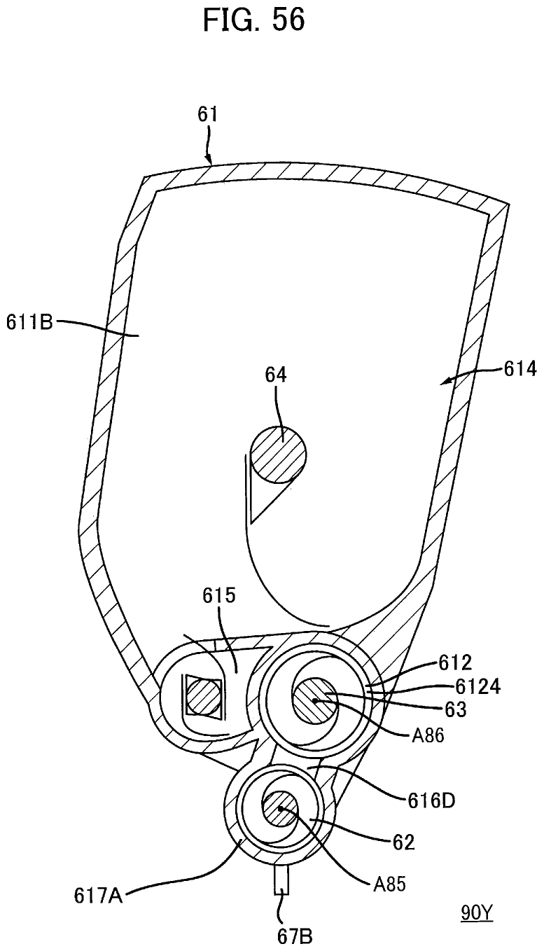

FIG. 56 is a cross-sectional view of the toner container taken along line LVI-LVI of FIG. 50.

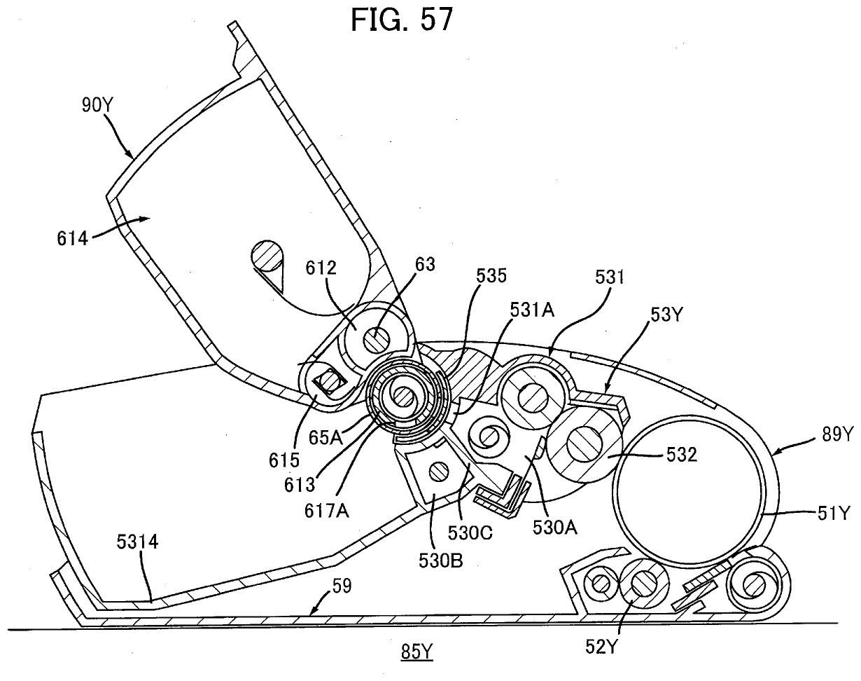

FIG. 57 is a view for explaining attachment of the toner container to the drum cartridge, and specifically illustrating a state where a second toner storage chamber of the toner container is positioned relative to the drum cartridge.

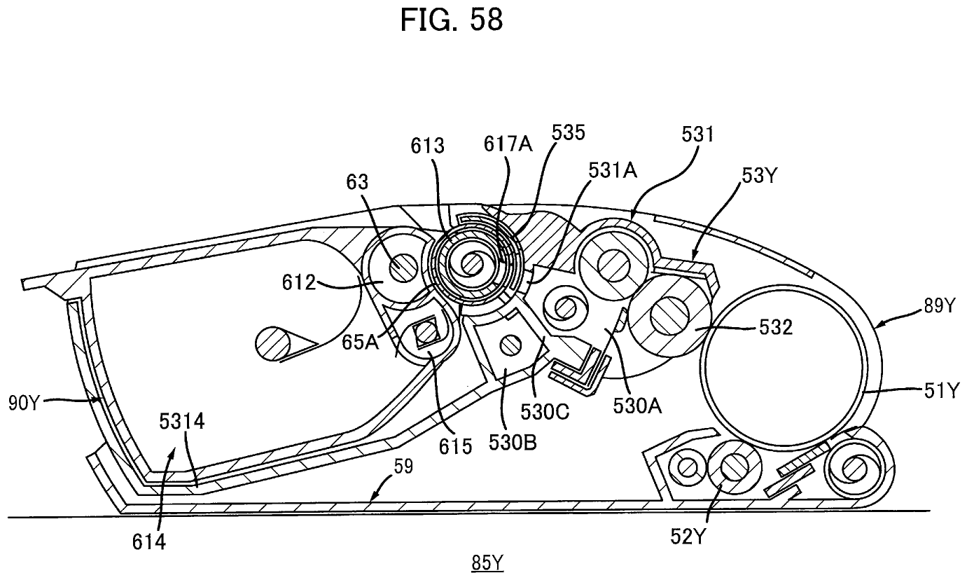

FIG. 58 is a view for explaining, subsequently to FIG. 57, the attachment of the toner container to the drum cartridge, and specifically illustrating a state where the attachment of the toner container to the drum cartridge is completed.

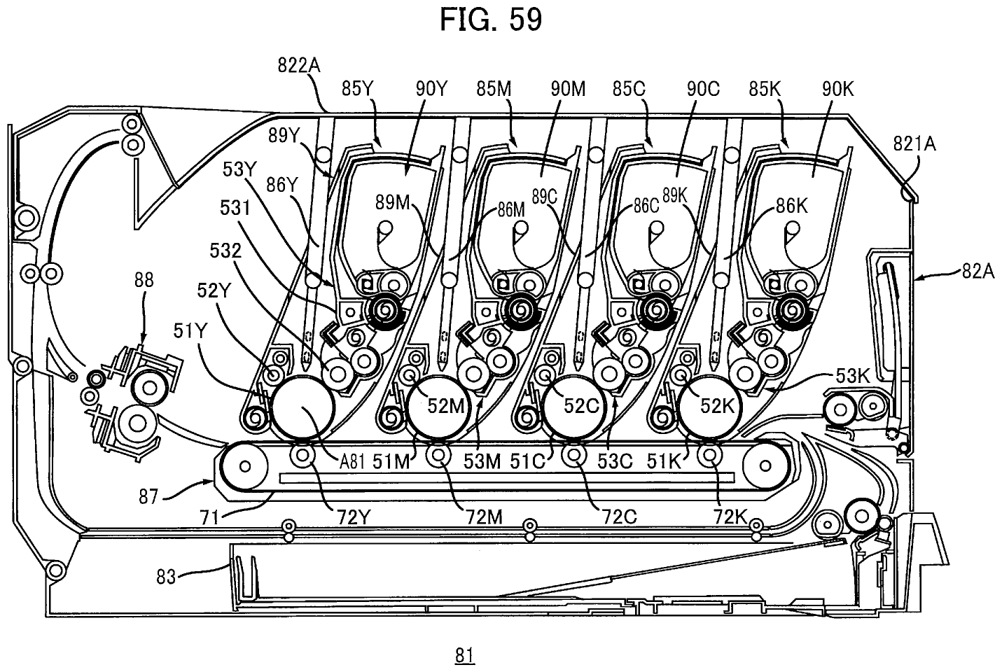

FIG. 59 is an outline view of an image forming apparatus.

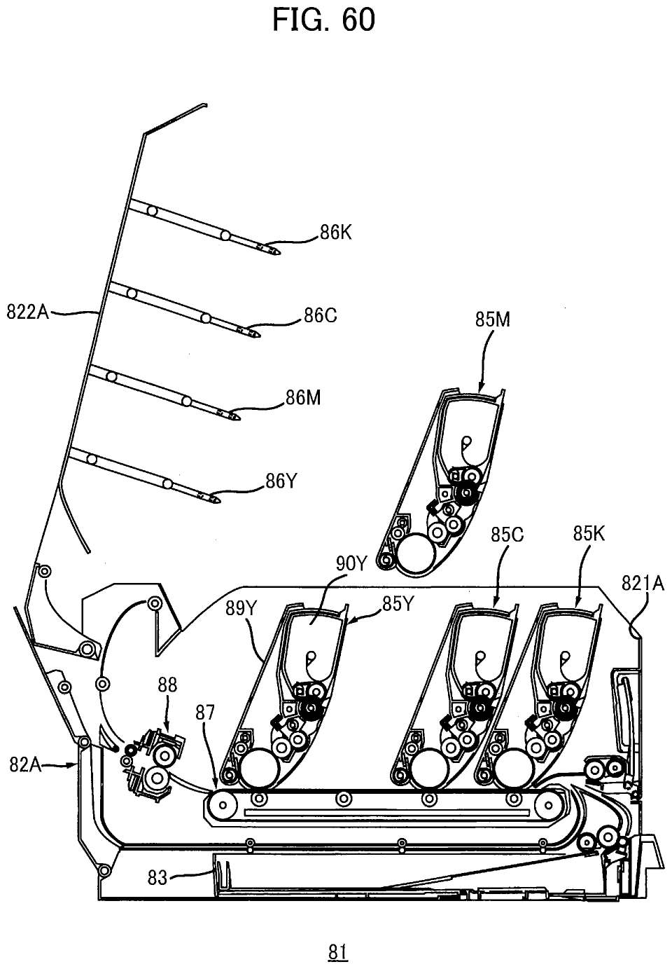

FIG. 60 is a view illustrating a state where a cover is at its opening position in the image forming apparatus of FIG. 59.

### 1. Outline of Image Forming Apparatus 1

The outline of an image forming apparatus 1 will be described with reference to FIGS. 1 and 2.

As illustrated in FIG. 1, the image forming apparatus 1 includes a main body housing 2, a sheet accommodation portion 3, a cartridge 4, an exposing device 5, and a fixing device 6.

<1.1 Main Body Housing 2>

The main body housing 2 houses therein the sheet accommodation portion 3, cartridge 4, exposing device 5, and fixing device 6. The main body housing 2 has an opening 21 and includes a cover 22. The cover 22 is movable between a closing position (see FIG. 1) and an opening position (see FIG. 2). As illustrated in FIG. 1, in a state where the cover 22 is at the closing position, the cover 22 closes the opening 21. As illustrated in FIG. 2, in a state where the cover 22 is at the opening position, the cover 22 opens the opening 21, i.e., the opening 21 is open.

<1.2 Sheet Accommodation Portion 3>

As illustrated in FIG. 1, the sheet accommodation portion 3 can accommodate therein a sheet S. The sheet S in the sheet accommodation portion 3 is conveyed toward a transfer roller 40. The transfer roller 40 will be described later.

<1.3 Cartridge 4>

The cartridge 4 is attachable to and detachable from the image forming apparatus 1. Specifically, the cartridge 4 is attachable to and detachable from the main body housing 2 of the image forming apparatus 1. In a state where the cartridge 4 is attached to the image forming apparatus 1 (specifically, to the main body housing 2), the cartridge 4 is positioned inside the main body housing 2. As illustrated in FIG. 2, in a state where the cover 22 is at the opening position, the cartridge 4 is attachable to and detachable from the image forming apparatus 1 (specifically, the main body housing 2) through the opening 21. In other words, in a state where the cover 22 is at the opening position, the cartridge 4 can be replaced with a new cartridge 4 in the image forming apparatus 1, i.e., the user can replace the cartridge 4 with a new cartridge 4 in the image forming apparatus 1. That is, in a state where the cover 22 is at the opening position, the cartridge 4 can be replaced with respect to the image forming apparatus 1.

As illustrated in FIG. 1, the cartridge 4 includes a drum cartridge 7 and a toner container 8.

<1.3.1 Drum Cartridge 7>

The drum cartridge 7 includes a photosensitive drum 41, a charging roller 42, a developing device 43, and a transfer roller 40. In other words, the cartridge 4 includes the photosensitive drum 41 and the developing device 43.

<1.3.1.1 Photosensitive Drum 41>

The photosensitive drum 41 is rotatable about a first axis Al. In a state where the cartridge 4 is attached to the image forming apparatus 1, the first axis Al extends in a first direction. The photosensitive drum 41 extends in the first direction. The photosensitive drum 41 has a cylindrical shape.

<1.3.1.2 Charging Roller 42>

The charging roller 42 charges the photosensitive drum 41. The image forming apparatus 1 may have a scorotron charger in place of the charging roller 42.

<1.3.1.3 Developing Device 43>

The developing device 43 is configured to supply toner in the toner container 8 to the photosensitive drum 41. The developing device 43 includes a developing housing 431 and a developing roller 432.

The developing housing 431 can store toner from the toner container 8.

The developing roller 432 is configured to supply toner in the developing housing 431 to the photosensitive drum 41. The developing roller 432 is rotatably supported by the developing housing 431. The developing roller 432 is in contact with the photosensitive drum 41. The developing roller 432 may be configured to come into contact with and separate from the photosensitive drum 41. The developing roller 432 extends in the first direction. The developing roller 432 is rotatable about a developing axis A2. In a state where the cartridge 4 is attached to the image forming apparatus 1, the developing axis A2 extends in the first direction.

<1.3.1.4 Transfer Roller 40>

The transfer roller 40 is configured to transfer toner on the photosensitive drum 41 to the sheet S. More specifically, the sheet S fed from the sheet accommodation portion 3 passes between the transfer roller 40 and the photosensitive drum 41. At this time, the transfer roller 40 transfers toner on the photosensitive drum 41 to the sheet S.

<1.3.2 Toner Container 8>

The toner container 8 can store toner therein. The toner container 8 is attachable to and detachable from the cartridge 4, i.e., the toner container 8 can be replaced with respect to the cartridge 4. That is, the toner container 8 can be replaced with a new toner container 8 in the cartridge 4, i.e., the user can replace the toner container 8 with a new toner container 8 in the cartridge 4. In other words, the toner container 8 is attachable to and detachable from the drum cartridge 7, i.e., the toner container 8 can be replaced with respect to the drum cartridge 7. That is, the toner container 8 can be replaced with a new toner container 8 in the drum cartridge 7, i.e. the user can replace the toner container 8 with a new toner container 8 in the drum cartridge 7.

<1.4 Exposing Device 5>

In a state where the cartridge 4 is attached to the image forming apparatus 1, the exposing device 5 is configured to expose the peripheral surface of the photosensitive drum 41 charged by the charging roller 42. The developing device 43 supplies toner to the exposed peripheral surface of the photosensitive drum 41. In the present embodiment, the exposing device 5 is a laser scan unit. The exposing device 5 may be an LED head.

<1.5 Fixing Device 6>

The fixing device 6 is configured to fix toner to the sheet S. In the present embodiment, the fixing device 6 applies heat and pressure to the sheet S having toner transferred thereto to fix the toner to the sheet S. The sheet S that has passed through the fixing device 6 is discharged onto the upper surface of the main body housing 2.

### 2. Drum Cartridge 7A according to First Embodiment

In the present disclosure, in a state where the cartridge 4 is attached to the image forming apparatus 1, toner that has not been transferred from the photosensitive drum 41 to the sheet S and thus remains on the peripheral surface of the photosensitive drum 41 can be collected to the developing device 43. Hereinafter, the toner collected from the photosensitive drum 41 to the developing device 43 is defined as “collected toner”.

In a state where the cartridge 4 is attached to the image forming apparatus 1, the cartridge 4 can circulate toner between the developing device 43 and the toner container 8. In a state where the cartridge 4 is attached to the image forming apparatus 1, the cartridge 4 can mix the collected toner and unused toner with each other in the developing device 43 and toner container 8 and then supply the collected toner once again to the photosensitive drum 41. The unused toner refers to toner that has never been supplied to the photosensitive drum 41.

Next, a cartridge 4A and a drum cartridge 7A according to a first embodiment will be described while referring to FIGS. 3 to 6, 8, 9, and 12. The cartridge 4A according to the first embodiment includes the drum cartridge 7A and a toner container 8A.

As illustrated in FIG. 3, the drum cartridge 7A includes a drum frame 44, a drum cleaner 45, a toner pipe 46 (see FIG. 4), a seal member 47 (see FIG. 4), and a collected toner conveying member 48 (see FIG. 4) in addition to the above-described photosensitive drum 41, charging roller 42, and developing device 43. In other words, the cartridge 4A includes the drum frame 44, drum cleaner 45, toner pipe 46, seal member 47, and collected toner conveying member 48.

<2.1 Drum Frame 44>

As illustrated in FIG. 5, the drum frame 44 includes two drum side plates 441A and 441B.

The drum side plate 441A is positioned at one end portion in the first direction of the drum frame 44. The drum side plate 441A supports one end portion in the first direction of the photosensitive drum 41. As illustrated in FIG. 4, the drum side plate 441A extends in a direction crossing the first direction. Preferably, the drum side plate 441A extends in a direction orthogonal to the first direction. The drum side plate 441A has two holes 442A and 443A.

The hole 442A is positioned separated from the photosensitive drum 41 in a direction connecting the first axis Al and developing axis A2. The hole 442A is an elongated hole. The hole 442A extends in the direction connecting the first axis Al and developing axis A2.

The hole 443A is positioned between the photosensitive drum 41 and the hole 442A in the direction connecting the first axis Al and developing axis A2. The hole 443A is an elongated hole. The hole 443A extends in the direction connecting the first axis Al and developing axis A2.

As illustrated in FIG. 5, the drum side plate 441B is positioned at the other end portion in the first direction of the drum frame 44. The drum side plate 441B supports the other end portion in the first direction of the photosensitive drum 41. The drum side plates 441A and 441B support respectively the one end portion and the other end portion of the photosensitive drum 41 in the first direction, whereby the drum frame 44 supports the photosensitive drum 41. The drum side plate 441B is positioned separated from the drum side plate 441A in the first direction. The drum side plate 441B extends in a direction crossing the first direction. Preferably, the drum side plate 441B extends in a direction orthogonal to the first direction. The drum side plate 441B has two holes 442B and 443B.

The hole 442B is positioned separated from the photosensitive drum 41 in the direction connecting the first axis A1 and developing axis A2. Like the hole 442A, the hole 442B is an elongated hole. The hole 442B extends in the direction connecting the first axis A1 and developing axis A2.

The hole 443B is positioned between the photosensitive drum 41 and the hole 442B in the direction connecting the first axis A1 and developing axis A2. Like the hole 443A, the hole 443B is an elongated hole. The hole 443B extends in the direction connecting the first axis A1 and developing axis A2.

<2.2 Details of Developing Device 43>

As illustrated in FIG. 6, the developing device 43 includes a developing conveying member 433, a developing shutter 434, two projections 435A, 435B and two projections 436A, 436B, in addition to the above-described developing housing 431 and developing roller 432.

<2.2.1 Details of Developing Housing 431>

The developing housing 431 is positioned between the drum side plate 441A and the drum side plate 441B in the first direction. The developing housing 431 includes two developing side plates 4311A, 4311B, a main body part 4312, a protruding part 4313, and a bottom plate 4314.

<2.2.1.1 Developing Side Plates 4311A, 4311B>

The developing side plate 4311A is positioned at one end portion in the first direction of the developing housing 431. The developing side plate 4311A is positioned between the drum side plate 441A and the drum side plate 441B in the first direction. The developing side plate 4311A supports one end portion in the first direction of the developing roller 432. The developing side plate 4311A includes a guide 4315A.

The guide 4315A is configured to guide a projection 56A (see FIG. 8) of a toner container 8A (see FIG. 8) during attachment of the toner container 8A to the drum cartridge 7A. The toner container 8A and the projection 56A will be described later. The guide 4315A extends in the same direction as the direction in which a guide 4315B (see FIG. 3) of the developing side plate 4311B extends. The guide 4315B will be described later.

The developing side plate 4311B is positioned at the other end portion in the first direction of the developing housing 431. The developing side plate 4311B is positioned separated from the developing side plate 4311A in the first direction. The developing side plate 4311B is positioned between the developing side plate 4311A and the drum side plate 441B in the first direction. The developing side plate 4311B supports the other end portion in the first direction of the developing roller 432. The developing side plates 4311A and 4311B support respectively the one end portion and the other end portion of the developing roller 432 in the first direction, whereby the developing roller 432 is supported by the developing housing 431. As illustrated in FIG. 3, the developing side plate 4311B includes the guide 4315B.

The guide 4315B is configured to guide a projection 56B (see FIG. 8) of the toner container 8A during attachment of the toner container 8A to the drum cartridge 7A. The projection 56B will be described later. The guide 4315B extends in a direction crossing both the first direction and a moving direction of the developing device 43. The direction in which the guide 4315B extends is defined as “guide direction”. The guide direction is preferably orthogonal to the first direction and crosses the moving direction of the developing device 43. The moving direction of the developing device 43 will be described later.

<2.2.1.2 Main Body Part 4312>

As illustrated in FIG. 6, the main body part 4312 is positioned between the developing side plate 4311A and the developing side plate 4311B in the first direction. The main body part 4312 extends in the first direction. The main body part 4312 includes a developing chamber 430, a toner receiving port 431A, a toner return port 431B, and a second toner return port 431C. In other words, the developing housing 431 includes the developing chamber 430, toner receiving port 431A, toner return port 431B, and second toner return port 431C.

The developing chamber 430 is the inner space of the main body part 4312. The developing chamber 430 is positioned between the developing side plate 4311A and the developing side plate 4311B in the first direction. The developing chamber 430 can store therein toner from the toner container 8A. The developing roller 432 can supply toner in the developing chamber 430 to the photosensitive drum 41.

In a state where the toner container 8A is attached to the drum cartridge 7A, the toner receiving port 431A can receive toner discharged from a toner discharge port 511A (see FIG. 9) of the toner container 8A. The toner discharge port 511A will be described later. The toner receiving port 431A is positioned at the center portion in the first direction of the developing housing 431. More specifically, the toner receiving port 431A is positioned at the center portion in the first direction of the main body part 4312. The toner receiving port 431A overlaps an upstream end E1 of a developing first conveying member 433A as viewed in a direction that is orthogonal to the first direction and is directed from the toner receiving port 431A toward the developing first conveying member 433A. The developing first conveying member 433A will be described later. The toner receiving port 431A overlaps an upstream end E11 of a developing third conveying member 433C as viewed in a direction that is orthogonal to the first direction and is directed from the toner receiving port 431A toward the developing third conveying member 433C. The developing third conveying member 433C will be described later. The toner receiving port 431A is communicated with the developing chamber 430.

In a state where the toner container 8A is attached to the drum cartridge 7A, toner can be returned to a returned toner receiving port 511B (see FIG. 9) of the toner container 8A through the toner return port 431B. The toner return port 431B is positioned separated from the toner receiving port 431A in the first direction. The toner return port 431B is positioned between the developing side plate 4311A and the toner receiving port 431A in the first direction. The toner return port 431B is positioned at one end portion in the first direction of the main body part 4312. The toner return port 431B overlaps a downstream end E2 of the developing first conveying member 433A as viewed in a direction that is orthogonal to the first direction and is directed from the toner return port 431B toward the developing first conveying member 433A. The toner return port 431B is communicated with the developing chamber 430.

In a state where the toner container 8A is attached to the drum cartridge 7A, toner can be returned to a second returned toner receiving port 511C (see FIG. 9) of the toner container 8A through the second toner return port 431C. The second toner return port 431C is positioned on the opposite side of the toner receiving port 431A from the toner return port 431B in the first direction. The second toner return port 431C is positioned separated from the toner receiving port 431A in the first direction. The second toner return port 431C is positioned between the developing side plate 4311B and the toner receiving port 431A in the first direction. The second toner return port 431C is positioned at the other end portion in the first direction of the developing housing 431. The second toner return port 431C is positioned at the other end portion in the first direction of the main body part 4312. The second toner return port 431C overlaps a downstream end E12 of the developing third conveying member 433C as viewed in a direction that is orthogonal to the first direction and is directed from the second toner return port 431C toward the developing third conveying member 433C. The second toner return port 431C is communicated with the developing chamber 430.

<2.2.1.3 Protruding Part 4313>

The protruding part 4313 is positioned on the opposite side of the developing side plate 4311A from the developing side plate 4311B in the first direction. The protruding part 4313 protrudes from the developing side plate 4311A. The protruding part 4313 extends in the first direction. The inner space of the protruding part 4313 is communicated with the developing chamber 430. As illustrated in FIG. 4, the protruding part 4313 includes a collected toner receiving port 431D. In other words, the developing housing 431 includes the collected toner receiving port 431D.

The collected toner receiving port 431D is positioned on the opposite side of the developing side plate 4311A from the developing side plate 4311B in the first direction. The collected toner receiving port 431D can receive the collected toner from the toner pipe 46. The collected toner receiving port 431D is communicated with the inner space of the protruding part 4313. Accordingly, the collected toner receiving port 431D is communicated with the developing chamber 430 through the inner space of the protruding part 4313. In a state where the cartridge 4A is attached to the image forming apparatus 1 (specifically, to the main body housing 2), the collected toner receiving port 431D is positioned further upward than the toner return port 431B (see FIG. 6). With this configuration, collected toner can be conveyed from the collected toner receiving port 431D to the toner return port 431B by using gravity.

<2.2.1.4 Bottom Plate 4314>

As illustrated in FIG. 5, the bottom plate 4314 is positioned between the developing side plate 4311A and developing side plate 4311B in the first direction. The bottom plate 4314 extends in the first direction. One end portion in the first direction of the bottom plate 4314 is connected to the developing side plate 4311A. The other end in the first direction of the bottom plate 4314 is connected to the developing side plate 4311B. The bottom plate 4314 has a plurality of holes 4314A, 4314B, and 4314C.

The hole 4314A is a hole for fixing a toner first shutter 55A (see FIG. 8) to the developing device 43 during attachment of the toner container 8A to the drum cartridge 7A. The toner first shutter 55A will be described later. The hole 4314A is positioned at the center portion in the first direction of the bottom plate 4314. During attachment of the toner container 8A to the drum cartridge 7A, a projection 551 (see FIG. 8) of the toner first shutter 55A is fitted into the hole 4314A, whereby the toner first shutter 55A is fixed to the developing device 43. The projection 551 will be described later.

The hole 4314B is a hole for fixing a toner second shutter 55B (see FIG. 8) to the developing device 43 during attachment of the toner container 8A to the drum cartridge 7A. The toner second shutter 55B will be described later. The hole 4314B is positioned at the one end portion in the first direction of the bottom plate 4314. During attachment of the toner container 8A to the drum cartridge 7A, a projection 552 (see FIG. 8) of the toner second shutter 55B is fitted into the hole 4314B, whereby the toner second shutter 55B is fixed to the developing device 43. The projection 552 will be described later.

The hole 4314C is a hole for fixing a toner third shutter 55C (see FIG. 8) to the developing device 43 during attachment of the toner container 8A to the drum cartridge 7A. The toner third shutter 55C will be described later. The hole 4314C is positioned at the other end portion in the first direction of the bottom plate 4314. During attachment of the toner container 8A to the drum cartridge 7A, a projection 553 (see FIG. 8) of the toner third shutter 55C is fitted into the hole 4314C, whereby the toner third shutter 55C is fixed to the developing device 43. The projection 553 will be described later.

<2.2.3 Developing Conveying Member 433>

As illustrated in FIG. 6, the developing conveying member 433 is positioned inside the developing housing 431. More specifically, the developing conveying member 433 is positioned inside the developing chamber 430 and protruding part 4313, i.e., the developing conveying member 433 is disposed over both the inside of the developing chamber 430 and the inside of the protruding part 4313. The developing conveying member 433 includes a developing first conveying member 433A, a developing second conveying member 433B, and a developing third conveying member 433C. In other words, the developing device 43 includes the developing first conveying member 433A, developing second conveying member 433B, and developing third conveying member 433C.

<2.2.3.1 Developing First Conveying Member 433A>

The developing first conveying member 433A is positioned inside the developing chamber 430. The developing first conveying member 433A is configured to convey toner in the developing chamber 430 in the first direction. The developing first conveying member 433A is configured to convey toner from the toner receiving port 431A toward the toner return port 431B. The developing first conveying member 433A extends in the first direction. The developing first conveying member 433A extends from the toner receiving port 431A to the toner return port 431B. The developing first conveying member 433A has the upstream end E1 and the downstream end E2 in the toner conveying direction from the toner receiving port 431A toward the toner return port 431B. In the present embodiment, the developing first conveying member 433A is an auger screw. The developing first conveying member 433A is rotatable about an axis A3. The axis A3 extends in the first direction.

<2.2.3.2 Developing Second Conveying Member 433B>

The developing second conveying member 433B is positioned inside the protruding part 4313. The developing second conveying member 433B is configured to convey toner in the protruding part 4313 in the first direction. The developing second conveying member 433B is configured to convey toner from the collected toner receiving port 431D (see FIG. 4) toward the toner return port 431B. The developing second conveying member 433B extends in the first direction. The developing second conveying member 433B extends from the collected toner receiving port 431D to the toner return port 431B. In the present embodiment, the developing second conveying member 433B is an auger screw. The developing second conveying member 433B is connected to the downstream end E2 of the developing first conveying member 433A. The developing second conveying member 433B is rotatable together with the developing first conveying member 433A. The developing second conveying member 433B is rotatable about the axis A3.

<2.2.3.3 Developing Third Conveying Member 433C>

The developing third conveying member 433C is positioned inside the developing chamber 430. The developing third conveying member 433C is configured to convey toner in the developing chamber 430 in the first direction. The developing third conveying member 433C is configured to convey toner from the toner receiving port 431A toward the second toner return port 431C. The developing third conveying member 433C extends in the first direction. The developing third conveying member 433C extends from the toner receiving port 431A to the second toner return port 431C. The developing third conveying member 433C has the upstream end E11 and the downstream end E12 in the toner conveying direction from the toner receiving port 431A to the second toner return port 431C. In the present embodiment, the developing third conveying member 433C is an auger screw. The developing third conveying member 433C is connected to the upstream end E1 of the developing first conveying member 433A. The developing third conveying member 433C is rotatable together with the developing first conveying member 433A. The developing third conveying member 433C is rotatable about the axis A3.

<2.2.4 Developing Shutter 434>

The developing shutter 434 is positioned between the developing side plate 4311A and the developing side plate 4311B in the first direction. The developing shutter 434 extends in the first direction. The developing shutter 434 is movable between a closing position (see FIG. 3) and an opening position (see FIG. 12). In a state where the developing shutter 434 is at the closing position, the developing shutter 434 closes the toner receiving port 431A, toner return port 431B, and second toner return port 431C. In a state where the developing shutter 434 is at the opening position, the developing shutter 434 closes the toner receiving port 431A, toner return port 431B, and second toner return port 431C, i.e., the toner receiving port 431A, toner return port 431B, and second toner return port 431C are open. The developing shutter 434 includes a developing first shutter 434A, a developing second shutter 434B, a developing third shutter 434C, a connection part 434D, and a connection part 434E. In other words, the developing device 43 includes the developing first shutter 434A and developing second shutter 434B.

<2.2.4.1 Developing First Shutter 434A>

The developing first shutter 434A is configured to open and close the toner receiving port 431A. In a state where the developing shutter 434 is at the closing position, the developing first shutter 434A closes the toner receiving port 431A. In a state where the developing shutter 434 is at the opening position, the developing first shutter 434A opens the toner receiving port 431A, i.e., the toner receiving port 431A is open. The developing first shutter 434A is positioned at the center portion in the first direction of the developing shutter 434. The developing first shutter 434A extends in the first direction.

<2.2.4.2 Developing Second Shutter 434B>

The developing second shutter 434B is configured to open and close the toner return port 431B. In a state where the developing shutter 434 is at the closing position, the developing second shutter 434B closes the toner return port 431B. In a state where the developing shutter 434 is at the opening position, the developing second shutter 434B opens the toner return port 431B, i.e., the toner return port 431B is open. The developing second shutter 434B is positioned at one end portion in the first direction of the developing shutter 434. The developing second shutter 434B is positioned separated from the developing first shutter 434A in the first direction. The developing second shutter 434B extends in the first direction.

<2.2.4.3 Developing Third Shutter 434C>

The developing third shutter 434C is configured to open and close the second toner return port 431C. In a state where the developing shutter 434 is at the closing position, the developing third shutter 434C closes the second toner return port 431C. In a state where the developing shutter 434 is at the opening position, the developing third shutter 434C opens the second toner return port 431C, i.e., the second toner return port 431C is open. The developing third shutter 434C is positioned at the other end portion in the first direction of the developing shutter 434. The developing third shutter 434C is positioned on the opposite side of the developing first shutter 434A from the developing second shutter 434B in the first direction. The developing third shutter 434C is positioned separated from the developing first shutter 434A in the first direction. The developing third shutter 434C extends in the first direction.

<2.2.4.4 Connection Parts 434D, 434E>

The connection part 434D connects the developing first shutter 434A and the developing second shutter 434B. The connection part 434D is positioned between the developing first shutter 434A and the developing second shutter 434B in the first direction. The connection part 434D extends in the first direction. One end portion of the connection part 434D in the first direction is connected to the developing second shutter 434B. The other end portion of the connection part 434D in the first direction is connected to the developing first shutter 434A.

The connection part 434E connects the developing first shutter 434A and the developing third shutter 434C. The connection part 434E is positioned between the developing first shutter 434A and the developing third shutter 434C in the first direction. The connection part 434E extends in the first direction. One end portion of the connection part 434E in the first direction is connected to the developing first shutter 434A. The other end portion of the connection part 434E in the first direction is connected to the developing third shutter 434C.

<2.2.5 Projections 435A, 435B, 436A, 436B>

The projection 435A is positioned on the opposite side of the developing side plate 4311A from the developing side plate 4311B in the first direction. The projection 435Ais positioned separated from the photosensitive drum 41 in the direction connecting the first axis A1 and the developing axis A2. The projection 435A extends from the developing side plate 4311A. The projection 435A may be assembled to the developing side plate 4311A. The projection 435A extends in the first direction. The projection 435A is fitted in the hole 442A (see FIG. 4) of the drum side plate 441A.

The projection 435B is positioned on the opposite side of the developing side plate 4311B from the developing side plate 4311A in the first direction. The projection 435B is positioned separated from the photosensitive drum 41 in the direction connecting the first axis A1 and the developing axis A2. The projection 435B extends from the developing side plate 4311B. The projection 435B may be assembled to the developing side plate 4311B. The projection 435B extends in the first direction. The projection 435B is fitted in the hole 442B (see FIG. 5) of the drum side plate 441B.

The projection 436Ais positioned on the opposite side of the developing side plate 4311A from the developing side plate 4311B in the first direction. The projection 436Ais positioned between the photosensitive drum 41 and the projection 435A in the direction connecting the first axis A1 and the developing axis A2. The projection 436A extends in the first direction. The projection 436A extends along the developing axis A2. In the present embodiment, the projection 436A is one end portion of the shaft of the developing roller 432. The projection 436A may extend from the developing side plate 4311A. The projection 436A may be assembled to the developing side plate 4311A. The projection 436A is fitted in the hole 443A (see FIG. 4) of the drum side plate 441A.

The projection 436B is positioned on the opposite side of the developing side plate 4311B from the developing side plate 4311A in the first direction. The projection 436B is positioned between the photosensitive drum 41 and the projection 435B in the direction connecting the first axis A1 and the developing axis A2. The projection 436B extends in the first direction. The projection 436B extends along the developing axis A2. In the present embodiment, the projection 436B is the other end portion of the shaft of the developing roller 432. The projection 436B may extend from the developing side plate 4311B. The projection 436B may be assembled to the developing side plate 4311B. The projection 436B is fitted in the hole 443B (see FIG. 5) of the drum side plate 441B.

The projection 435A is fitted into the hole 442A of the drum side plate 441A, the projection 435B is fitted into the hole 442B of the drum side plate 441B, the projection 436A is fitted into the hole 443A of the drum side plate 441A, and the projection 436B is fitted into the hole 443B of the drum side plate 441B, whereby the developing device 43 is supported by the drum frame 44 so as to be movable relative to the photosensitive drum 41. The developing device 43 is movable in the direction connecting the first axis A1 and the developing axis A2. The direction connecting the first axis A1 and the developing axis A2 is defined as the moving direction of the developing device 43.

<2.3 Drum Cleaner 45>

As illustrated in FIG. 3, the drum cleaner 45 is configured to clean the peripheral surface of the photosensitive drum 41. The drum cleaner 45 removes, from the peripheral surface of the photosensitive drum 41, toner that remains on the peripheral surface of the photosensitive drum 41 as a result of not having been transferred from the photosensitive drum 41 to the sheet S. The toner that has been removed from the peripheral surface of the photosensitive drum 41 by the drum cleaner 45 becomes the collected toner.

The drum cleaner 45 includes a cleaner housing 451 and a cleaning member 452.

As illustrated in FIG. 5, the cleaner housing 451 is positioned between the drum side plates 441A and 441B in the first direction. The cleaner housing 451 extends in the first direction. One end portion in the first direction of the cleaner housing 451 is connected to the drum side plate 441A. The other end portion in the first direction of the cleaner housing 451 is connected to the drum side plate 441B. As illustrated in FIG. 3, the cleaner housing 451 has an opening 453. The cleaner housing 451 stores therein the collected toner.

The cleaning member 452 is assembled to the cleaner housing 451. The cleaning member 452 extends in the first direction. The cleaning member 452 has a plate-like shape. The cleaning member 452 cleans the peripheral surface of the photosensitive drum 41. More specifically, the edge of the cleaning member 452 contacts the peripheral surface of the photosensitive drum 41. When the photosensitive drum 41 rotates, toner on the peripheral surface of the photosensitive drum 41 contacts the edge of the cleaning member 452 and is thus removed from the peripheral surface of the photosensitive drum 41. The removed toner passes through the opening 453 and then is stored in the cleaner housing 451.

<2.4 Toner Pipe 46>

As illustrated in FIGS. 4 and 5, the toner pipe 46 is positioned on the opposite side of the drum side plate 441A from the drum side plate 441B in the first direction. The toner pipe 46 is fixed to the drum frame 44. More specifically, the toner pipe 46 is fixed to the drum side plate 441A. The toner pipe 46 passes through one side in the first direction of the developing roller 432. The toner pipe 46 allows the collected toner to pass therethrough. The toner pipe 46 is connected to the protruding part 4313 of the developing housing 431. The toner pipe 46 has a collected toner discharge port 461. Note that although the toner pipe 46 is connected to the developing housing 431 in the present embodiment, the toner pipe 46 may be configured to be connected to the toner container 8A, not to the developing housing 431.

The collected toner discharge port 461 is a port through which the collected toner in the toner pipe 46 can be discharged. The collected toner discharge port 461 is communicated with the collected toner receiving port 431D of the developing housing 431.

<2.5 Seal Member 47>

As illustrated in FIG. 4, the seal member 47 is positioned around the collected toner receiving port 431D. The seal member 47 seals a portion between the toner pipe 46 and the developing device 43. More specifically, the seal member 47 seals a portion between the toner pipe 46 and the protruding part 4313. The seal member 47 is elastically deformable in accordance with movement of the developing device 43 relative to the photosensitive drum 41. The seal member 47 is made of sponge, for example.

<2.6 Collected Toner Conveying Member 48>

As illustrated in FIGS. 4 and 5, the collected toner conveying member 48 is positioned inside the cleaner housing 451 and toner pipe 46, i.e., the collected toner conveying member 48 is disposed over both the inside of the cleaner housing 451 and the inside of the oner pipe 46. The collected toner conveying member 48 is configured to convey toner in the cleaner housing 451 and the collected toner in the toner pipe 46 toward the collected toner discharge port 461. In the present embodiment, the collected toner conveying member 48 is a shaftless screw.

### 3. Toner Container 8A according to First Embodiment

Next, the toner container 8A according to the first embodiment will be described while referring to FIGS. 5 to 12. In the following description of the toner container 8A, when referring to the first direction, it is assumed that the toner container 8A has already been attached to the drum cartridge 7A.

As illustrated in FIG. 7, the toner container 8A includes a toner housing 51, a toner conveying member 52, a first agitator 53, a second agitator 54, a toner first shutter 55A, a toner second shutter 55B (see FIG. 8), a toner third shutter 55C (see FIG. 8), two projections 56A, 56B (see FIG. 8), and two projections 57A, 57B (see FIG. 8).

<3.1 Toner Housing 51>

The toner housing 51 includes a first toner storage part 511, a second toner storage part 512, and a partition wall 513. In other words, the toner container 8A includes the first toner storage part 511 and second toner storage part 512.

<3.1.1 First Toner Storage Part 511>

The first toner storage part 511 stores therein toner to be supplied to the developing housing 431. In a state where the toner container 8A is attached to the drum cartridge 7A, the first toner storage part 511 is positioned between the developing housing 431 (see FIG. 12) and the second toner storage part 512. The first toner storage part 511 has a cylindrical shape. The first toner storage part 511 extends in the first direction. The capacity of the first toner storage part 511 is smaller than that of the second toner storage part 512.

As illustrated in FIG. 9, the first toner storage part 511 has a toner discharge port 511A, a returned toner receiving port 511B, and a second returned toner receiving port 511C. In other words, the toner container 8A has the toner discharge port 511A, returned toner receiving port 511B, and second returned toner receiving port 511C.

The toner discharge port 511A is a port through which toner in the toner container 8A can be discharged. More specifically, toner in the first toner storage part 511 can be discharged through the toner discharge port 511A. The toner discharge port 511A is positioned at the center portion in the first direction of the first toner storage part 511. The toner discharge port 511A is communicated with the inner space of the first toner storage part 511.

The returned toner receiving port 511B can receive returned toner. The returned toner is toner to be returned from the developing device 43 to the toner container 8A. The returned toner receiving port 511B can receive the toner returned from the toner return port 431B (see FIG. 6) to the toner container 8A. The returned toner receiving port 511B is positioned at one end portion in the first direction of the first toner storage part 511. The returned toner receiving port 511B is positioned separated from the toner discharge port 511A in the first direction. The returned toner receiving port 511B is communicated with the inner space of the first toner storage part 511.

The second returned toner receiving port 511C can receive the returned toner. The second returned toner receiving port 511C can receive the toner returned from the second toner return port 431C (see FIG. 6) to the toner container 8A. The second returned toner receiving port 511C is positioned at the other end portion in the first direction of the first toner storage part 511. The second returned toner receiving port 511C is positioned separated from the toner discharge port 511A in the first direction. The second returned toner receiving port 511C is positioned on the opposite side of the toner discharge port 511A from the returned toner receiving port 511B. The second returned toner receiving port 511C is communicated with the inner space of the first toner storage part 511.

<3.1.2 Second Toner Storage Part 512>

The second toner storage part 512 stores therein toner to be supplied to the first toner storage part 511. In a state where the toner container 8A is attached to the drum cartridge 7A, the second toner storage part 512 is positioned separated from the developing housing 431 (see FIG. 12). The second toner storage part 512 extends in the first direction. The capacity of the second toner storage part 512 is larger than that of the first toner storage part 511. The second toner storage part 512 includes two light transmissive members 512A and 512B.

The light transmissive member 512A is assembled to one side plate in the first direction of the second toner storage part 512. The light transmissive member 512A penetrates the one side plate in the first direction of the second toner storage part 512. The light transmissive member 512A is transparent. The light transmissive member 512A allows light to pass therethrough.

The light transmissive member 512B is assembled to the other side plate in the first direction of the second toner storage part 512. The light transmissive member 512B penetrates the other side plate in the first direction of the second toner storage part 512. The light transmissive member 512B is positioned separated from the light transmissive member 512A in the first direction. The light transmissive member 512B and the light transmissive member 512A are aligned in the first direction. The light transmissive member 512B is transparent. The light transmissive member 512B allows light to pass therethrough.

<3.1.3 Partition Wall 513>

The partition wall 513 is positioned between the first toner storage part 511 and the second toner storage part 512. The partition wall 513 separates the first toner storage part 511 and second toner storage part 512 from each other. The partition wall 513 has two passage ports 513A and 513B.

The passage port 513A is positioned between the toner discharge port 511A and the returned toner receiving port 511B in the first direction. The passage port 513A allows toner to pass therethrough between the first toner storage part 511 and the second toner storage part 512.

The passage port 513B is positioned between the toner discharge port 511A and the second returned toner receiving port 511C in the first direction. The passage port 513B is positioned separated from the passage port 513A in the first direction. The passage port 513B allows toner to pass therethrough between the first toner storage part 511 and the second toner storage part 512.

<3.2 Toner Conveying Member 52>

The toner conveying member 52 is positioned inside the first toner storage part 511. The toner conveying member 52 includes a toner first conveying member 52A and a toner second conveying member 52B. In other words, the toner container 8A includes the toner first conveying member 52A and toner second conveying member 52B.

The toner first conveying member 52A is configured to convey toner in the first toner storage part 511 in the first direction. The toner first conveying member 52A conveys toner from the returned toner receiving port 511B toward the toner discharge port 511A. Further, the toner first conveying member 52A conveys toner from the passage port 513A toward the toner discharge port 511A. The toner first conveying member 52A extends in the first direction. The toner first conveying member 52A extends from the returned toner receiving port 511B to the toner discharge port 511A. In the present embodiment, the toner first conveying member 52A is an auger screw. The toner first conveying member 52A is rotatable about an axis A4. The axis A4 extends in the first direction.

The toner second conveying member 52B is configured to convey toner in the first toner storage part 511 in the first direction. The toner second conveying member 52B conveys toner from the second returned toner receiving port 511C toward the toner discharge port 511A. Further, the toner second conveying member 52B conveys toner from the passage port 513B toward the toner discharge port 511A. The toner second conveying member 52B extends in the first direction. The toner second conveying member 52B extends from the second returned toner receiving port 511C to the toner discharge port 511A. In the present embodiment, the toner second conveying member 52B is an auger screw. The toner second conveying member 52B is rotatable together with the toner first conveying member 52A. The toner second conveying member 52B is rotatable about the axis A4.

<3.3 First Agitator 53>

The first agitator 53 is positioned inside the second toner storage part 512. The first agitator 53 is positioned between the first toner storage part 511 and the second agitator 54. The first agitator 53 is configured to convey toner in the second toner storage part 512 toward the first toner storage part 511 while agitating the toner.

<3.4 Second Agitator 54>

The second agitator 54 is positioned inside the second toner storage part 512. The second agitator 54 is positioned on the opposite side of the first agitator 53 from the first toner storage part 511. The second agitator 54 is configured to convey toner in the second toner storage part 512 toward the first agitator 53 while agitating the toner.

<3.5 Toner First Shutter 55A>

As illustrated in FIG. 8, the toner first shutter 55A is positioned at the center portion in the first direction of the first toner storage part 511. The toner first shutter 55A is positioned on the peripheral surface of the first toner storage part 511. The toner first shutter 55A is configured to open and close the toner discharge port 511A (see FIG. 9). More specifically, as illustrated in FIGS. 7 and 10, the toner first shutter 55A is movable between a closing position (see FIG. 7) and an opening position (see FIG. 10) along the peripheral surface of the first toner storage part 511. In a state where the toner first shutter 55A is at the closing position, the toner first shutter 55A closes the toner discharge port 511A. In a state where the toner first shutter 55A is at the opening position, the toner first shutter 55A opens the toner discharge port 511A, i.e., the toner discharge port 511A is open. As illustrated in FIG. 8, the toner first shutter 55A includes a projection 551.

The projection 551 is positioned on the peripheral surface of the toner first shutter 55A. The projection 551 extends from the peripheral surface of the toner first shutter 55A. The projection 551 may be assembled to the peripheral surface of the toner first shutter 55A. As illustrated in FIGS. 11 and 12, during attachment of the toner container 8A to the drum cartridge 7A, the projection 551 is fitted into the hole 4314A (see FIG. 5) of the drum cartridge 7A, whereby the toner first shutter 55A is fixed to the drum cartridge 7A.

<3.6 Toner Second Shutter 55B>

As illustrated in FIG. 8, the toner second shutter 55B is positioned at the one end portion in the first direction of the first toner storage part 511. The toner second shutter 55B is positioned on the peripheral surface of the first toner storage part 511. The toner second shutter 55B is configured to open and close the returned toner receiving port 511B (see FIG. 9). More specifically, like the toner first shutter 55A, the toner second shutter 55B is movable between a closing position and an opening position along the peripheral surface of the first toner storage part 511. In a state where the toner second shutter 55B is at the closing position, the toner second shutter 55B closes the returned toner receiving port 511B. In a state where the toner second shutter 55B is at the opening position, the toner second shutter 55B opens the returned toner receiving port 511B, i.e., the returned toner receiving port 511B is open. The toner second shutter 55B includes a projection 552.

The projection 552 is positioned on the peripheral surface of the toner second shutter 55B. The projection 552 extends from the peripheral surface of the toner second shutter 55B. The projection 552 may be assembled to the peripheral surface of the toner second shutter 55B. During attachment of the toner container 8A to the drum cartridge 7A, the projection 552 is fitted into the hole 4314B (see FIG. 5) of the drum cartridge 7A, whereby the toner second shutter 55B is fixed to the drum cartridge 7A.

<3.7 Toner Third Shutter 55C>

The toner third shutter 55C is positioned at the other end portion in the first direction of the first toner storage part 511. The toner third shutter 55C is positioned on the peripheral surface of the first toner storage part 511. The toner third shutter 55C is configured to open and close the second returned toner receiving port 511C (see FIG. 9). More specifically, like the toner first shutter 55A, the toner third shutter 55C is movable between a closing position and an opening position along the peripheral surface of the first toner storage part 511. In a state where the toner third shutter 55C is at the closing position, the toner third shutter 55C closes the second returned toner receiving port 511C. In a state where the toner third shutter 55C is at the opening position, the toner third shutter 55C opens the second returned toner receiving port 511C, i.e., the second returned toner receiving port 511C is open. The toner third shutter 55C includes a projection 553.

The projection 553 is positioned on the peripheral surface of the toner third shutter 55C. The projection 553 extends from the peripheral surface of the toner third shutter 55C. The projection 553 may be assembled to the peripheral surface of the toner third shutter 55C. During attachment of the toner container 8A to the drum cartridge 7A, the projection 553 is fitted into the hole 4314C (see FIG. 5) of the drum cartridge 7A, whereby the toner third shutter 55C is fixed to the drum cartridge 7A.

<3.8 Projections 56A, 56B>

The projection 56A is positioned on an outer surface S1 of the first toner storage part 511. The outer surface S1 is an outer surface positioned on one side in the first direction of the first toner storage part 511. The projection 56A protrudes from the outer surface S1. The projection 56A may be assembled to the outer surface S1. During attachment of the toner container 8A to the drum cartridge 7A, the projection 56A is fitted into the guide 4315A (see FIG. 5) of the drum cartridge 7A.

The projection 56B is positioned on an outer surface S2 of the first toner storage part 511. The outer surface S2 is an outer surface positioned on the other side in the first direction of the first toner storage part 511. The projection 56B protrudes from the outer surface S2. The projection 56B may be assembled to the outer surface S2. During attachment of the toner container 8A to the drum cartridge 7A, the projection 56B is fitted into the guide 4315B (see FIG. 5) of the drum cartridge 7A.

<3.9 Projections 57A, 57B>

The projection 57A is positioned on the peripheral surface of the first toner storage part 511. The projection 57A is positioned between the toner first shutter 55A and the toner second shutter 55B in the first direction. The projection 57A is positioned between the toner discharge port 511A and the returned toner receiving port 511B in the first direction. The projection 57A extends from the peripheral surface of the first toner storage part 511. The projection 57A may be assembled to the peripheral surface of the first toner storage part 511.

The projection 57B is positioned on the peripheral surface of the first toner storage part 511. The projection 57B is positioned between the toner first shutter 55A and the toner third shutter 55C in the first direction. The projection 57B is positioned between the toner discharge port 511A and the second returned toner receiving port 511C in the first direction. The projection 57B extends from the peripheral surface of the first toner storage part 511. The projection 57B may be assembled to the peripheral surface of the first toner storage part 511.

### 4. Attachment of Toner Container 8A to Drum Cartridge 7A

Next, attachment of the toner container 8A to the drum cartridge 7A will described while referring to FIGS. 3, 5, 7, 8, 11, and 12.

In a state where the toner container 8A is detached from the drum cartridge 7A, the developing shutter 434 is positioned at its closing position (see FIG. 3), the toner first shutter 55A is positioned at its closing position (see FIG. 7), the toner second shutter 55B is positioned at its closing position, and the toner third shutter 55C is positioned at its closing position.

When attaching the toner container 8A to the drum cartridge 7A, a user positions the first toner storage part 511 to the developing housing 431 as illustrated in FIG. 11.

More specifically, the user fits the projection 56A (see FIG. 8) and projection 56B (see FIG. 8) of the toner container 8A into the guide 4315A (see FIG. 5) and guide 4315B (see FIG. 5) of the cartridge 4A, respectively. Then, the user mounts the toner container 8A onto the drum cartridge 7A along the guides 4315A and 4315B such that the first toner storage part 511 is mounted first.

As a result, the projection 551 of the toner first shutter 55A is fitted into the hole 4314A of the developing housing 431, the projection 552 (see FIG. 8) of the toner second shutter 55B is fitted into the hole 4314B (see FIG. 5) of the developing housing 431, and the projection 553 (see FIG. 8) of the toner third shutter 55C is fitted into the hole 4314C (see FIG. 5) of the developing housing 431.

Hence, the toner first shutter 55A, toner second shutter 55B, and toner third shutter 55C are fixed to the developing housing 431, whereby the first toner storage part 511 is positioned to the developing housing 431. Further, the developing shutter 434 is fitted between the projections 57A, 57B (see FIG. 9) of the toner container 8A and the second toner storage part 512. The second toner storage part 512 is positioned separated from the bottom plate 4314 of the developing housing 431.

Then, as illustrated in FIGS. 11 and 12, the user pivotally moves the toner housing 51 about the first toner storage part 511. Specifically, the user pivotally moves the toner housing 51 in such a direction that the second toner storage part 512 approaches the bottom plate 4314.

As a result, the developing shutter 434 is pushed by the projections 57A and 57B (see FIG. 8) of the toner container 8A to move from the closing position to the opening position. Further, since the toner housing 51 is pivotally moved in such a direction that the second toner storage part 512 approaches the bottom plate 4314 in a state where the toner first shutter 55A, toner second shutter 55B, and toner third shutter 55C are fixed to the developing housing 431, the toner first shutter 55A moves from its closing position to its opening position relative to the toner housing 51, the toner second shutter 55B moves from its closing position to its opening position relative to the toner housing 51, and the toner third shutter 55C moves from its closing position to its opening position relative to the toner housing 51.

Then, as illustrated in FIG. 12, attachment of the toner container 8A to the drum cartridge 7A is completed in a state where the developing shutter 434 is at its opening position, the toner first shutter 55A is at its opening position, the toner second shutter 55B is at its opening position, and the toner third shutter 55C is at its opening position.

Note that, when the user pivotally moves the toner housing 51 in such a direction that the second toner storage part 512 is separated from the bottom plate 4314 from a state where the toner container 8A is attached to the drum cartridge 7A, the developing shutter 434 is pushed by the second toner storage part 512 to move from its opening position to its closing position. Further, since the toner housing 51 is pivotally moved in such a direction that the second toner storage part 512 is separated from the bottom plate 4314 in a state where the toner first shutter 55A, toner second shutter 55B, and toner third shutter 55C are fixed to the developing housing 431, the toner first shutter 55A moves from its opening position to its closing position relative to the toner housing 51, the toner second shutter 55B moves from its opening position to its closing position relative to the toner housing 51, and the toner third shutter 55C moves from its opening position to its closing position relative to the toner housing 51.

### 5. Detection of Toner Residual Amount

Next, detection of amount of remaining toner will be described while referring to FIG. 9.

As illustrated in FIG. 9, the image forming apparatus 1 further includes detection members 9A, 9B and a controller 10.

The detection members 9A and 9B are positioned inside the main body housing 2. In a state where the cartridge 4A is attached to the image forming apparatus 1, the detection member 9A faces the light transmissive member 512A of the toner container 8A while the detection member 9B faces the light transmissive member 512B of the toner container 8A. The detection member 9A is a light emitting element, and detection member 9B is a light receiving element.

In a state where the cartridge 4A is attached to the image forming apparatus 1, the detection members 9A and 9B detect the amount of toner remaining in the toner container 8A. In more detail, the detection members 9A and 9B detect the amount of toner remaining in the second toner storage part 512. Specifically, when the amount of toner remaining in the toner container 8A decreases to a threshold value or less, the detection member 9B receives light from the detection member 9A.

For example, the threshold value set for the amount of toner remaining in the toner container 8A is half the amount of toner in the developing device 43 and, preferably, the same amount as the amount of toner in the developing device 43. The light-transmissive members 512A and 512B of the toner container 8A are disposed at such positions that light from the detection member 9A passes therethrough when the amount of toner remaining in the toner container 8A becomes equal to or less than the above threshold value in a state where the cartridge 4A having the toner container 8A attached thereto is attached to the image forming apparatus 1.

In a state where the cartridge 4A is attached to the image forming apparatus 1, the detection members 9A and 9B detect reduction in the amount of toner remaining in the second toner storage part 512 by the detection member 9B receiving light from the detection member 9A. When the detection member 9B receives light from the detection member 9A, the detection member 9B outputs a signal.

Note that, when the amount of toner remaining in the toner container 8A is large, light from the detection member 9A is interrupted by the toner in the toner container 8A and does not reach the detection member 9B. In this case, the detection member 9B does not receive light and thus outputs no signal.

The controller 10 can receive the signal from the detection member 9B. Upon receipt of the signal from the detection member 9B, the controller 10 executes a process for replacement of the toner container 8A. That is, when the detection members 9A and 9B detect that the amount of toner remaining in the toner container 8A has become equal to or less than the threshold value, the controller 10 executes a process for replacement of the toner container 8A.

The process for replacement of the toner container 8A includes, for example, a process of stopping a printing process and a process of displaying a toner empty message.

### 6. Functions and Effects

(1) According to the cartridge 4A, the collected toner from the photosensitive drum 41 can be returned to the developing housing 431 through the collected toner receiving port 431D (see FIG. 4) as illustrated in FIG. 5. Further, the toner that has been returned to the developing housing 431 can be returned to the toner container 8A through the toner return port 431B and returned toner receiving port 511B as illustrated in FIGS. 6 and 9.

With the above configuration, the collected toner can be supplied once again to the photosensitive drum 41 after mixed with unused toner in the developing housing 431 or in the toner container 8.

This eliminates the need to provide in the cartridge 4A a space for storing the collected toner to thereby correspondingly increase the capacity of the toner container 8A.

As a result, the capacity of the toner container 8A can be increased while suppressing increase in size of the cartridge 4A.

(2) According to the cartridge 4A, the developing device 43 includes the developing second conveying member 433B as illustrated in FIG. 6. The developing second conveying member 433B conveys toner from the collected toner receiving port 431D to the toner return port 431B.

With this configuration, the collected toner introduced into the developing housing 431 through the collected toner receiving port 431D can be returned smoothly to the toner container 8A by the developing second conveying member 433B.

(3) According to the cartridge 4A, in a state where the cartridge 4A is attached to the image forming apparatus 1, the collected toner receiving port 431D is positioned further upward than the toner return port 431B as illustrated in FIGS. 4 and 6.

Thus, the collected toner can be conveyed from the collected toner receiving port 431D to the toner return port 431B by using gravity.

As a result, the collected toner introduced into the developing housing 431 through the collected toner receiving port 431D can be returned smoothly to the toner container 8A by using gravity.

(4) As illustrated in FIG. 9, in a state where the cartridge 4A is attached to the image forming apparatus 1, the detection members 9A and 9B detect the amount of toner remaining in the toner container 8A. When the detection members 9A and 9B detect that the amount of toner remaining in the toner container 8A becomes equal to or less than the threshold value, the controller 10 executes the process for replacement of the toner container 8A.

Toner tends to be deteriorated through repetition of image forming operation. Hence, the collected toner may contain a certain amount of the deteriorated toner.

In a configuration where the collected toner is returned to the developing device 43, when the toner container 8A is replaced after the toner therein is consumed, the deteriorated toner may be left in the developing device 43.

Thus, in a configuration where toner is not circulated between the developing device 43 and the toner container 8A, the deteriorated toner may be accumulated in the developing device 43 due to repetition of replacement of the toner container 8A, and accordingly, the image quality may be gradually degraded.

However, in this image forming apparatus 1, the cartridge 4A in which toner can be circulated between the developing device 43 and the toner container 8A can be attached to the image forming apparatus 1. Further, the toner container 8A can be replaced with the toner therein left by an amount corresponding to a certain threshold value or less.

Thus, a certain amount of the deteriorated toner can be discarded together with the toner container 8A.

Accordingly, accumulation of the deteriorated toner in the developing device 43 can be suppressed even if replacement of the toner container 8A is repeated.

(5) The threshold value may be half the toner amount in the developing device 43. In a case where the threshold value is set to half the toner amount in the developing device, when the toner container 8A is replaced, one third (⅓) of the deteriorated toner can be discarded together with the toner container 8A. In this case, two third (⅔) of the deteriorated toner is left in the developing device 43.

Even in this case, accumulation of the deteriorated toner in the developing device 43 can be suppressed even if replacement of the toner container 8A is repeated.

(6) The threshold value may be the same amount as the toner amount in the developing device 43. In a case where the threshold value is set to the same amount as the toner amount in the developing device 43, when the toner container 8A is replace, the remaining toner is evenly divided between the developing device 43 and the toner container 8A.

Thus, half of the deteriorated toner can be discarded together with the toner container 8A.

As a result, even if replacement of the toner container 8A is repeated infinitely, the deteriorated toner can be suppressed from being accumulated in the developing device 43.

(7) As illustrated in FIG. 9, the detection members 9A and 9B detect the amount of toner remaining in the second toner storage part 512.

Hence, the user can be prompted to replace the toner container 8A in a state where toner is left in the first toner storage part 511.

In a case where it is desired to replace the toner container 8A while leaving the toner therein by an amount corresponding to a certain threshold value or less, it is difficult to make constant the amount of toner remaining in the toner container 8A at the time of replacement thereof.

However, by appropriately designing the capacity of the first toner storage part 511, the amount of toner remaining in the toner container 8A at the time of replacement thereof can be made constant.

As a result, the controller 10 can prompt the user to replace the toner container 8A at an appropriate timing.

### 7. Second Embodiment

Next, a second embodiment will be described while referring to FIGS. 13 to 15. In the second embodiment, the same reference numerals are given to the same components as in the first embodiment and descriptions thereof will be omitted.

A cartridge 4B according to the second embodiment includes a drum cartridge 7B and a toner container 8B. The description of the toner container 8B is the same as that of the toner container 8A, so the description thereof will be omitted.

<7.1 Drum Cartridge 7B according to Second Embodiment>

As illustrated in FIG. 13, in the drum cartridge 7B according to the second embodiment, the collected toner receiving port 431D is positioned at the center portion in the first direction of the developing housing 431. More specifically, the collected toner receiving port 431D is positioned at the center portion in the first direction of the main body part 4312. As illustrated in FIG. 14, the collected toner receiving port 431D is provided in the upper wall of the main body part 4312 of the developing housing 431. The drum cartridge 7B does not include the protruding part 4313 (see FIG. 6).

As illustrated in FIG. 15, in the drum cartridge 7B, as in the drum cartridge 7A according to the first embodiment, the toner receiving port 431A is positioned at the center portion in the first direction of the developing housing 431. Further, the toner return port 431B is positioned at the one end portion in the first direction of the developing housing 431. Further, the second toner return port 431C is positioned at the other end potion in the first direction of the developing housing 431.

<7.2 Functions and Effects of Second Embodiment>

(1) According to the cartridge 4B of the second embodiment, the collected toner receiving port 431D is positioned at the center portion in the first direction of the developing housing 431 as illustrated in FIGS. 13 and 15. The toner return port 431B is positioned at the one end portion in the first direction of the developing housing 431, and the second toner return port 431C is positioned at the other end portion in the first direction of the developing housing 431.

With this configuration, the collected toner can be mixed with toner introduced through the toner receiving port 431A and can then be conveyed evenly from the center portion in the first direction of the developing housing 431 toward both ends thereof.

This can suppress a difference in the mixing ratio between the collected toner on one side of the center of the developing housing 431 and the collected toner on the other side of the center of the developing housing 431 to thereby suppress the occurrence of unevenness in a printed image.

(2) In the cartridge 4B according to the second embodiment as well, the same functions and effects as those of the cartridge 4A according to the first embodiment can be obtained.

### 8. Third Embodiment

Next, a third embodiment will be described while referring to FIGS. 16 and 17. In the third embodiment, the same reference numerals are given to the same components as in the first embodiment and descriptions thereof will be omitted.

A cartridge 4C according to the third embodiment includes a drum cartridge 7C and a toner container 8C. The description of the toner container 8C is the same as that of the toner container 8A, so the description thereof will be omitted.

<8.1 Drum Cartridge 7C According to Third Embodiment>

As illustrated in FIGS. 16 and 17, in the drum cartridge 7C according to the third embodiment, the collected toner receiving port 431D and the toner return port 431B are positioned at the one end portion in the first direction of the developing housing 431. More specifically, the collected toner receiving port 431D and the toner return port 431B are positioned at the protruding part 4313 of the developing housing 431. That is, the collected toner receiving port 431D and the toner return port 431B are positioned outside the developing chamber 430 in the first direction. In other words, the collected toner receiving port 431D and the toner return port 431B are positioned outside a developable area in the first direction. The developable area refers to an area where the developing roller 432 can supply toner to the photosensitive drum 41. In the present embodiment, the developable area is defined between one end portion and the other end portion of the developing chamber 430 in the first direction. Preferably, at least a part of the collected toner receiving port 431D overlaps the toner return port 431B as viewed in a direction that is orthogonal to the first direction and is directed from the collected toner receiving port 431D to the toner return port 431B. More preferably, the entire collected toner receiving port 431D overlaps the toner return port 431B as viewed in the direction that is orthogonal to the first direction and is directed from the collected toner receiving port 431D to the toner return port 431B.

<8.2 Functions and Effects of Third Embodiment>

(1) According to the cartridge 4C of the third embodiment, the collected toner receiving port 431D and toner return port 431B are positioned at the one end portion in the first direction of the developing housing 431 as illustrated in FIG. 16.

With this configuration, as illustrated in FIG. 17, the collected toner introduced into the one end portion in the first direction of the developing housing 431 through the collected toner receiving port 431D can be returned through the toner return port 431B to the toner container 8C without being conveyed to the other end portion in the first direction of the developing housing 431.

Thus, after the collected toner and unused toner are mixed in the toner container 8C, they can further be mixed in the developing housing 431, and the resultant toner can be supplied to the photosensitive drum 41.

As a result, the collected toner and unused toner can be evenly mixed and supplied to the photosensitive drum 41.

(2) According to the cartridge 4C of the third embodiment, as illustrated in FIG. 17, the collected toner receiving port 431D and the toner return port 431B are positioned outside the developable area in the first direction.

Accordingly, in an area outside the developable area, the collected toner can be returned to the toner container 8C.

As a result, the collected toner introduced into the developing housing 431 can be suppressed from being supplied to the photosensitive drum 41 before being returned to the toner container 8C.

(3) According to the cartridge 4C of the third embodiment, as illustrated in FIG. 16, at least a part of the collected toner receiving port 431D overlaps the toner return port 431B as viewed in the direction that is orthogonal to the first direction and is directed from the collected toner receiving port 431D to the toner return port 431B.

Thus, the collected toner introduced into the developing housing 431 through the collected toner receiving port 431D can be returned through the toner return port 431B to the toner container 8C without substantially being conveyed in the first direction.

As a result, the collected toner can be returned smoothly to the toner container 8C.

(4) In the cartridge 4C according to the third embodiment as well, the same functions and effects as those of the cartridge 4A according to the first embodiment can be obtained.

<8.3 Modification of Third Embodiment>

The toner receiving port 431A may be positioned at the other end portion in the first direction of the developing housing 431. In this case, the developing housing 431 does not include the second toner return port 431C.

### 9. Fourth Embodiment

Next, a fourth embodiment will be described while referring to FIGS. 18 and 19. In the fourth embodiment, the same reference numerals are given to the same components as in the first embodiment and descriptions thereof will be omitted.

A cartridge 4D according to the fourth embodiment includes a drum cartridge 7D and a toner container 8D.

<9.1 Drum Cartridge 7D according to Fourth Embodiment>

As illustrated in FIG. 18, in the drum cartridge 7D according to the fourth embodiment, the toner receiving port 431A is positioned at the one end portion in the first direction of the developing housing 431. More specifically, the toner receiving port 431A is positioned at the one end portion in the first direction of the main body part 4312. The toner return port 431B is positioned at the other end portion in the first direction of the developing housing 431. More specifically, the toner return port 431B is positioned at the other end portion in the first direction of the main body part 4312. The drum cartridge 7D does not include the second toner return port 431C. The collected toner receiving port 431D is positioned at the one end portion in the first direction of the developing housing 431 as in the drum cartridge 7A (see FIG. 4) according to the first embodiment. More specifically, the collected toner receiving port 431D is positioned at the protruding part 4313. The developing conveying member 433 is configured to convey toner, toward the other side in the first direction, from the collected toner receiving port 431D to the toner return port 431B through the toner receiving port 431A.

<9.2 Toner Container 8D according to Fourth Embodiment>

As illustrated in FIG. 19, in the toner container 8D according to the fourth embodiment, the toner discharge port 511A is positioned at one end portion in the first direction of the toner housing 51. The returned toner receiving port 511B is positioned at the other end portion in the first direction of the toner housing 51. The toner container 8D does not include the second returned toner receiving port 511C. The toner conveying member 52 is configured to convey toner, toward one side in the first direction, from the returned toner receiving port 511B to the toner discharge port 511A.

<9.3 Functions and Effects of Fourth Embodiment>

(1) According to the cartridge 4D of the fourth embodiment, as illustrated in FIG. 18, the protruding part 4313 having the collected toner receiving port 431D is positioned at the one end portion in the first direction of the developing housing 431, and the toner return port 431B is positioned at the other end portion in the first direction of the developing housing 431.

With this configuration, the collected toner introduced into the developing housing 431 through the collected toner receiving port 431D is conveyed from the one end portion of the developing housing 431 to the other end portion of the developing housing 431 at which the toner return port 431B is positioned and is then returned to the toner container 8A.

Accordingly, influence of the collected toner occurs evenly in the entire width of an image forming area.

As a result, the occurrence of unevenness in a printed image in the first direction can be suppressed.

(2) In the cartridge 4D according to the fourth embodiment as well, the same functions and effects as those of the cartridge 4A according to the first embodiment can be obtained.

<9.4 Modification of Fourth Embodiment>

(1) The toner receiving port 431A may be positioned at the other end portion in the first direction of the developing housing 431, the toner return port 431B may be positioned at the one end portion in the first direction of the developing housing 431, and the collected toner receiving port 431D may be positioned at the protruding part 4313.

In this case, the developing conveying member 433 includes the developing first conveying member 433A configured to convey toner from the toner receiving port 431A to the toner return port 431B and the developing second conveying member 433B configured to convey toner from the collected toner receiving port 431D to the toner return port 431B.

(2) The collected toner receiving port 431D and toner receiving port 431A may be positioned at the protruding part 4313, and the toner return port 431B may be positioned at the other end portion in the first direction of the main body part 4312.

(3) The collected toner receiving port 431D and toner return port 431B may be positioned at the protruding part 4313, and the toner receiving port 431A may be positioned at the other end portion in the first direction of the main body part 4312.

### 10. Fifth Embodiment

Next, a fifth embodiment will be described while referring to FIGS. 20 to 23. In the fifth embodiment, the same reference numerals are given to the same components as in the first embodiment and descriptions thereof will be omitted.

A cartridge 4E according to the fifth embodiment includes a drum cartridge 7E and a toner container 8E.

<10.1 Drum Cartridge 7E according to Fifth Embodiment>

As illustrated in FIG. 20, in the drum cartridge 7E according to the fifth embodiment, the developing housing 431 does not include the toner receiving port 431A, toner return port 431B, and second toner return port 431C but includes the collected toner receiving port 431D and a developing passage port 100.

Further, in the drum cartridge 7E, the collected toner receiving port 431D is positioned at the center portion in the first direction of the developing housing 431. The drum cartridge 7E does not include the protruding part 4313 (see FIG. 6).

Further, as illustrated in FIG. 21, in the drum cartridge 7E, the toner pipe 46 includes a cylinder 460 having the collected toner discharge port 461. The cylinder 460 is inserted into the collected toner receiving port 431D. The seal member 47 is positioned between the outer peripheral surface of the cylinder 460 and the inner peripheral surface of the collected toner receiving port 431D.

Further, as illustrated in FIGS. 21 and 22, in the drum cartridge 7E, the developing housing 431 includes a partition wall 101. In other words, the developing device 43 includes the partition wall 101.

Further, in the drum cartridge 7E, the developing device 43 does not include the developing conveying member 433 but includes a first conveying member 102 and a second conveying member 103.

Further, as illustrated in FIGS. 20 and 21, in the drum cartridge 7E, the developing device 43 does not include the developing shutter 434 but includes a first shutter 104.

<10.1.1 Developing Passage port 100>

As illustrated in FIG. 20, the developing passage port 100 is positioned at the center portion in the first direction of the developing housing 431. More specifically, the developing passage port 100 is positioned at the center portion in the first direction of the main body part 4312. The developing passage port 100 can receive toner discharged from a toner passage port 105 (see FIG. 23) and returns toner to the toner passage port 105. The toner passage port 105 will be described later. The developing passage port 100 is communicated with the developing chamber 430.

<10.1.2 Collected Toner Receiving Port 431D>

The collected toner receiving port 431D is positioned at the center portion in the first direction of the developing housing 431. The collected toner receiving port 431D is positioned at the center portion in the first direction of the main body part 4312. At least a part of the collected toner receiving port 431D overlaps the developing passage port 100 as viewed in a direction that is orthogonal to the first direction and is directed from the collected toner receiving port 431D to the developing passage port 100. As illustrated in FIG. 21, the collected toner receiving port 431D is provided in the upper wall of the main body part 4312 of the developing housing 431. In a state where the cartridge 4E is attached to the image forming apparatus 1 (specifically, to the main body housing 2), the collected toner receiving port 431D is positioned further upward than the developing passage port 100. Hence, the collected toner from the collected toner receiving port 431D can be returned to the toner container 8E through the developing passage port 100 by using gravity.

<10.1.3 Partition Wall 101>

As illustrated in FIGS. 21 and 22, the partition wall 101 is positioned inside the developing housing 431. The partition wall 101 is positioned between the first conveying member 102 and the second conveying member 103 in a second direction. The second direction is a direction orthogonal to the first direction. In a state where the cartridge 4E is attached to the image forming apparatus 1, the second direction is the up-down direction, i.e., the vertical direction. The partition wall 101 is positioned between one end and the other end of the developing passage port 100 in the second direction. The partition wall 101 partitions the inner space of the developing housing 431 into a first developing chamber 430A and a second developing chamber 430B.

The first developing chamber 430A houses a part of the developing roller 432. The first developing chamber 430A is positioned separated from the collected toner receiving port 431D in the second direction. The first developing chamber 430A is communicated with the one end in the second direction of the developing passage port 100.

The second developing chamber 430B is positioned between the first developing chamber 430A and the collected toner receiving port 431D in the second direction. The second developing chamber 430B is communicated with the collected toner receiving port 431D. Further, the second developing chamber 430B is communicated with the other end in the second direction of the developing passage port 100.

As illustrated in FIG. 22, the partition wall 101 includes two openings 101A and 101B.

The opening 101A is positioned at one end portion in the first direction of the partition wall 101. The opening 101A allows toner to pass therethrough from the first developing chamber 430A to the second developing chamber 430B.

The opening 101B is positioned at the other end portion in the first direction of the partition wall 101. The opening 101B allows toner to pass therethrough from the first developing chamber 430A to the second developing chamber 430B.

<10.1.4 First Conveying Member 102>

As illustrated in FIG. 21, the first conveying member 102 is positioned inside the first developing chamber 430A. As illustrated in FIG. 22, the first conveying member 102 is configured to convey toner in the developing device 43 in a direction away from the developing passage port 100 in the first direction. More specifically, the first conveying member 102 is configured to convey toner in the first developing chamber 430A in a direction away from the developing passage port 100 in the first direction. In still more detail, the first conveying member 102 is configured to convey toner in the first developing chamber 430A from the developing passage port 100 to the opening 101A and to convey toner in the first developing chamber 430A from the developing passage port 100 to the opening 101B. The first conveying member 102 is an auger screw. The first conveying member 102 may be a shaftless screw.

<10.1.5 Second Conveying Member 103>

As illustrated in FIG. 21, the second conveying member 103 is positioned inside the second developing chamber 430B. The first conveying member 102 and second conveying member 103 are aligned in the second direction. As illustrated in FIG. 22, the second conveying member 103 is configured to convey toner in the developing device 43 in a direction approaching the developing passage port 100 in the first direction. More specifically, the second conveying member 103 is configured to convey toner in the second developing chamber 430B in a direction approaching the developing passage port 100 in the first direction. In still more detail, the second conveying member 103 is configured to convey toner in the second developing chamber 430B from the opening 101A to the developing passage port 100 and to convey toner in the second developing chamber 430A from the opening 101B to the developing passage port 100. The second conveying member 103 is an auger screw. The second conveying member 103 may be a shaftless screw.

<10.1.6 First Shutter 104>

As illustrated in FIG. 21, the first shutter 104 is configured to open and close the developing passage port 100. The first shutter 104 is movable between a closing position and an opening position. In a state where the first shutter 104 is at the closing position, the first shutter 104 closes the developing passage port 100. In a state where the first shutter 104 is at the opening position, the first shutter 104 opens the developing passage port 100, i.e., the developing passage port 100 is open.

Like the developing shutter 434 according to the first embodiment, when the user pivotally moves the toner housing 51 in such a direction that the second toner storage part 512 approaches the bottom plate 4314 during attachment of the toner container 8E to the cartridge 4E, the first shutter 104 is pushed by the projections 57A and 57B (see FIG. 23) of the toner container 8E to move from the closing position to the opening position.

When the user pivotally moves the toner housing 51 in such a direction that the second toner storage part 512 separates from the bottom plate 4314 from a state where the toner container 8E is attached to the cartridge 4E, the first shutter 104 is pushed by the second toner storage part 512 to move from the opening position to the closing position.

<10.2 Toner Container 8E according to Fifth Embodiment>

As illustrated in FIG. 23, the toner housing 51 of the toner container 8E has a toner passage port 105. The toner container 8E includes a third conveying member 106 and a second shutter 107.

<10.2.1 Toner Passage port 105>

The toner passage port 105 is positioned at the center portion in the first direction of the first toner storage part 511. The toner passage port 105 is a port through which toner in the toner container 8E can be discharged and through which toner returned from the developing passage port 100 can be introduced.

<10.2.2 Third Conveying Member 106>

The third conveying member 106 is positioned inside the first toner storage part 511 of the toner container 8E. The third conveying member 106 is configured to convey toner in the toner container 8E toward the toner passage port 105. The third conveying member 106 includes a shaft 106A and a plurality of vanes 106B. The shaft 106A extends in the first direction. The plurality of vanes 106B are arranged in the first direction. Each of the vanes 106B is assembled to the shaft 106A. Each of the vanes 106B is rotatable together with the shaft 106A.

<10.2.3 Second Shutter 107>

The second shutter 107 is configured to open and close the toner passage port 105. The second shutter 107 is movable between a closing position and an opening position. In a state where the second shutter 107 is at the closing position, the second shutter 107 closes the toner passage port 105. In a state where the second shutter 107 is at the opening position, the second shutter 107 opens the toner passage port 105, i.e., the toner passage port 105 is open.

Like the toner first shutter 55A according to the first embodiment, when the user pivotally moves the toner housing 51 in such a direction that the second toner storage part 512 approaches the bottom plate 4314 during attachment of the toner container 8E to the cartridge 4E, the second shutter 107 moves from the closing position to the opening position.

When the user pivotally moves the toner housing 51 in such a direction that the second toner storage part 512 separates from the bottom plate 4314 from a state where the toner container 8E is attached to the cartridge 4E, the second shutter 107 moves from the opening position to the closing position.

<10.3 Functions and Effects of Fifth Embodiment>

(1) According to the cartridge 4E of the fifth embodiment, as illustrated in FIG. 21, in a state where the cartridge 4E is attached to the image forming apparatus 1, the collected toner receiving port 431D is positioned further upward than the developing passage port 100.

Accordingly, the collected toner can be conveyed from the collected toner receiving port 431D to the developing passage port 100 by using gravity.

As a result, the collected toner can be returned smoothly to the toner container 8E.

(2) According to the cartridge 4E of the fifth embodiment, as illustrated in FIG. 22, at least a part of the collected toner receiving port 431D overlaps the developing passage port 100 as viewed in the direction that is orthogonal to the first direction and is directed from the collected toner receiving port 431D to the developing passage port 100.

Thus, the collected toner introduced into the developing housing 431 through the collected toner receiving port 431D can be returned to the toner container 8E through the developing passage port 100 without substantially being conveyed in the first direction.

As a result, the collected toner can be returned smoothly to the toner container 8E.

(3) According to the cartridge 4E of the fifth embodiment, as illustrated in FIG. 21, the developing device 43 includes the partition wall 101. The partition wall 101 partitions the inner space of the developing housing 431 into the first developing chamber 430A and the second developing chamber 430B. The first developing chamber 430A houses a part of the developing roller 432. The second developing chamber 430B is communicated with the collected toner receiving port 431D.

Thus, the partition wall 101 can suppress the collected toner introduced into the developing housing 431 from being supplied to the photosensitive drum 41 before being mixed with unused toner.

(4) In the cartridge 4E according to the fifth embodiment as well, the same functions and effects as those of the cartridge 4A according to the first embodiment can be obtained.

### 11. Sixth Embodiment

Next, a sixth embodiment will be described while referring to FIGS. 24 to 26. In the sixth embodiment, the same reference numerals are given to the same components as in the first embodiment and descriptions thereof will be omitted.

A cartridge 4F according to the sixth embodiment includes a drum cartridge 7F and a toner container 8F.

<11.1 Drum Cartridge 7F according to Sixth Embodiment>

As illustrated in FIGS. 24 and 25, in the drum cartridge 7F, the developing housing 431 includes a partition wall 201. In other words, the developing device 43 includes the partition wall 201.

Further, in the drum cartridge 7F, the developing device 43 does not include the developing conveying member 433 but includes a first conveying member 202 and a second conveying member 203.

<11.1.1 Partition Wall 201>

As illustrated in FIG. 24, the partition wall 201 is positioned inside the developing housing 431. The partition wall 201 is positioned between the first conveying member 202 and the second conveying member 203. In a state where the cartridge 4F is attached to the image forming apparatus 1 (specifically, to the main body housing 2), the partition wall 201 is positioned between the first conveying member 202 and the second conveying member 203 in the horizontal direction. The partition wall 201 partitions the inner space of the developing housing 431 into the first developing chamber 430A and the second developing chamber 430B.

The first developing chamber 430A houses a part of the developing roller 432. The first developing chamber 430A is positioned separated from the toner receiving port 431A. In a state where the cartridge 4F is attached to the image forming apparatus 1, the first developing chamber 430A is positioned separated from the toner receiving port 431A in the horizontal direction.

The second developing chamber 430B is positioned between the first developing chamber 430A and the toner receiving port 431A. In a state where the cartridge 4F is attached to the image forming apparatus 1, the second developing chamber 430B is positioned between the first developing chamber 430A and the toner receiving port 431A in the horizontal direction. As illustrated in FIG. 25, the second developing chamber 430B is communicated with the toner receiving port 431A, toner return port 431B, and second toner return port 431C. The second developing chamber 430B is also communicated with the inner space of the protruding part 4313. As in the drum cartridge 7A according to the first embodiment, the protruding part 4313 has the collected toner receiving port 431D. Accordingly, the second developing chamber 430B is communicated with the collected toner receiving port 431D through the inner space of the protruding part 4313.

The partition wall 201 has three openings 201A, 201B, and 201C.

The opening 201A is positioned at the center portion in the first direction of the partition wall 201. The opening 201A allows toner to pass therethrough from the second developing chamber 430B to the first developing chamber 430A.

The opening 201B is positioned at one end portion in the first direction of the partition wall 201. The opening 201B allows toner to pass therethrough from the first developing chamber 430A to the second developing chamber 430B.

The opening 201C is positioned at the other end portion in the first direction of the partition wall 201. The opening 201C allows toner to pass therethrough from the first developing chamber 430A to the second developing chamber 430B.

<11.1.2 First Conveying Member 202>

As illustrated in FIG. 24, the first conveying member 202 is positioned inside the first developing chamber 430A. As illustrated in FIG. 25, the first conveying member 202 is configured to convey toner in the developing device 43 in a direction away from the toner receiving port 431A in the first direction. More specifically, the first conveying member 202 is configured to convey toner in the first developing chamber 430A from the opening 201A toward the opening 201B and to convey toner in the first developing chamber 430A from the opening 201A toward the opening 201C. The first conveying member 202 is an auger screw. The first conveying member 202 may be a shaftless screw.

<11.1.3 Second Conveying Member 203>

As illustrated in FIG. 24, the second conveying member 203 is positioned inside the second developing chamber 430B. As illustrated in FIG. 25, the second conveying member 203 is configured to convey toner in the developing device 43 in a direction approaching the toner return port 431B and second toner return port 431C in the first direction. More specifically, the second conveying member 203 is configured to convey toner in the second developing chamber 430B from the opening 201B toward the toner return port 431B and to convey toner in the second developing chamber 430B from the opening 201C toward the second toner return port 431C. The second conveying member 203 is an auger screw. The second conveying member 203 may be a shaftless screw.

<11.2 Toner Container 8F according to Sixth Embodiment>

As illustrated in FIG. 26, in the toner container 8F, the toner housing 51 includes a partition wall 204 in place of the partition wall 513 (see FIG. 9).

The toner container 8F includes a toner conveying member 205 in place of the toner conveying member 52 (see FIG. 9).

<11.2.1 Partition Wall 204>

The partition wall 204 is positioned between the first toner storage part 511 and the second toner storage part 512. The partition wall 204 separates the first toner storage part 511 and the second toner storage part 512 from each other. The partition wall 204 includes four passage ports 204A, 204B, 204C, and 204D.

The passage port 204A is positioned between the toner discharge port 511A and the returned toner receiving port 511B in the first direction. The passage port 204A allows toner to pass therethrough between the first toner storage part 511 and the second toner storage part 512.

The passage port 204B is positioned between the toner discharge port 511A and the second returned toner receiving port 511C in the first direction. The passage port 204B is positioned separated from the passage port 204A in the first direction. The passage port 204B allows toner to pass therethrough between the first toner storage part 511 and the second toner storage part 512.

The passage port 204C is positioned on the opposite side of the returned toner receiving port 511B from the toner discharge port 511A in the first direction. The passage port 204C is positioned separated from the passage port 204A in the first direction. The passage port 204C allows toner to pass therethrough between the first toner storage part 511 and the second toner storage part 512.

The passage port 204D is positioned on the opposite side of the second returned toner receiving port 511C from the toner discharge port 511A in the first direction. The passage port 204D is positioned separated from the passage port 204B in the first direction. The passage port 204D allows toner to pass therethrough between the first toner storage part 511 and the second toner storage part 512.

<11.2.2 Toner Conveying Member 205>

The toner conveying member 205 is positioned inside the first toner storage part 511. The toner conveying member 205 includes a toner first conveying member 205A, a toner second conveying member 205B, a toner third conveying member 205C, and a toner fourth conveying member 205D.

The toner first conveying member 205A is configured to convey toner in the first toner storage part 511 in the first direction. More specifically, the toner first conveying member 205A is configured to convey toner from the passage port 204A toward the toner discharge port 511A. The toner first conveying member 205A extends in the first direction. The toner first conveying member 205A extends from the passage port 204A to the toner discharge port 511A. In the present embodiment, the toner first conveying member 205A is an auger screw.

The toner second conveying member 205B is configured to convey toner in the first toner storage part 511 in the first direction. More specifically, the toner second conveying member 205B is configured to convey toner from the passage port 204B toward the toner discharge port 511A. The toner second conveying member 205B extends in the first direction. The toner second conveying member 205B extends from the passage port 204B to the toner discharge port 511A. In the present embodiment, the toner second conveying member 205B is an auger screw. The toner second conveying member 205B is rotatable together with the toner first conveying member 205A.

The toner third conveying member 205C is configured to convey toner in the first toner storage part 511 in the first direction. The toner third conveying member 205C is configured to convey toner from the returned toner receiving port 511B toward the passage port 204C. The toner third conveying member 205C extends in the first direction. The toner third conveying member 205C extends from the returned toner receiving port 511B to the passage port 204C. In the present embodiment, the toner third conveying member 205C is an auger screw. The toner third conveying member 205C is rotatable together with the toner first conveying member 205A.

The toner fourth conveying member 205D is configured to convey toner in the first toner storage part 511 in the first direction. The toner fourth conveying member 205D is configured to convey toner from the second returned toner receiving port 511C toward the passage port 204D. The toner fourth conveying member 205D extends in the first direction. The toner fourth conveying member 205D extends from the second returned toner receiving port 511C to the passage port 204D. In the present embodiment, the toner fourth conveying member 205D is an auger screw. The toner fourth conveying member 205D is rotatable together with the toner second conveying member 205B.

<11.3 Functions and Effects of Sixth Embodiment>

(1) According to the cartridge 4F of the sixth embodiment, as illustrated in FIG. 24, the developing device 43 includes the partition wall 201. The partition wall 201 partitions the inner space of the developing housing 431 into the first developing chamber 430A and the second developing chamber 430B. The first developing chamber 430A houses a part of the developing roller 432. As illustrated in FIG. 25, the second developing chamber 430B is communicated with the toner receiving port 431A and toner return port 431B. Further, the second developing chamber 430B is communicated with the collected toner receiving port 431D through the inner space of the protruding part 4313.

Thus, the partition wall 201 can suppress the collected toner introduced into the developing housing 431 from being supplied to the photosensitive drum 41 before being mixed with unused toner.

(2) In the cartridge 4F according to the sixth embodiment as well, the same functions and effects as those of the cartridge 4A according to the first embodiment can be obtained.

### 12. Seventh Embodiment

Next, a seventh embodiment will be described while referring to FIGS. 27 to 38.

<12.1. Outline of Image Forming Apparatus 71>

The outline of an image forming apparatus 71 according to the seventh embodiment will be described with reference to FIGS. 27 and 28.

As illustrated in FIG. 27, the image forming apparatus 71 includes a main body housing 72, a sheet accommodation portion 73, a cartridge 74, an exposing device 75, a fixing device 76, and a transfer roller 740.

<12.1.1 Main Body Housing 72>

The main body housing 72 houses therein the sheet accommodation portion 73, cartridge 74, exposing device 75, and fixing device 76, the transfer roller 740. The main body housing 72 has an opening 721 and includes a cover 722. The cover 722 is movable between a closing position (see FIG. 27) and an opening position (see FIG. 28). As illustrated in FIG. 27, in a state where the cover 722 is at the closing position, the cover 722 closes the opening 721. As illustrated in FIG. 28, in a state where the cover 722 is at the opening position, the cover 722 opens the opening 721, i.e., the opening 721 is open.

<12.1.2 Sheet Accommodation Portion 73>

As illustrated in FIG. 27, the sheet accommodation portion 73 can accommodate therein a sheet S. The sheet S in the sheet accommodation portion 73 is conveyed toward the transfer roller 740.

<12.1.3 Cartridge 74>

The cartridge 74 is attachable to and detachable from the image forming apparatus 71. Specifically, the cartridge 74 is attachable to and detachable from the main body housing 72 of the image forming apparatus 71. In a state where the cartridge 74 is attached to the image forming apparatus 71 (specifically, to the main body housing 72), the cartridge 74 is positioned inside the main body housing 72. As illustrated in FIG. 28, in a state where the cover 722 is at the opening position, the cartridge 74 is attachable to and detachable from the image forming apparatus 71 (specifically, the main body housing 72) through the opening 721.

As illustrated in FIG. 27, the cartridge 74 includes a drum cartridge 77 and a toner container 78.

<12.1.3.1 Drum Cartridge 77>

The drum cartridge 77 includes a photosensitive drum 741, a charging roller 742, a developing device 743. In other words, the cartridge 74 includes the photosensitive drum 741, the charging roller 742, and the developing device 743.

<12.1.3.1.1 Photosensitive Drum 741>

The photosensitive drum 741 is rotatable about a first axis A71. In a state where the cartridge 74 is attached to the image forming apparatus 71, the first axis A71 extends in a first direction. The photosensitive drum 741 extends in the first direction. The photosensitive drum 741 has a cylindrical shape.

<12.1.3.1.2 Charging Roller 742>

The charging roller 742 charges the peripheral surface of the photosensitive drum 741. The image forming apparatus 71 may have a scorotron charger in place of the charging roller 742.

<12.1.3.1.3 Developing Device 743>

The developing device 743 is configured to supply toner in the toner container 78 to the photosensitive drum 741. The developing device 743 includes a developing housing 731 and a developing roller 732. In other words, the drum cartridge 77 includes the developing housing 731 and the developing roller 732.

The developing housing 731 can store toner from the toner container 78.

The developing roller 732 is configured to supply toner in the developing housing 731 to the photosensitive drum 741. The developing roller 732 is supported by the developing housing 731. More specifically, the developing roller 732 is rotatably supported by the developing housing 731. The developing roller 732 is in contact with the photosensitive drum 741. The developing roller 732 may be configured to come into contact with and separate from the photosensitive drum 741. The developing roller 732 extends in the first direction. The developing roller 732 is rotatable about a developing axis A72. In a state where the cartridge 74 is attached to the image forming apparatus 71, the developing axis A72 extends in the first direction. In a state where the cartridge 74 is attached to the image forming apparatus 71, the developing axis A72 is positioned further downward than the first axis A71.

<12.1.3.2 Toner Container 78>

The toner container 78 can store toner therein. The toner container 78 is attachable to and detachable from the cartridge 74, i.e., the toner container 78 can be replaced with respect to the cartridge 74. That is, the toner container 78 can be replaced with a new toner container 78 in the cartridge 74, i.e., the user can replace the toner container 78 with a new toner container 78 in the cartridge 74. In other words, the toner container 78 is attachable to and detachable from the drum cartridge 77, i.e., the toner container 78 can be replaced with respect to the drum cartridge 77. In other words, the toner container 78 is attachable to and detachable from the image forming apparatus 71.

<12.1.4 Exposing Device 75>

In a state where the cartridge 74 is attached to the image forming apparatus 71, the exposing device 75 is configured to expose the peripheral surface of the photosensitive drum 741. More specifically, the exposing device 75 is configured to expose the peripheral surface of the photosensitive drum 741 charged by the charging roller 742. In a state where the cartridge 74 is attached to the image forming apparatus 71, light emitted from the exposing device 75 passes through a portion above the developing device 743 and below a drum cleaner 745, and then enters the peripheral surface of the photosensitive drum 741. The developing device 743 supplies toner to the exposed peripheral surface of the photosensitive drum 741. In the present embodiment, the exposing device 75 is a laser scan unit. The exposing device 75 may be an LED head.

<12.1.5 Transfer Roller 740>

The transfer roller 740 is configured to transfer toner on the photosensitive drum 741 to the sheet S. More specifically, the sheet S fed from the sheet accommodation portion 73 passes between the transfer roller 740 and the photosensitive drum 741. At this time, the transfer roller 740 transfers toner on the photosensitive drum 741 to the sheet S.

<12.1.6 Fixing Device 76>

The fixing device 76 is configured to fix toner to the sheet S. In the present embodiment, the fixing device 76 applies heat and pressure to the sheet S having toner transferred thereto to fix the toner to the sheet S. The sheet S that has passed through the fixing device 76 is discharged onto the upper surface of the main body housing 72.

<12.2. Details of Drum Cartridge 77 according to Seventh Embodiment>

In a state where the cartridge 74 is attached to the image forming apparatus 71, toner that has not been transferred from the photosensitive drum 741 to the sheet S and thus remains on the peripheral surface of the photosensitive drum 741 can be collected to the developing device 743. In the following description of this embodiment, the toner collected from the photosensitive drum 741 to the developing device 743 is defined as “collected toner”.

In a state where the cartridge 74 is attached to the image forming apparatus 71, the cartridge 74 can circulate toner between the developing device 743 and the toner container 78. In a state where the cartridge 74 is attached to the image forming apparatus 71, the cartridge 74 can mix the collected toner and unused toner with each other in the developing device 743 and toner container 78 and then supply the collected toner once again to the photosensitive drum 741. In this embodiment, the unused toner refers to toner that has never been supplied to the photosensitive drum 741.

Next, the drum cartridge 77 according to the seventh embodiment will be described while referring to FIGS. 29 to 34.

As illustrated in FIG. 29, the drum cartridge 77 includes a drum frame 744, the drum cleaner 745, a toner pipe 746 (see FIG. 30), a seal member 747 (see FIG. 30), and a collected toner conveying member 748 (see FIG. 30) in addition to the above-described photosensitive drum 741, charging roller 742, and developing device 743. In other words, the cartridge 74 includes the drum cleaner 745, toner pipe 746, seal member 747, and collected toner conveying member 748.

<12.2.1 Drum Frame 744>

As illustrated in FIG. 31, the drum frame 744 includes a drum first side plate 741A and a drum second side plate 741B. In other words, the cartridge 74 includes the drum first side plate 741A and the drum second side plate 741B.

The drum first side plate 741A is positioned at one end portion in the first direction of the drum frame 744. As illustrated in FIGS. 31 and 32, the drum first side plate 741A supports one end portion in the first direction of the photosensitive drum 741. The drum first side plate 741A extends in a third direction. The third direction crosses the first direction. Preferably, the third direction is orthogonal to the first direction. The drum first side plate 741A has two holes 742A and 743A.

The hole 742A is positioned separated from the photosensitive drum 741 in the third direction. The hole 742A is an elongated hole. The hole 742A extends in the third direction.

The hole 743A is positioned separated from the photosensitive drum 741 in a direction connecting the first axis A71 and developing axis A72. The hole 743A is an elongated hole. The hole 743A extends in the direction connecting the first axis A71 and developing axis A72. In the present embodiment, the direction connecting the first axis A71 and developing axis A72 is orthogonal to the first direction and crosses the third direction.

The drum second side plate 741B is positioned at the other end portion in the first direction of the drum frame 744. As illustrated in FIGS. 29 and 31, the drum second side plate 741B supports the other end portion in the first direction of the photosensitive drum 741. The drum first side plate 741A and drum second side plate 741B support respectively the one end portion and the other end portion of the photosensitive drum 741 in the first direction, whereby the drum frame 744 supports the photosensitive drum 741. The drum second side plate 741B is positioned separated from the drum first side plate 741A in the first direction. The drum second side plate 741B extends in the third direction. The drum second side plate 741B has two holes 742B and 743B.

The hole 742B is positioned separated from the photosensitive drum 741 in the third direction. Like the hole 742A, the hole 742B is an elongated hole. The hole 742B extends in the third direction.

The hole 743B is positioned separated from the photosensitive drum 741 in the direction connecting the first axis A71 and developing axis A72. Like the hole 743A, the hole 743B is an elongated hole. The hole 743B extends in the direction connecting the first axis A71 and developing axis A72.

<12.2.2 Details of Developing Device 743>

As illustrated in FIG. 29, the developing device 743 includes a developing conveying member 733, a developing shutter 734, two projections 735A, 735B (see FIG. 31) and two projections 736A, 736B (see FIG. 31), in addition to the above-described developing housing 731 and developing roller 732.

<12.2.2.1 Developing Housing 731>

As illustrated in FIG. 31, the developing housing 731 is positioned between the drum first side plate 741A and the drum second side plate 741B in the first direction. The developing housing 731 includes two developing side plates 7311A, 7311B, a main body part 7312, a protruding part 7313, and a bottom plate 7314.

<12.2.2.1.1 Developing Side Plates 7311A, 7311B>

The developing side plate 7311A is positioned at one end portion in the first direction of the developing housing 731. The developing side plate 7311A is positioned between the drum first side plate 741A and the drum second side plate 741B in the first direction. The developing side plate 7311A supports one end portion in the first direction of the developing roller 732. As illustrated in FIGS. 30 and 31, the developing side plate 7311A includes a guide 7315A.

The guide 7315A is configured to guide a projection 786A (see FIG. 35) of a toner container 78 (see FIG. 35) during attachment of the toner container 78 to the drum cartridge 77. The toner container 78 and the projection 786A will be described later. The guide 7315A extends in a direction crossing both the first direction and a moving direction of the developing device 743. In this embodiment, the direction in which the guide 7315A extends is defined as “guide direction”. Preferably, the guide direction is orthogonal to the first direction and crosses the moving direction of the developing device 743. The moving direction of the developing device 743 will be described later.

As illustrated in FIGS. 29 and 31, the developing side plate 7311B is positioned at the other end portion in the first direction of the developing housing 731. The developing side plate 7311B is positioned separated from the developing side plate 7311A in the first direction. The developing side plate 7311B is positioned between the developing side plate 7311A and the drum second side plate 741B in the first direction. The developing side plate 7311B supports the other end portion in the first direction of the developing roller 732. The developing side plates 7311A and 7311B support respectively the one end portion and the other end portion of the developing roller 732 in the first direction, whereby the developing roller 732 is supported by the developing housing 731. The developing side plate 7311B includes the guide 7315B.

The guide 7315B is configured to guide a projection 786B (see FIG. 35) of the toner container 78 during attachment of the toner container 78 to the drum cartridge 77. The projection 786B will be described later. The guide 7315B extends in the same direction as the direction in which the guide 7315A of the developing side plate 7311A extends.

<12.2.2.1.2 Main Body Part 7312>

As illustrated in FIG. 31, the main body part 7312 is positioned between the developing side plate 7311A and the developing side plate 7311B in the first direction. The main body part 7312 extends in the first direction. The main body part 7312 includes a developing chamber 730 (see FIG. 29), a toner receiving port 731A, a toner return port 731B, and a second toner return port 731C. In other words, the developing housing 731 includes the developing chamber 730, toner receiving port 731A, toner return port 731B, and second toner return port 731C.

As illustrated in FIG. 29, the developing chamber 730 is the inner space of the main body part 7312. The developing chamber 730 is positioned between the developing side plate 7311A and the developing side plate 7311B in the first direction. The developing chamber 730 can store therein toner from the toner container 78 (see FIG. 35). The developing roller 732 can supply toner in the developing chamber 730 to the photosensitive drum 741.

In a state where the toner container 78 (see FIG. 35) is attached to the drum cartridge 77, the toner receiving port 731A can receive toner discharged from a toner discharge port 811A of the toner container 78. The toner discharge port 811A will be described later. As illustrated in FIG. 31, the toner receiving port 731A is positioned at the center portion in the first direction of the developing housing 731. More specifically, the toner receiving port 731A is positioned at the center portion in the first direction of the main body part 7312. The toner receiving port 731A overlaps an upstream end E71 of a developing first conveying member 733A as viewed in a direction that is orthogonal to the first direction and is directed toward the developing first conveying member 733A from the toner receiving port 731A. The developing first conveying member 733A will be described later. The toner receiving port 731A overlaps an upstream end E75 of a developing third conveying member 733C as viewed in a direction that is orthogonal to the first direction and is directed toward the developing third conveying member 733C from the toner receiving port 731A. The developing third conveying member 733C will be described later. As illustrated in FIG. 33, the toner receiving port 731A is communicated with the developing chamber 730.

In a state where the toner container 78 is attached to the drum cartridge 77, toner can be returned to a returned toner receiving port 811B (see FIG. 35) of the toner container 78 through the toner return port 731B as illustrated in FIG. 31. The toner return port 731B is positioned separated from the toner receiving port 731A in the first direction. The toner return port 731B is positioned between the developing side plate 7311A and the toner receiving port 731A in the first direction. The toner return port 731B is positioned at one end portion in the first direction of the main body part 7312. In other words, the toner return port 731B is positioned at the one end portion in the first direction of the developing housing 731. The toner return port 731B overlaps a downstream end E72 of the developing first conveying member 733A as viewed in a direction that is orthogonal to the first direction and is directed toward the developing first conveying member 733A from the toner return port 731B. The toner return port 731B is communicated with the developing chamber 730 (see FIG. 33).

In a state where the toner container 78 is attached to the drum cartridge 77, toner can be returned to a second returned toner receiving port 811C (see FIG. 35) of the toner container 78 through the second toner return port 731C. The second toner return port 731C is positioned on the opposite side of the toner receiving port 731A from the toner return port 731B in the first direction. The second toner return port 731C is positioned separated from the toner receiving port 731A in the first direction. The second toner return port 731C is positioned between the developing side plate 7311B and the toner receiving port 731A in the first direction. The second toner return port 731C is positioned at the other end portion in the first direction of the main body part 7312. In other words, the second toner return port 731C is positioned at the other end portion in the first direction of the developing housing 731. The second toner return port 731C overlaps a downstream end E76 of the developing third conveying member 733C as viewed in a direction that is orthogonal to the first direction and is directed toward the developing third conveying member 733C from the second toner return port 731C. The second toner return port 731C is communicated with the developing chamber 730 (see FIG. 33).

<12.2.2.1.3 Protruding Part 7313>

As illustrated in FIGS. 30 and 31, the protruding part 7313 is positioned on the opposite side of the developing side plate 7311A from the developing side plate 7311B in the first direction. The protruding part 7313 protrudes from the developing side plate 7311A. The protruding part 7313 is positioned between the developing side plate 7311A and the drum first side plate 741A in the first direction. The protruding part 7313 extends in the first direction. The inner space of the protruding part 7313 is communicated with the developing chamber 730 (see FIG. 33). The protruding part 7313 includes a collected toner receiving port 731D. In other words, the developing housing 731 includes the collected toner receiving port 731D (see FIG. 30).

The collected toner receiving port 731D is positioned on the opposite side of the developing side plate 7311A from the developing side plate 7311B in the first direction. That is, the collected toner receiving port 731D is positioned at the one end portion in the first direction of the developing housing 731. The collected toner receiving port 731D is positioned outside a developable area in the first direction. In this embodiment, the developable area refers to an area where the developing roller 732 can supply toner to the photosensitive drum 741. The collected toner receiving port 731D can receive the collected toner from the toner pipe 746. The collected toner receiving port 731D is communicated with the inner space of the protruding part 7313. Accordingly, the collected toner receiving port 731D is communicated with the developing chamber 730 (see FIG. 33) through the inner space of the protruding part 7313.

<12.2.2.1.4 Bottom Plate 7314>

As illustrated in FIG. 31, the bottom plate 7314 is positioned between the developing side plate 7311A and developing side plate 7311B in the first direction. The bottom plate 7314 extends in the first direction. One end portion in the first direction of the Bottom plate 7314 is connected to the developing side plate 7311A. The other end in the first direction of the bottom plate 7314 is connected to the developing side plate 7311B. The bottom plate 7314 has a plurality of holes 73141A, 73141B, 73142A, 73142B, 73143A, and 73143B (see FIG. 31).

The holes 73141A and 73141B are holes for fixing a toner first shutter 785A (see FIG. 36) to the developing device 743 during attachment of the toner container 78 to the drum cartridge 77. The toner first shutter 785A will be described later.

The hole 73141A is positioned at the center portion in the first direction of the bottom plate 7314. During attachment of the toner container 78 to the drum cartridge 77, a projection 851A (see FIG. 37) of the toner first shutter 785A is fitted into the hole 73141A.

The hole 73141B is positioned at the center portion in the first direction of the bottom plate 7314. The hole 73141B is positioned separated from the hole 73141A in the first direction. The hole 73141B is positioned on the opposite side of the toner receiving port 731A from the hole 73141A in the first direction. During attachment of the toner container 78 to the drum cartridge 77, a projection 851B (see FIG. 36) of the toner first shutter 785A is fitted into the hole 73141B.

During attachment of the toner container 78 to the drum cartridge 77, the projections 851A and 851B are fitted respectively into the holes 73141A and 73141B, whereby the toner first shutter 785A is fixed to the developing device 743. The projections 851A and 851B will be described later.

The holes 73142A and 73142B are holes for fixing a toner second shutter 785B (see FIG. 37) to the developing device 743 during attachment of the toner container 78 to the drum cartridge 77. The toner second shutter 785B will be described later.

The hole 73142A is positioned at the one end portion in the first direction of the bottom plate 7314. During attachment of the toner container 78 to the drum cartridge 77, a projection 852A (see FIG. 37) of the toner second shutter 785B is fitted into the hole 73142A.

The hole 73142B is positioned at the one end portion in the first direction of the bottom plate 7314. The hole 73142B is positioned separated from the hole 73142A in the first direction. The hole 73142B is positioned on the opposite side of the toner return port 731B from the hole 73142A in the first direction. During attachment of the toner container 78 to the drum cartridge 77, a projection 852B (see FIG. 37) of the toner second shutter 785B is fitted into the hole 73142B.

During attachment of the toner container 78 to the drum cartridge 77, the projections 852A and 852B are fitted respectively into the holes 73142A and 73142B, whereby the toner second shutter 785B is fixed to the developing device 743. The projections 852A and 852B will be described later.

The holes 73143A and 73143B are holes for fixing a toner third shutter 785C (see FIG. 37) to the developing device 743 during attachment of the toner container 78 to the drum cartridge 77. The toner third shutter 785C will be described later.

The hole 73143A is positioned at the other end portion in the first direction of the bottom plate 7314. During attachment of the toner container 78 to the drum cartridge 77, a projection 853A (see FIG. 37) of the toner third shutter 785C is fitted into the hole 73143A.

The hole 73143B is positioned at the other end portion in the first direction of the bottom plate 7314. The hole 73143B is positioned separated from the hole 73143A in the first direction. The hole 73143B is positioned on the opposite side of the second toner return port 731C from the hole 73143A in the first direction. During attachment of the toner container 78 to the drum cartridge 77, a projection 853B (see FIG. 37) of the toner third shutter 785C is fitted into the hole 73143B.

During attachment of the toner container 78 to the drum cartridge 77, the projections 853A and 853B are fitted respectively into the holes 73143A and 73143B, whereby the toner third shutter 785C is fixed to the developing device 743. The projections 853A and 853B will be described later.

<12.2.2.2 Details of Charging Roller 742>

As illustrated in FIG. 30, the charging roller 742 includes a shaft 7421 and a roller body 7422.

As illustrated in FIG. 31, the shaft 7421 extends in the first direction. One end portion in the first direction of the shaft 7421 is rotatably supported by the drum first side plate 741A. The other end portion in the first direction of the shaft 7421 is rotatably supported by the drum second side plate 741B.

The roller body 7422 is positioned between the drum first side plate 741A and the drum second side plate 741B in the first direction. The dimension in the first direction of the roller body 7422 is shorter than the dimension in the first direction of the shaft 7421. The roller body 7422 is rotatable together with the shaft 7421. The roller body 7422 extends in the first direction. The roller body 7422 has a cylindrical shape.

<12.2.2.3 Developing Conveying Member 733>

As illustrated in FIG. 29, the developing conveying member 733 is positioned inside the developing housing 731. More specifically, as illustrated in FIGS. 29 and 30, the developing conveying member 733 is positioned inside the developing chamber 730 (see FIG. 29) and protruding part 7313, i.e., the developing conveying member 733 is disposed over both the inside of the developing chamber 730 and the inside of the protruding part 7313. As illustrated in FIG. 31, the developing conveying member 733 extends in the first direction. The developing conveying member 733 includes the developing first conveying member 733A, a developing second conveying member 733B, and the developing third conveying member 733C. In other words, the developing device 743 includes the developing first conveying member 733A, developing second conveying member 733B, and developing third conveying member 733C.

<12.2.2.3.1 Developing First Conveying Member 733A>

The developing first conveying member 733A is positioned inside the developing chamber 730. The developing first conveying member 733A is configured to convey toner in the developing chamber 730 in the first direction. The developing first conveying member 733A is configured to convey toner from the toner receiving port 731A toward the toner return port 731B. The developing first conveying member 733A extends in the first direction. The developing first conveying member 733A extends from the toner receiving port 731A to the toner return port 731B. The developing first conveying member 733A has the upstream end E71 and the downstream end E72 in the toner conveying direction from the toner receiving port 731A toward the toner return port 731B. In the present embodiment, the developing first conveying member 733A is an auger screw. The developing first conveying member 733A is rotatable about an axis A73. The axis A73 extends in the first direction.

<12.2.2.3.2 Developing Second Conveying Member 733B>

The developing second conveying member 733B is positioned inside the protruding part 7313. The developing second conveying member 733B is configured to convey toner in the protruding part 7313 in the first direction. The developing second conveying member 733B is configured to convey toner from the collected toner receiving port 731D (see FIG. 30) toward the toner return port 731B. The developing second conveying member 733B extends in the first direction. The developing second conveying member 733B extends from the collected toner receiving port 731D to the toner return port 731B. In the present embodiment, the developing second conveying member 733B is an auger screw. The developing second conveying member 733B is connected to the downstream end E72 of the developing first conveying member 733A. The developing second conveying member 733B is rotatable together with the developing first conveying member 733A. The developing second conveying member 733B is rotatable about the axis A73.

<12.2.2.3.3 Developing Third Conveying Member 733C>

The developing third conveying member 733C is positioned inside the developing chamber 730. The developing third conveying member 733C is configured to convey toner in the developing chamber 730 in the first direction. The developing third conveying member 733C is configured to convey toner from the toner receiving port 731A toward the second toner return port 731C. The developing third conveying member 733C extends in the first direction. The developing third conveying member 733C extends from the toner receiving port 731A to the second toner return port 731C. The developing third conveying member 733C has the upstream end E75 and the downstream end E76 in the toner conveying direction from the toner receiving port 731A to the second toner return port 731C. In the present embodiment, the developing third conveying member 733C is an auger screw. The developing third conveying member 733C is connected to the upstream end E71 of the developing first conveying member 733A. The developing third conveying member 733C is rotatable together with the developing first conveying member 733A. The developing third conveying member 733C is rotatable about the axis A73.

<12.2.2.4 Developing Shutter 734>

The developing shutter 734 is positioned between the developing side plate 7311A and the developing side plate 7311B in the first direction. The developing shutter 734 extends in the first direction. The developing shutter 734 is movable between a closing position (see FIG. 34) and an opening position (see FIG. 33). In a state where the developing shutter 734 is at the closing position as illustrated in FIG. 34, the developing shutter 734 closes the toner receiving port 731A, toner return port 731B (see FIG. 31), and second toner return port 731C (see FIG. 31). In a state where the developing shutter 734 is at the opening position as illustrated in FIG. 33, the developing shutter 734 closes the toner receiving port 731A, toner return port 731B, and second toner return port 731C, i.e., the toner receiving port 731A, toner return port 731B, and second toner return port 731C are open. As illustrated in FIG. 31, the developing shutter 734 includes a developing first shutter 734A, a developing second shutter 734B, a developing third shutter 734C, a connection part 734D, and a connection part 734E. In other words, the developing device 743 includes the developing first shutter 734A and developing second shutter 734B.

<12.2.2.4.1 Developing First Shutter 734A>

As illustrated in FIGS. 33 and 34, the developing first shutter 734A is configured to open and close the toner receiving port 731A. In a state where the developing shutter 734 is at the closing position as illustrated in FIG. 34, the developing first shutter 734A closes the toner receiving port 731A. In a state where the developing shutter 734 is at the opening position as illustrated in FIG. 33, the developing first shutter 734A opens the toner receiving port 731A, i.e., the toner receiving port 731A is open. As illustrated in FIG. 31, the developing first shutter 734A is positioned at the center portion in the first direction of the developing shutter 734. The developing first shutter 734A extends in the first direction.

<12.2.2.4.2 Developing Second Shutter 734B>

The developing second shutter 734B is configured to open and close the toner return port 731B. In a state where the developing shutter 734 is at the closing position, the developing second shutter 734B closes the toner return port 731B. In a state where the developing shutter 734 is at the opening position, the developing second shutter 734B opens the toner return port 731B, i.e., the toner return port 731B is open. The developing second shutter 734B is positioned at one end portion in the first direction of the developing shutter 734. The developing second shutter 734B is positioned separated from the developing first shutter 734A in the first direction. The developing second shutter 734B extends in the first direction.

<12.2.2.4.3 Developing Third Shutter 734C>

The developing third shutter 734C is configured to open and close the second toner return port 731C. In a state where the developing shutter 734 is at the closing position, the developing third shutter 734C closes the second toner return port 731C. In a state where the developing shutter 734 is at the opening position, the developing third shutter 734C opens the second toner return port 731C, i.e., the second toner return port 731C is open. The developing third shutter 734C is positioned at the other end portion in the first direction of the developing shutter 734. The developing third shutter 734C is positioned on the opposite side of the developing first shutter 734A from the developing second shutter 734B in the first direction. The developing third shutter 734C is positioned separated from the developing first shutter 734A in the first direction. The developing third shutter 734C extends in the first direction.

<12.2.2.4.4 Connection Parts 734D, 734E>

The connection part 734D connects the developing first shutter 734A and the developing second shutter 734B. The connection part 734D is positioned between the developing first shutter 734A and the developing second shutter 734B in the first direction. The connection part 734D extends in the first direction. One end portion in the first direction of the connection part 734D is connected to the developing second shutter 734B. The other end portion of the connection part 734D in the first direction is connected to the developing first shutter 734A. The connection part 734D has a hole 7341D.

The connection part 734E connects the developing first shutter 734A and the developing third shutter 734C. The connection part 734E is positioned between the developing first shutter 734A and the developing third shutter 734C in the first direction. The connection part 734E extends in the first direction. One end portion in the first direction of the connection part 734E is connected to the developing first shutter 734A. The other end portion of the connection part 734E in the first direction is connected to the developing third shutter 734C. The connection part 734E has a hole 7341E.

<2.2.5 Projections 735A, 735B, 736A, 736B>

As illustrated in FIG. 32, the projection 735A is positioned separated from the photosensitive drum 741 in the third direction. As illustrated in FIG. 31, the projection 735A is positioned on the opposite side of the developing side plate 7311A from the developing side plate 7311B in the first direction. The projection 735A extends from the developing side plate 7311A. The projection 735A may be assembled to the developing side plate 7311A. The projection 735A extends in the first direction. The projection 735A is fitted in the hole 742A of the drum first side plate 741A.

The projection 735B is positioned separated from the photosensitive drum 741 in the third direction. The projection 735B is positioned on the opposite side of the developing side plate 7311B from the developing side plate 7311A in the first direction. The projection 735B extends from the developing side plate 7311B. The projection 735B may be assembled to the developing side plate 7311B. The projection 735B extends in the first direction. The projection 735B is fitted in the hole 742B of the drum second side plate 741B.

As illustrated in FIG. 32, the projection 736A is positioned separated from the photosensitive drum 741 in the direction connecting the first axis A71 and the developing axis A72. As illustrated in FIG. 31, the projection 736A is positioned on the opposite side of the developing side plate 7311A from the developing side plate 7311B in the first direction. The projection 736A extends in the first direction. The projection 736A extends along the developing axis A72. In the present embodiment, the projection 736A is one end portion of the shaft of the developing roller 732. The projection 736A may extend from the developing side plate 7311A. The projection 736A may be assembled to the developing side plate 7311A. The projection 736Ais fitted in the hole 743A of the drum first side plate 741A.

The projection 736B is positioned separated from the photosensitive drum 741 in the direction connecting the first axis A71 and the developing axis A72. The projection 736B is positioned on the opposite side of the developing side plate 7311B from the developing side plate 7311A in the first direction. The projection 736B extends in the first direction. The projection 736B extends along the developing axis A72. In the present embodiment, the projection 736B is the other end portion of the shaft of the developing roller 732. The projection 736B may extend from the developing side plate 7311B. The projection 736B may be assembled to the developing side plate 7311B. The projection 736B is fitted in the hole 743B of the drum second side plate 741B.

The projection 735A is fitted into the hole 742A of the drum first side plate 741A, the projection 735B is fitted into the hole 742B of the drum second side plate 741B, the projection 736A is fitted into the hole 743A of the drum first side plate 741A, and the projection 736B is fitted into the hole 743B of the drum second side plate 741B, whereby the developing device 743 is supported by both the drum first side plate 741A and drum second side plate 741B so as to be movable relative to the photosensitive drum 741.

The developing device 743 is movable in the direction connecting the first axis A71 and the developing axis A72. The direction connecting the first axis A71 and the developing axis A72 is defined as the moving direction of the developing device 743.

<12.2.3 Drum Cleaner 745>

As illustrated in FIG. 33, the drum cleaner 745 is configured to clean the peripheral surface of the photosensitive drum 741. The drum cleaner 745 removes, from the peripheral surface of the photosensitive drum 741, toner that remains on the peripheral surface of the photosensitive drum 741 as a result of not having been transferred from the photosensitive drum 741 to the sheet S. The toner that has been removed from the peripheral surface of the photosensitive drum 741 by the drum cleaner 745 becomes the collected toner. In a state where the cartridge 74 is attached to the image forming apparatus 71 (see FIG. 27), the drum cleaner 745 is positioned further upward than the photosensitive drum 741.

The drum cleaner 745 includes a cleaner housing 751 and a cleaning member 752.

As illustrated in FIG. 31, the cleaner housing 751 is positioned between the drum first side plate 741A and the drum second side plate 741B in the first direction. The cleaner housing 751 extends in the first direction. One end portion in the first direction of the cleaner housing 751 is connected to the drum first side plate 741A. The other end portion in the first direction of the cleaner housing 751 is connected to the drum second side plate 741B. As illustrated in FIG. 33, the cleaner housing 751 has an opening 753. The cleaner housing 751 stores therein the collected toner.

The cleaning member 752 is assembled to the cleaner housing 751. The cleaning member 752 extends in the first direction. The cleaning member 752 has a plate-like shape. The cleaning member 752 cleans the peripheral surface of the photosensitive drum 741. More specifically, the edge of the cleaning member 752 contacts the peripheral surface of the photosensitive drum 741. When the photosensitive drum 741 rotates, toner on the peripheral surface of the photosensitive drum 741 contacts the edge of the cleaning member 752 and is thus removed from the peripheral surface of the photosensitive drum 741. The removed toner passes through the opening 753 and then is stored in the cleaner housing 751.

<12.2.4 Toner Pipe 746>

As illustrated in FIG. 31, the toner pipe 746 is positioned on the opposite side of the developing side plate 7311A from the developing side plate 7311B in the first direction. The toner pipe 746 is positioned between the drum first side plate 741A and the drum second side plate 741B in the first direction. More specifically, the toner pipe 746 is positioned between the drum first side plate 741A and the developing side plate 7311A.

The toner pipe 746 passes through one side in the first direction of the charging roller 742. As illustrated in FIG. 30, the toner pipe 746 passes through an area above the shaft 7421 and is connected to the developing device 743. The toner pipe 746 is connected to the protruding part 7313 of the developing housing 731. As illustrated in FIG. 31, the toner pipe 746 passes through an area on one side in the first direction of the developing device 743.

That is, as illustrated in FIGS. 30 and 31, in a state where the cartridge 74 is attached to the image forming apparatus 71 (see FIG. 27), the toner pipe 746 passes through an area that is on one side in the first direction of the roller body 7422 (see FIG. 31) and above the shaft 7421 (see FIG. 30) and is connected to the developing device 743. Note that, the toner pipe 746 may be configured to be connected to the toner container 78, not to the developing device 743.

The toner pipe 746 allows the collected toner to pass therethrough. As illustrated in FIG. 30, the toner pipe 746 has one end portion E73 and the other end portion E74 (see FIG. 30).

The one end portion E73 is connected to the drum cleaner 745 (see FIG. 31). More specifically, the one end portion E73 is connected to the one end portion in the first direction of the cleaner housing 751. Hence, the toner pipe 746 is communicated with the cleaner housing 751.

As illustrated in FIG. 30, the other end portion E74 of the toner pipe 746 is connected to the developing housing 731. More specifically, the other end portion E74 is connected to the protruding part 7313 of the developing housing 731 in the first direction. The other end portion E74 of the toner pipe 746 has a collected toner discharge port 761. The collected toner discharge port 761 is a port through which the collected toner in the toner pipe 746 can be discharged. The other end portion E74 is inserted in the collected toner receiving port 731D from the above, whereby the collected toner discharge port 761 is communicated with the internal space of the protruding part 7313.

In a state where the cartridge 74 is attached to the image forming apparatus 71 (see FIG. 27), the other end portion E74 is positioned further downward than the one end portion E73.

<12.2.5 Seal Member 747>

As illustrated in FIG. 30, the seal member 747 is positioned between the outer peripheral surface of the toner pipe 746 and the inner peripheral surface of the collected toner receiving port 731D. The seal member 747 seals a portion between the outer peripheral surface of the toner pipe 746 and the inner peripheral surface of the collected toner receiving port 731D. The seal member 747 is elastically deformable in accordance with movement of the developing device 743 relative to the photosensitive drum 741. The seal member 747 is made of sponge, for example.

<12.2.6 Collected Toner Conveying Member 748>

As illustrated in FIGS. 30 and 31, the collected toner conveying member 748 is positioned inside the toner pipe 746. The collected toner conveying member 748 is configured to convey the collected toner in the toner pipe 746. More specifically, the collected toner conveying member 748 is configured to convey the collected toner in the toner pipe 746 toward the collected toner discharge port 761. In the present embodiment, the collected toner conveying member 748 is a shaftless screw.

<12.3. Details of Toner Container 78 according to Seventh Embodiment>

Next, details of the toner container 78 according to the seventh embodiment will be described while referring to FIGS. 35 to 38. In the following description of the toner container 78, when referring to the first direction, it is assumed that the toner container 78 has already been attached to the drum cartridge 77.

As illustrated in FIG. 35, the toner container 78 includes a toner housing 781, a toner conveying member 782, a plurality of agitators 784A, 784B, 784C, 784D, 784E, 784F, 784G, and 784H, the toner first shutter 785A, the toner second shutter 785B, the toner third shutter 785C, the two projections 786A, 786B, and two projections 787A, 787B.

<12.3.1 Toner Housing 781>

As illustrated in FIGS. 35 and 36, the toner housing 781 includes a first toner storage part 811, a second toner storage part 812, and a partition wall 813. In other words, the toner container 78 includes the first toner storage part 811 and second toner storage part 812.

<12.3.1.1 First Toner Storage Part 811>

The first toner storage part 811 stores therein toner to be supplied to the developing housing 731. In a state where the toner container 78 is attached to the drum cartridge 77 as illustrated in FIG. 27, the first toner storage part 811 is positioned between the developing housing 731 and the second toner storage part 812. The first toner storage part 811 has a cylindrical shape. The first toner storage part 811 extends in the first direction.

As illustrated in FIG. 35, the first toner storage part 811 has the toner discharge port 811A, the returned toner receiving port 811B, and the second returned toner receiving port 811C. In other words, the toner container 78 has the toner discharge port 811A, returned toner receiving port 811B, and second returned toner receiving port 811C.

The toner discharge port 811A is a port through which toner in the toner container 78 can be discharged. More specifically, toner in the first toner storage part 811 can be discharged through the toner discharge port 811A. The toner discharge port 811A is positioned at the center portion in the first direction of the first toner storage part 811. The toner discharge port 811A is communicated with the inner space of the first toner storage part 811.

The returned toner receiving port 811B can receive returned toner. The returned toner is toner to be returned from the developing device 743 (see FIG. 27) to the toner container 78. The returned toner receiving port 811B can receive the toner returned from the toner return port 731B (see FIG. 31) to the toner container 78. The returned toner receiving port 811B is positioned at one end portion in the first direction of the first toner storage part 811. The returned toner receiving port 811B is positioned separated from the toner discharge port 811A in the first direction. The returned toner receiving port 811B is communicated with the inner space of the first toner storage part 811.

The second returned toner receiving port 811C can receive the returned toner. The second returned toner receiving port 811C can receive the toner returned from the second toner return port 731C (see FIG. 31) to the toner container 78. The second returned toner receiving port 811C is positioned at the other end portion in the first direction of the first toner storage part 811. The second returned toner receiving port 811C is positioned separated from the toner discharge port 811A in the first direction. The second returned toner receiving port 811C is positioned on the opposite side of the toner discharge port 811A from the returned toner receiving port 811B. The second returned toner receiving port 811C is communicated with the inner space of the first toner storage part 811.

<12.3.1.2 Second Toner Storage Part 812>

The second toner storage part 812 stores therein toner to be supplied to the first toner storage part 811. In a state where the toner container 78 is attached to the drum cartridge 77 as illustrated in FIG. 27, the second toner storage part 812 is positioned separated from the developing housing 731. As illustrated in FIG. 35, the second toner storage part 812 extends in the first direction. The capacity of the second toner storage part 812 is larger than that of the first toner storage part 811.

<12.3.1.3 Partition Wall 813>

The partition wall 813 is positioned between the first toner storage part 811 and the second toner storage part 812. The partition wall 813 separates the first toner storage part 811 and second toner storage part 812 from each other. The partition wall 813 has two passage ports 813A and 813B.

The passage port 813A is positioned between the toner discharge port 811A and the returned toner receiving port 811B in the first direction. The passage port 813A allows toner to pass therethrough between the first toner storage part 811 and the second toner storage part 812.

The passage port 813B is positioned between the toner discharge port 811A and the second returned toner receiving port 811C in the first direction. The passage port 813B is positioned separated from the passage port 813A in the first direction. The passage port 813B allows toner to pass therethrough between the first toner storage part 811 and the second toner storage part 812.

<12.3.2 Toner Conveying Member 782>

The toner conveying member 782 is positioned inside the first toner storage part 811. The toner conveying member 782 includes a toner first conveying member 782A and a toner second conveying member 782B. In other words, the toner container 78 includes the toner first conveying member 782A and toner second conveying member 782B.

The toner first conveying member 782A is configured to convey toner in the first toner storage part 811 in the first direction. The toner first conveying member 782A conveys toner from the returned toner receiving port 811B toward the toner discharge port 811A. The toner first conveying member 782A extends in the first direction. The toner first conveying member 782A extends from the returned toner receiving port 811B to the toner discharge port 811A.

The toner second conveying member 782B is configured to convey toner in the first toner storage part 811 in the first direction. The toner second conveying member 782B conveys toner from the second returned toner receiving port 811C toward the toner discharge port 811A. The toner second conveying member 782B extends in the first direction. The toner second conveying member 782B extends from the second returned toner receiving port 811C to the toner discharge port 811A.

<12.3.3 Agitators 784A, 784B, 784C, 784D, 784E, 784F, 784G, and 784H>

The agitators 784A, 784B, 784C, 784D, 784E, 784F, 784G, and 784H are positioned inside the second toner storage part 812. The agitators 784A, 784B, 784C, 784D, 784E, 784F, 784G, and 784H are arranged at intervals in a direction from the second toner storage part 812 toward the first toner storage part 811. The agitators 784A, 784B, 784C, 784D, 784E, 784F, 784G, and 784H are each configured to convey toner in the second toner storage part 812 toward the first toner storage part 811 while agitating the toner.

<12.3.4 Toner First Shutter 785A>

As illustrated in FIG. 37, the toner first shutter 785A is positioned at the center portion in the first direction of the first toner storage part 811. The toner first shutter 785A is positioned on the peripheral surface of the first toner storage part 811. The toner first shutter 785A is configured to open and close the toner discharge port 811A (see FIG. 33). More specifically, as illustrated in FIGS. 33 and 34, the toner first shutter 785A is movable between a closing position (see FIG. 34) and an opening position (see FIG. 33) along the peripheral surface of the first toner storage part 811. In a state where the toner first shutter 785A is at the closing position as illustrated in FIG. 34, the toner first shutter 785A closes the toner discharge port 811A. In a state where the toner first shutter 785A is at the opening position as illustrated in FIG. 33, the toner first shutter 785A opens the toner discharge port 811A, i.e., the toner discharge port 811A is open. As illustrated in FIG. 37, the toner first shutter 785A includes the two projections 851A, 851B.

The projections 851A and 851B are positioned on the peripheral surface of the toner first shutter 785A. The projections 851A and 851B extend from the peripheral surface of the toner first shutter 785A. The projections 851A and 851B may be assembled to the peripheral surface of the toner first shutter 785A.

The projection 851A is positioned at one end portion in the first direction of the toner first shutter 785A. During attachment of the toner container 78 to the drum cartridge 77, the projection 851A is fitted into the hole 73141A (see FIG. 31) of the drum cartridge 77.

The projection 851B is positioned at the other end portion in the first direction of the toner first shutter 785A. During attachment of the toner container 78 to the drum cartridge 77, the projection 851B is fitted into the hole 73141B (see FIG. 31) of the drum cartridge 77.

During attachment of the toner container 78 to the drum cartridge 77, the projections 851A and 851B are fitted respectively into the holes 73141A and 73141B, whereby the toner first shutter 785A is fixed to the drum cartridge 77.

<12.3.5 Toner Second Shutter 785B>

As illustrated in FIG. 37, the toner second shutter 785B is positioned at the one end portion in the first direction of the first toner storage part 811. The toner second shutter 785B is positioned on the peripheral surface of the first toner storage part 811. The toner second shutter 785B is configured to open and close the returned toner receiving port 811B (see FIG. 35). More specifically, like the toner first shutter 785A, the toner second shutter 785B is movable between a closing position and an opening position along the peripheral surface of the first toner storage part 811. In a state where the toner second shutter 785B is at the closing position, the toner second shutter 785B closes the returned toner receiving port 811B. In a state where the toner second shutter 785B is at the opening position, the toner second shutter 785B opens the returned toner receiving port 811B, i.e., the returned toner receiving port 811B is open. The toner second shutter 785B includes the two projections 852A, 852B.

The projections 852A and 852B are positioned on the peripheral surface of the toner second shutter 785B. The projections 852A and 852B extend from the peripheral surface of the toner second shutter 785B. The projections 852A and 852B may be assembled to the peripheral surface of the toner second shutter 785B.

The projection 852A is positioned at one end portion in the first direction of the toner second shutter 785B. During attachment of the toner container 78 to the drum cartridge 77, the projection 852A is fitted into the hole 73142A (see FIG. 31) of the drum cartridge 77.

The projection 852B is positioned at the other end portion in the first direction of the toner second shutter 785B. During attachment of the toner container 78 to the drum cartridge 77, the projection 852B is fitted into the hole 73142B (see FIG. 31) of the drum cartridge 77.

During attachment of the toner container 78 to the drum cartridge 77, the projections 852A and 852B are fitted respectively into the holes 73142A and 73142B, whereby the toner second shutter 785B is fixed to the drum cartridge 77.

<12.3.6 Toner Third Shutter 785C>

The toner third shutter 785C is positioned at the other end portion in the first direction of the first toner storage part 811. The toner third shutter 785C is positioned on the peripheral surface of the first toner storage part 811. The toner third shutter 785C is configured to open and close the second returned toner receiving port 811C (see FIG. 35). More specifically, like the toner first shutter 785A, the toner third shutter 785C is movable between a closing position and an opening position along the peripheral surface of the first toner storage part 811. In a state where the toner third shutter 785C is at the closing position, the toner third shutter 785C closes the second returned toner receiving port 811C. In a state where the toner third shutter 785C is at the opening position, the toner third shutter 785C opens the second returned toner receiving port 811C, i.e., the second returned toner receiving port 811C is open. The toner third shutter 785C includes two the projections 853A, 853B.

The projections 853A and 853B are positioned on the peripheral surface of the toner third shutter 785C. The projections 853A and 853B extend from the peripheral surface of the toner third shutter 785C. The projections 853A and 853B may be assembled to the peripheral surface of the toner third shutter 785C.

The projection 853A is positioned at one end portion in the first direction of the toner third shutter 785C. During attachment of the toner container 78 to the drum cartridge 77, the projection 853A is fitted into the hole 73143A (see FIG. 31) of the drum cartridge 77.

The projection 853B is positioned at the other end portion in the first direction of the toner third shutter 785C. During attachment of the toner container 78 to the drum cartridge 77, the projection 853B is fitted into the hole 73143B (see FIG. 31) of the drum cartridge 77.

During attachment of the toner container 78 to the drum cartridge 77, the projections 853A and 853B are fitted respectively into the holes 73143A and 73143B, whereby the toner third shutter 785C is fixed to the drum cartridge 77.

<12.3.7 Projections 786A, 786B>

The projection 786A is positioned on an outer surface S71 of the first toner storage part 811. The outer surface S71 is an outer surface positioned on one side in the first direction of the first toner storage part 811. The projection 786A protrudes from the outer surface S71. The projection 786A may be assembled to the outer surface S71. During attachment of the toner container 78 to the drum cartridge 77, the projection 786A is fitted into the guide 7315A (see FIG. 31) of the drum cartridge 77.

The projection 786B is positioned on an outer surface S72 of the first toner storage part 811. The outer surface S72 is an outer surface positioned on the other side in the first direction of the first toner storage part 811. The projection 786B protrudes from the outer surface S72. The projection 786B may be assembled to the outer surface S72. During attachment of the toner container 78 to the drum cartridge 77, the projection 786B is fitted into the guide 7315B (see FIG. 31) of the drum cartridge 77.

<12.3.9 Projections 787A, 787B>

As illustrated in FIG. 37, the projection 787A is positioned on the peripheral surface of the first toner storage part 811. The projection 787A is positioned between the toner first shutter 785A and the toner second shutter 785B in the first direction. The projection 787A is positioned between the toner discharge port 811A (see FIG. 35) and the returned toner receiving port 811B (see FIG. 35) in the first direction. The projection 787A extends from the peripheral surface of the first toner storage part 811. The projection 787A may be assembled to the peripheral surface of the first toner storage part 811. During attachment of the toner container 78 to the drum cartridge 77, the projection 787A is fitted into the hole 7341D (see FIG. 31) of the developing shutter 734.

The projection 787B is positioned on the peripheral surface of the first toner storage part 811. The projection 787B is positioned between the toner first shutter 785A and the toner third shutter 785C in the first direction. The projection 787B is positioned between the toner discharge port 811A (see FIG. 35) and the second returned toner receiving port 811C (see FIG. 35) in the first direction. The projection 787B extends from the peripheral surface of the first toner storage part 811. The projection 787B may be assembled to the peripheral surface of the first toner storage part 811. During attachment of the toner container 78 to the drum cartridge 77, the projection 787B is fitted into the hole 7341E (see FIG. 31) of the developing shutter 734.

<12.4. Attachment of Toner Container 78 to Drum Cartridge 77>

Next, attachment of the toner container 78 to the drum cartridge 77 will described while referring to FIGS. 27, 29 to 31, and 34 to 38.

In a state where the toner container 78 is detached from the drum cartridge 77 as illustrated in FIG. 29, the developing shutter 734 is positioned at its closing position, the toner first shutter 785A is positioned at its closing position (see FIG. 34), the toner second shutter 785B (see FIG. 35) is positioned at its closing position, and the toner third shutter 785C (see FIG. 35) is positioned at its closing position.

When attaching the toner container 78 to the drum cartridge 77, a user positions the first toner storage part 811 to the developing housing 731 as illustrated in FIG. 38.

More specifically, the user fits the projection 786A (see FIG. 35) and projection 786B (see FIG. 35) of the toner container 78 into the guide 7315A (see FIG. 30) and guide 7315B (see FIG. 29) of the cartridge 74, respectively. Then, the user mounts the toner container 78 onto the drum cartridge 77 along the guides 7315A and 7315B such that the first toner storage part 811 is mounted first.

As a result, the projections 851A and 851B (see FIG. 37) of the toner first shutter 785A are fitted respectively into the holes 73141A and 73141B (see FIG. 31) of the developing housing 731, the projections 852A and 852B (see FIG. 37) of the toner second shutter 785B are fitted respectively into the holes 73142A and 73142B (see FIG. 31) of the developing housing 731, and the projections 853A and 853B (see FIG. 37) of the toner third shutter 785C are fitted respectively into the holes 73143A and 73143B (see FIG. 31) of the developing housing 731.

Hence, the toner first shutter 785A, toner second shutter 785B, and toner third shutter 785C are fixed to the developing housing 731, whereby the first toner storage part 811 is positioned to the developing housing 731. As illustrated in FIG. 38, the second toner storage part 812 is positioned separated from the bottom plate 7314 of the developing housing 731.

Further, the projections 787A and 787B (see FIG. 37) of the toner container 78 are fitted respectively into the holes 7341D and 7341E (see FIG. 31) of the developing shutter 734.

Then, as illustrated in FIG. 27, the user pivotally moves the toner housing 781 about the first toner storage part 811. Specifically, the user pivotally moves the toner housing 781 in such a direction that the second toner storage part 812 approaches the bottom plate 7314.

As a result, as illustrated in FIG. 33, the developing shutter 734 pivotally moves together with the toner housing 781 to move from the closing position to the opening position. Further, since the toner housing 781 is pivotally moved in such a direction that the second toner storage part 812 approaches the bottom plate 7314 in a state where the toner first shutter 785A, toner second shutter 785B, and toner third shutter 785C are fixed to the developing housing 731, the toner first shutter 785A moves from its closing position to its opening position relative to the toner housing 781, the toner second shutter 785B (see FIG. 36) moves from its closing position to its opening position relative to the toner housing 781, and the toner third shutter 785C (see FIG. 36) moves from its closing position to its opening position relative to the toner housing 781.

Then, as illustrated in FIG. 33, attachment of the toner container 78 to the drum cartridge 77 is completed in a state where the developing shutter 734 is at its opening position, the toner first shutter 785A is at its opening position, the toner second shutter 785B (see FIG. 36) is at its opening position, and the toner third shutter 785C (see FIG. 36) is at its opening position.

Note that, when the user pivotally moves the toner housing 781 in such a direction that the second toner storage part 812 is separated from the bottom plate 7314 from a state where the toner container 78 is attached to the drum cartridge 77, the developing shutter 734 pivotally moves together with the toner housing 781 to move from its opening position to its closing position. Further, since the toner housing 781 is pivotally moved in such a direction that the second toner storage part 812 is separated from the bottom plate 7314 in a state where the toner first shutter 785A, toner second shutter 785B, and toner third shutter 785C are fixed to the developing housing 731, the toner first shutter 785A moves from its opening position to its closing position relative to the toner housing 781, the toner second shutter 785B moves from its opening position to its closing position relative to the toner housing 781, and the toner third shutter 785C moves from its opening position to its closing position relative to the toner housing 781.

<12.5. Functions and Effects>

(1) According to the cartridge 74, the collected toner from the photosensitive drum 741 can be returned to the developing housing 731 through the collected toner receiving port 731D as illustrated in FIG. 30. Further, the toner that has been returned to the developing housing 731 can be returned to the toner container 78 through the toner return port 731B and returned toner receiving port 811B as illustrated in FIGS. 32 and 36.

With the above configuration, the collected toner can be supplied once again to the photosensitive drum 741 after mixed with unused toner in the developing housing 731 or in the toner container 78.

This eliminates the need to provide in the cartridge 74 a space for storing the collected toner to thereby correspondingly increase the capacity of the toner container 78.

As a result, the capacity of the toner container 78 can be increased while suppressing increase in size of the cartridge 74.

(2) According to the cartridge 74, as illustrated in FIG. 30, the collected toner receiving port 731D can smoothly receive the collected toner in the toner pipe 746 by using gravity.

(3) As illustrated in FIG. 31, the toner pipe 746 is positioned between the drum first side plate 741A and the drum second side plate 741B in the first direction. This configuration enables the cartridge 74 to further suppress increase in size thereof.

(4) According to the cartridge 74, the developing device 743 includes the developing second conveying member 733B as illustrated in FIG. 31. The developing second conveying member 733B conveys toner from the collected toner receiving port 731D to the toner return port 731B.

With this configuration, the collected toner introduced into the developing housing 731 through the collected toner receiving port 731D can be returned smoothly to the toner container 78 by the developing second conveying member 733B.

(5) According to the cartridge 74, in an area outside the developable area, the collected toner can be received from the toner pipe 746.

As a result, in the area outside the developable area, the collected toner in the toner pipe 746 can be returned to the developing housing 731.

### 13. Eighth Embodiment

Next, an eighth embodiment and modifications thereof will be described while referring to FIGS. 39 to 60.

<13.1. Outline of Image Forming Apparatus 81 according to Eighth Embodiment>

The outline of an image forming apparatus 81 according to the eighth embodiment will be described while referring to FIGS. 39 and 40.

As illustrated in FIG. 39, the image forming apparatus 81 includes a main body housing 82, a sheet accommodation portion 83, a drawer 84, a plurality of cartridges 85Y, 85M, 85C, and 85K, an exposing device 86, a transfer device 87, and a fixing device 88.

<13.1.1 Main Body Housing 82>

The main body housing 82 houses therein the sheet accommodation portion 83, drawer 84, cartridges 85Y, 85M, 85C, and 85K, exposing device 86, transfer device 87, and fixing device 88. The main body housing 82 has an opening 821 and includes a cover 822. The cover 822 is movable between a closing position (see FIG. 39) and an opening position (see FIG. 40). As illustrated in FIG. 39, in a state where the cover 822 is at the closing position, the cover 822 closes the opening 821. As illustrated in FIG. 40, in a state where the cover 822 is at the opening position, the cover 822 opens the opening 821, i.e., the opening 821 is opened.

<13.1.2 Sheet Accommodation Portion 83>

As illustrated in FIG. 39, the sheet accommodation portion 83 can accommodate therein a sheet S. The sheet S in the sheet accommodation portion 83 is conveyed toward the transfer device 87.

<13.1.3 Drawer 84>

As illustrated in FIGS. 39 and 40, in a state where the cover 822 is at the opening position, the drawer 84 is movable between an inner position (see FIG. 39) and an outer position (see FIG. 40) through the opening 821. As illustrated in FIG. 39, in a state where the drawer 84 is at the inner position, the entire drawer 84 is positioned inside the main body housing 82. As illustrated in FIG. 40, in a state where the drawer 84 is at the outer position, at least a part of the drawer 84 is positioned outside the main body housing 82.

<13.1.4 Cartridge 85Y>

The cartridge 85Y is attachable to and detachable from the image forming apparatus 81. In more detail, in a state where the drawer 84 is at the outer position (see FIG. 40), the cartridge 85Y is attachable to and detachable from the drawer 84. In a state where the cartridge 85Y is attached to the drawer 84 and the drawer 84 is at the inner position (see FIG. 39), the cartridge 85Y is attached to the image forming apparatus 81. In this state where the cartridge 85Y is attached to the image forming apparatus 81, the cartridge 85Y is positioned inside the main body housing 82. The cartridge 85Y attached to the drawer 84 can be detached from the drawer 84 in a state where the drawer 84 is at the outer position (see FIG. 40).

As illustrated in FIG. 39, the cartridge 85Y includes a drum cartridge 89Y and a toner container 90Y

<13.1.4.1 Drum Cartridge 89Y>

The drum cartridge 89Y includes a photosensitive drum 51Y, a charging roller 52Y, and a developing device 53Y. In other words, the cartridge 85Y includes the photosensitive drum 51Y, charging roller 52Y, and developing device 53Y

<13.1.4.1.1 Photosensitive Drum 51Y>

The photosensitive drum 51Y is rotatable about a first axis A81. The first axis A81 extends in a first direction. The photosensitive drum 51Y extends in the first direction. The photosensitive drum 51Y has a cylindrical shape.

<13.1.4.1.2 Charging Roller 52Y>

The charging roller 52Y charges the peripheral surface of the photosensitive drum 51Y. The image forming apparatus 81 may have a scorotron charger in place of the charging roller 52Y.

<13.1.4.1.3 Developing Device 53Y>

The developing device 53Y is configured to supply toner contained in the toner container 90Y to the photosensitive drum 51Y. The developing device 53Y includes a developing housing 531 and a developing roller 532. In other words, the drum cartridge 89Y includes the developing housing 531 and developing roller 532.

The developing housing 531 can store therein toner from the toner container 90Y.

The developing roller 532 is configured to supply toner in the developing housing 531 to the photosensitive drum 51Y. The developing roller 532 is rotatably supported by the developing housing 531. The developing roller 532 is in contact with the photosensitive drum 51Y. The developing roller 532 may be configured to come into contact with and separate from the photosensitive drum 51Y. The developing roller 532 extends in the first direction. The developing roller 532 is rotatable about a developing axis A82. In a state where the cartridge 85Y is attached to the image forming apparatus 81, the developing axis A82 extends in the first direction.

<13.1.4.2 Toner Container 90Y>

The toner container 90Y can store toner therein. The toner container 90Y is attachable to and detachable from the drum cartridge 89Y. In other words, the toner container 90Y is attachable to and detachable from the cartridge 85Y. That is, the toner container 90Y is attachable to and detachable from to the image forming apparatus 81. Accordingly, a state where the cartridge 85Y is attached to the image forming apparatus 81 denotes a state where the drum cartridge 89Y having the toner container 90Y attached thereto is attached to the image forming apparatus 81.

<13.1.5 Cartridges 85M, 85C, 85K>

The cartridge 85M is attachable to and detachable from the image forming apparatus 81. The cartridge 85M includes a drum cartridge 89M and a toner container 90M. The drum cartridge 89M includes a photosensitive drum 51M, a charging roller 52M, and a developing device 53M. In other words, the cartridge 85M includes the photosensitive drum 51M, charging roller 52M, and developing device 53M.

The cartridge 85C is attachable to and detachable from the image forming apparatus 81. The cartridge 85C includes a drum cartridge 89C and a toner container 90C. The drum cartridge 89C includes a photosensitive drum 51C, a charging roller 52C, and a developing device 53C. In other words, the cartridge 85C includes the photosensitive drum 51C, charging roller 52C, and developing device 53C.

The cartridge 85K is attachable to and detachable from the image forming apparatus 81. The cartridge 85K includes a drum cartridge 89K and a toner container 90K. The drum cartridge 89K includes a photosensitive drum 51K, a charging roller 52K, and a developing device 53K. In other words, the cartridge 85K includes the photosensitive drum 51K, charging roller 52K, and developing device 53K.

The cartridges 85M, 85C, and 85K each have the same structure as that of the cartridge 85Y, so description of each of the cartridges 85M, 85C, and 85K will be omitted.

<13.1.6 Exposing Device 86>

The exposing device 86 is configured to expose the peripheral surfaces of the photosensitive drums 51Y, 51M, 51C, and 51K in a state where the cartridges 85Y, 85M, 85C, and 85K are attached to the image forming apparatus 81. In more detail, the exposing device 86 is configured to expose the peripheral surface of the photosensitive drum 51Y charged by the charging roller 52Y. The exposing device 86 is configured to expose the peripheral surface of the photosensitive drum 51M charged by the charging roller 52M. The exposing device 86 is configured to expose the peripheral surface of the photosensitive drum 51C charged by the charging roller 52C. The exposing device 86 is configured to expose the peripheral surface of the photosensitive drum 51K charged by the charging roller 52K. In the present embodiment, the exposing device 86 is a laser scan unit.

<13.1.7 Transfer Device 87>

The transfer device 87 is positioned below the photosensitive drums 51Y, 51M, 51C, and 51K in a state where the cartridges 85Y, 85M, 85C, and 85K are attached to the image forming apparatus 81. The transfer device 87 includes a belt 71 and a plurality of transfer rollers 72Y, 72M, 72C, and 72K.

In a state where the cartridges 85Y, 85M, 85C, and 85K are attached to the image forming apparatus 81, the belt 71 is in contact with the photosensitive drums 51Y, 51M, 51C, and 51K. The belt 71 is configured to convey the sheet S fed from the sheet accommodation portion 83 toward the fixing device 88. The sheet S fed from the sheet accommodation portion 83 passes between the belt 71 and photosensitive drums 51Y, 51M, 51C, and 51K.

The transfer roller 72Y is configured to transfer toner on the photosensitive drum 51Y to the sheet S being conveyed by the belt 71. The transfer roller 72M is configured to transfer toner on the photosensitive drum 51M to the sheet S being conveyed by the belt 71. The transfer roller 72C is configured to transfer toner on the photosensitive drum 51C to the sheet S being conveyed by the belt 71. The transfer roller 72K is configured to transfer toner on the photosensitive drum 51K to the sheet S being conveyed by the belt 71.

<13.1.8 Fixing Device 88>

The fixing device 88 is configured to fix toner to the sheet S. In the present embodiment, the fixing device 88 applies heat and pressure to the sheet S having toner transferred thereon to fix the toner to the sheet S. The sheet S that has passed through the fixing device 88 is discharged to the upper surface of the main body housing 82.

<13.2. Details of Drum Cartridge 89Y>

In the present disclosure, in a state where the cartridge 85Y is attached to the image forming apparatus 81, the cartridge 85Y can return toner in the developing device 53Y to the toner container 90Y. In the following description of this embodiment, toner returned from the developing device 53Y to the toner container 90Y is defined as “retuned toner”.

In the present disclosure, in a state where the cartridge 85Y is attached to the image forming apparatus 81, toner can be circulated between the developing device 53Y and the toner container 90Y in the cartridge 85Y. In a state where the cartridge 85Y is attached to the image forming apparatus 81, the returned toner can be mixed with unused toner in both the developing device 53Y and the toner container 90Y and supplied once again to the photosensitive drum 51Y. In this embodiment, the unused toner refers to toner that has never been supplied to the photosensitive drum 51Y.

Next, the drum cartridge 89Y will be described while referring to FIGS. 41 to 48.

As illustrated in FIG. 41, the drum cartridge 89Y includes a drum frame 59, a drum cleaner 55, a toner pipe 56 (see FIG. 42), a seal member 57 (see FIG. 42), and a collected toner conveying member 58 (see FIG. 42) in addition to the above-described photosensitive drum 51Y, charging roller 52Y, and developing device 53Y. In other words, the cartridge 85Y includes the drum cleaner 55, toner pipe 56, seal member 57, and collected toner conveying member 58.

<13.2.1 Drum Frame 59>

As illustrated in FIG. 43, the drum frame 59 includes two drum side plates 541A and 541B. In other words, the cartridge 85Y includes the two drum side plates 541A and 541B.

The drum side plate 541A is positioned at one end portion in the first direction of the drum frame 59. The drum side plate 541A supports one end portion in the first direction of the photosensitive drum 51Y. As illustrated in FIG. 42, the drum side plate 541A extends in a direction crossing the first direction. Preferably, the drum side plate 541A extends in a direction orthogonal to the first direction. The drum side plate 541A includes two holes 542A and 543A.

The hole 542A is positioned separated from the photosensitive drum 51Y in a direction connecting the first axis A81 and the developing axis A82. The hole 542A is an elongated hole. The hole 542A extends in the direction connecting the first axis A81 and the developing axis A82.

The hole 543A is positioned between the photosensitive drum 51Y and the hole 542A in the direction connecting the first axis A81 and the developing axis A82. The hole 543A is an elongated hole. The hole 543A extends in the direction connecting the first axis A81 and the developing axis A82.

As illustrated in FIG. 43, the drum side plate 541B is positioned at the other end portion in the first direction of the drum frame 59. The drum side plate 541B supports the other end portion in the first direction of the photosensitive drum 51Y. The drum side plates 541A and 541B support respectively the one end portion and the other end portion in the first direction of the photosensitive drum 51Y, whereby the drum frame 59 supports the photosensitive drum 51Y. The drum side plate 541B is positioned separated from the drum side plate 541A in the first direction. The drum side plate 541B extends in a direction crossing the first direction. Preferably, the drum side plate 541B extends in a direction orthogonal to the first direction. The drum side plate 541B includes two holes 542B and 543B.

The hole 542B is positioned separated from the photosensitive drum 51Y in the direction connecting the first axis A81 and the developing axis A82. Like the hole 542A (see FIG. 42), the hole 542B is an elongated hole. The hole 542B extends in the direction connecting the first axis A81 and the developing axis A82.

The hole 543B is positioned between the photosensitive drum 51Y and the hole 542B in the direction connecting the first axis A81 and the developing axis A82. Like the hole 543A (see FIG. 42), the hole 543B is an elongated hole. The hole 543B extends in the direction connecting the first axis A81 and the developing axis A82.

<13.2.2 Details of Developing Device 53Y>

As illustrated in FIG. 44, the developing device 53Y includes a first developing conveying member 533, a second developing conveying member 534, a developing shutter 535 (see FIG. 43), two projections 536A, 536B and two projections 537A, 537B, in addition to the above-described developing housing 531 and developing roller 532.

<13.2.2.1 Developing Housing 531>

As illustrated in FIG. 43, the developing housing 531 is positioned between the drum side plate 541A and the drum side plate 541B in the first direction. As illustrated in FIG. 44, the developing housing 531 includes two developing side plates 5311A, 5311B, a main body part 5312, a protruding part 5313, and a bottom plate 5314.

<13.2.2.1.1 Developing Side Plates 5311A, 5311B>

The developing side plate 5311A is positioned at one end portion in the first direction of the developing housing 531. As illustrated in FIG. 43, the developing side plate 5311A is positioned between the drum side plate 541A and the drum side plate 541B in the first direction. The developing side plate 5311A supports one end portion in the first direction of the developing roller 532. The developing side plate 5311A includes a guide 5315A.

The guide 5315A is configured to guide a projection 66A (see FIG. 50) of a toner container 90Y (see FIG. 50) during attachment of the toner container 90Y to the drum cartridge 89Y. The toner container 90Y and the projection 66A will be described later. The guide 5315A extends in a direction the same as a direction in which a guide 5315B (see FIG. 41) of the developing side plate 5311B extends. The guide 5315B will be described later.

The developing side plate 5311B is positioned at the other end portion in the first direction of the developing housing 531. The developing side plate 5311B is positioned separated from the developing side plate 5311A in the first direction. The developing side plate 5311B is positioned between the developing side plate 5311A and the drum side plate 541B in the first direction. The developing side plate 5311B supports the other end portion in the first direction of the developing roller 532. The developing side plates 5311A and 5311B support respectively the one end portion and the other end portion in the first direction of the developing roller 532, whereby the developing roller 532 is supported by the developing housing 531. As illustrated in FIG. 41, the developing side plate 5311B includes the guide 5315B.

The guide 5315B is configured to guide a projection 66B (see FIG. 50) of the toner container 90Y during attachment of the toner container 90Y to the drum cartridge 89Y. The projection 66B will be described later. The guide 5315B extends in a direction crossing both the first direction and a moving direction of the developing device 53Y. In this embodiment, the direction in which the guide 5315B extends is defined as “guide direction”. The moving direction of the developing device 53Y will be described later.

<13.2.2.1.2 Main Body Part 5312 >

As illustrated in FIG. 44, the main body part 5312 is positioned between the developing side plate 5311A and the developing side plate 5311B in the first direction. The main body part 5312 extends in the first direction. The main body part 5312 includes a first developing chamber 530A, a second developing chamber 530B, a developing partition wall 530C, a toner receiving port 531A (see FIG. 43), a toner return port 531B (see FIG. 43), and a second toner return port 531C (see FIG. 43). Further, the main body part 5312 has a plurality of holes 5312A, 5312B, 5312C, 5312D, 5312E, and 5312F (see FIG. 43). In other words, the developing housing 531 includes the first developing chamber 530A, second developing chamber 530B, developing partition wall 530C, toner receiving port 531A, toner return port 531B, and second toner return port 531C, and has the plurality of holes 5312A, 5312B, 5312C, 5312D, 5312E, and 5312F.

As illustrated in FIG. 41, the first developing chamber 530A is an inner space of the main body part 5312. The first developing chamber 530A is positioned between the developing side plate 5311A (see FIG. 44) and the developing side plate 5311B (see FIG. 44) in the first direction. The first developing chamber 530A can store toner from the toner container 90Y. The first developing chamber 530A accommodates therein a part of the developing roller 532. The developing roller 532 is configured to supply toner in the first developing chamber 530A to the photosensitive drum 51Y. In a state where the cartridge 85Y is attached to the image forming apparatus 81 (i.e., in a state where the drum cartridge 89Y having the toner container 90Y attached thereto is attached to the image forming apparatus 81), the first developing chamber 530A is positioned further downward than the toner container 90Y.

The second developing chamber 530B is another inner space of the main body part 5312. The second developing chamber 530B is positioned between the developing side plate 5311A (see FIG. 44) and the developing side plate 5311B (see FIG. 44) in the first direction. In a state where the cartridge 85Y is attached to the image forming apparatus 81, the second developing chamber 530B is positioned further upward than the first developing chamber 530A. The second developing chamber 530B can store toner from the first developing chamber 530A. In a state where the cartridge 85Y is attached to the image forming apparatus 81, at least a part of the second developing chamber 530B is aligned with a second storage chamber 613 (see FIG. 49) of the toner container 90Y in the horizontal direction. The second storage chamber 613 will be described later.

The developing partition wall 530C is positioned between the first and second developing chambers 530A and 530B. The developing partition wall 530C separates the first and second developing chambers 530A and 530B from each other. As illustrated in FIG. 44, the developing partition wall 530C has two developing passage ports 530D and 530E.

The developing passage port 530D allows toner to pass therethrough from the first developing chamber 530A to the second developing chamber 530B. Thus, the second developing chamber 530B is communicated with the first developing chamber 530A. The developing passage port 530D is positioned separated from the toner receiving port 531A (see FIG. 43) in the first direction. The developing passage port 530D is positioned between the developing side plate 5311A and the toner receiving port 531A (see FIG. 43) in the first direction. The developing passage port 530D is positioned at one end portion in the first direction of the developing partition wall 530C. The developing passage port 530D overlaps a downstream end E82 of a first conveying part 533A of the first developing conveying member 533 as viewed in a direction that is orthogonal to the first direction and is directed toward the first conveying part 533A from the developing passage port 530D. The first conveying part 533A will be described later. The developing passage port 530D overlaps an upstream end E85 of a first conveying part 534A of the second developing conveying member 534 as viewed in a direction that is orthogonal to the first direction and is directed toward the first conveying part 534A from the developing passage port 530D. The first conveying part 534A will be described later.

The developing passage port 530E (see FIG. 48) allows toner to pass therethrough from the first developing chamber 530A to the second developing chamber 530B. The developing passage port 530E is positioned separated from the toner receiving port 531A (see FIG. 43) in the first direction. The developing passage port 530E is positioned between the developing side plate 5311B and the toner receiving port 531A in the first direction. The developing passage port 530E is positioned at the other end portion in the first direction of the developing partition wall 530C. The developing passage port 530E overlaps a downstream end E84 of a second conveying part 533B of the first developing conveying member 533 as viewed in a direction that is orthogonal to the first direction and is directed toward the second conveying part 533B from the developing passage port 530E. The second conveying part 533B will be described later. The developing passage port 530E overlaps an upstream end E87 of a third conveying part 534C of the second developing conveying member 534 as viewed in a direction that is orthogonal to the first direction and is directed toward the third conveying part 534C from the developing passage port 530E. The third conveying part 534C will be described later.

As illustrated in FIG. 43, the toner receiving port 531A is positioned at the center portion in the first direction of the developing housing 531. In more detail, the toner receiving port 531A is positioned at the center portion in the first direction of the main body part 5312. The toner receiving port 531A is communicated with the first developing chamber 530A (see FIG. 41). In a state where the toner container 90Y is attached to the drum cartridge 89Y, the toner receiving port 531A can receive toner discharged from a toner discharge port 617A (see FIG. 50) of the toner container 90Y. The toner discharge port 617A will be described later. The toner receiving port 531A overlaps an upstream end E81 (see FIG. 44) of the first conveying part 533A (see FIG. 44) of the first developing conveying member 533 as viewed in a direction that is orthogonal to the first direction and is directed toward the first conveying part 533A from the toner receiving port 531A. The toner receiving port 531A overlaps an upstream end E83 (see FIG. 44) of the second conveying part 533B (see FIG. 44) of the first developing conveying member 533 as viewed in a direction that is orthogonal to the first direction and is directed toward the second conveying part 533B from the toner receiving port 531A.

As illustrated in FIG. 43, the toner return port 531B is positioned separated from the toner receiving port 531A in the first direction. The toner return port 531B is positioned separated from the developing passage port 530D (see FIG. 44) in the first direction. The toner return port 531B is positioned between the toner receiving port 531A and the developing passage port 530D in the first direction. The toner return port 531B is communicated with the second developing chamber 530B (see FIG. 44). The toner return port 531B is a port through which toner is returned to a returned toner receiving port 617B (see FIG. 50) of the toner container 90Y in a state where the toner container 90Y is attached to the drum cartridge 89Y. The returned toner receiving port 617B will be described later. The toner return port 531B overlaps a downstream end E86 of the first conveying part 534A (see FIG. 44) of the second developing conveying member 534 as viewed in a direction that is orthogonal to the first direction and is directed toward the first conveying part 534A from the toner return port 531B.

The second toner return port 531C is positioned on the opposite side of the toner receiving port 531A from the toner return port 531B in the first direction. The second toner return port 531C is positioned separated from the toner receiving port 531A in the first direction. The second toner return port 531C is positioned separated from the developing passage port 530E (see FIG. 44) in the first direction. The second toner return port 531C is positioned between the toner receiving port 531A and the developing passage port 530E in the first direction. The second toner return port 531C is communicated with the second developing chamber 530B (see FIG. 44). The second toner return port 531C is a port through which toner is returned to a second returned toner receiving port 617C (see FIG. 50) of the toner container 90Y in a state where the toner container 90Y is attached to the drum cartridge 89Y. The second toner return port 531C overlaps a downstream end E88 of the third conveying part 534C (see FIG. 44) of the second developing conveying member 534 as viewed in a direction that is orthogonal to the first direction and is directed toward the third conveying part 534C from the second toner return port 531C.

As illustrated in FIG. 43, the hole 5312A is positioned at the center portion in the first direction of the main body part 5312.

The hole 5312B (see FIG. 45) is positioned at the center portion of the main body part 5312 in the first direction. The hole 5312B is positioned separated from the hole 5312A in the first direction. The hole 5312B is positioned on the opposite side of the toner receiving port 531A from the hole 5312A in the first direction.

The hole 5312C is positioned between the developing side plate 5311A and the hole 5312A in the first direction.

The hole 5312D is positioned between the developing side plate 5311A and the hole 5312A in the first direction. The hole 5312D is positioned separated from the hole 5312C in the first direction. The hole 5312D is positioned on the opposite side of the toner return port 531B from the hole 5312C in the first direction.

The hole 5312E (see FIG. 46) is positioned between the hole 5312B and the developing side plate 5311B in the first direction.

The hole 5312F is positioned between the hole 5312E and the developing side plate 5311B in the first direction. The hole 5312F is positioned separated from the hole 5312E in the first direction. The hole 5312F is positioned on the opposite side of the second toner return port 531C from the hole 5312E in the first direction.

<13.2.2.1.3 Protruding Part 5313>

As illustrated in FIG. 44, the protruding part 5313 is positioned on the opposite side of the developing side plate 5311A from the developing side plate 5311B in the first direction. The protruding part 5313 protrudes from the developing side plate 5311A. The protruding part 5313 extends in the first direction. The inner space of the protruding part 5313 is communicated with the second developing chamber 530B. The protruding part 5313 has a collected toner receiving port 531D. In other words, the developing housing 531 has the collected toner receiving port 531D.

The collected toner receiving port 531D is positioned on the opposite side of the developing side plate 5311A from the developing side plate 5311B in the first direction. That is, the collected toner receiving port 531D is positioned at the one end portion in the first direction of the developing housing 531. The collected toner receiving port 531D is positioned outside a developable area in the first direction. In this embodiment, the developable area refers to an area where the developing roller 532 can supply toner to the photosensitive drum 51Y. The collected toner receiving port 531D can receive the collected toner from the toner pipe 56 (see FIG. 42). The collected toner receiving port 531D is communicated with the inner space of the protruding part 5313. Accordingly, the collected toner receiving port 531D is communicated with the second developing chamber 530B through the inner space of the protruding part 5313.

<13.2.2.1.4 Bottom Plate 5314>

The bottom plate 5314 is positioned between the developing side plate 5311A and the developing side plate 5311B in the first direction. The bottom plate 5314 extends in the first direction. One end portion in the first direction of the bottom plate 5314 is connected to the developing side plate 5311A. The other end portion in the first direction of the bottom plate 5314 is connected to the developing side plate 5311B.

<13.2.2.2 First Developing Conveying Member 533>

The first developing conveying member 533 is positioned inside the developing housing 531. In more detail, the first developing conveying member 533 is positioned inside the first developing chamber 530A. The first developing conveying member 533 includes the first conveying part 533A and the second conveying part 533B. In other words, the developing device 53Y includes the first conveying part 533A and second conveying part 533B.

<13.2.2.2.1 First Conveying Part 533A>

The first conveying part 533A is positioned inside the first developing chamber 530A. The first conveying part 533A is configured to convey toner in the first developing chamber 530A in the first direction. The first conveying part 533A is configured to convey toner in the first developing chamber 530A from the toner receiving port 531A (see FIG. 43) toward the developing passage port 530D. The first conveying part 533A extends in the first direction. The first conveying part 533A extends from the toner receiving port 531A to the developing passage port 530D. The first conveying part 533A has the upstream end E81 and the downstream end E82 in the toner conveying direction from the toner receiving port 531A toward the developing passage port 530D. In the present embodiment, the first conveying part 533A is an auger screw. The first conveying part 533A is rotatable about an axis A83. The axis A83 extends in the first direction.

<13.2.2.2.2 Second Conveying Part 533B>

The second conveying part 533B is positioned inside the first developing chamber 530A. The second conveying part 533B is configured to convey toner in the first developing chamber 530A in the first direction. The second conveying part 533B is configured to convey toner in the first developing chamber 530A from the toner receiving port 531A (see FIG. 43) toward the developing passage port 530E. The second conveying part 533B extends in the first direction. The second conveying part 533B extends from the toner receiving port 531A to the developing passage port 530E. The second conveying part 533B has the upstream end E83 and the downstream end E84 in the toner conveying direction from the toner receiving port 531A toward the developing passage port 530E. In the present embodiment, the second conveying part 533B is an auger screw. The second conveying part 533B is connected to the upstream end E81 of the first conveying part 533A. The second conveying part 533B is rotatable together with the first conveying part 533A. The second conveying part 533B is rotatable about the axis A83.

<13.2.2.3 Second Developing Conveying Member 534>

The second developing conveying member 534 is positioned inside the developing housing 531. In more detail, the second developing conveying member 534 is positioned inside the second developing chamber 530B. The second developing conveying member 534 includes the first conveying part 534A, a second conveying part 534B, and the third conveying part 534C. In other words, the developing device 53Y includes the first conveying part 534A, second conveying part 534B, and third conveying part 534C.

<13.2.2.3.1 First Conveying Part 534A>

The first conveying part 534A is positioned inside the second developing chamber 530B. The first conveying part 534A is configured to convey toner in the second developing chamber 530B in the first direction. The first conveying part 534A is configured to convey toner in the second developing chamber 530B from the developing passage port 530D toward the toner return port 531B. The first conveying part 534A extends in the first direction. The first conveying part 534A extends from the developing passage port 530D to the toner return port 531B. The first conveying part 534A has the upstream end E85 and the downstream end E86 in the toner conveying direction from the developing passage port 530D toward the toner return port 531B. In the present embodiment, the first conveying part 534A is an auger screw. The first conveying part 534A is rotatable about an axis A84. The axis A84 extends in the first direction.

<13.2.2.3.2 Second Conveying Part 534B>

The second conveying part 534B is positioned inside the protruding part 5313. The second conveying part 534B is configured to convey toner in the protruding part 5313 in the first direction. The second conveying part 534B is configured to convey toner in the protruding part 5313 from the collected toner receiving port 531D toward the second developing chamber 530B. The second conveying part 534B extends in the first direction. The second conveying part 534B extends from the collected toner receiving port 531D to the second developing chamber 530B. In the present embodiment, the second conveying part 534B is an auger screw. The second conveying part 534B is connected to the upstream end E85 of the first conveying part 534A. The second conveying part 534B is rotatable together with the first conveying part 534A. The second conveying part 534B is rotatable about the axis A84.

<13.2.2.3.3 Third Conveying Part 534C>

The third conveying part 534C is positioned inside the second developing chamber 530B. The third conveying part 534C is configured to convey toner in the second developing chamber 530B in the first direction. The third conveying part 534C is configured to convey toner in the second developing chamber 530B from the developing passage port 530E toward the second toner return port 531C (see FIG. 43). The third conveying part 534C extends in the first direction. The third conveying part 534C extends from the developing passage port 530E to the second toner return port 531C. The third conveying part 534C has the upstream end E87 and the downstream end E88 in the toner conveying direction from the developing passage port 530E toward the second toner return port 531C. In the present embodiment, the third conveying part 534C is an auger screw. The third conveying part 534C is rotatable together with the first and second conveying parts 534A and 534B. The third conveying part 534C is rotatable about the axis A84.

<13.2.2.4 Developing Shutter 535>

As illustrated in FIG. 43, the developing shutter 535 is positioned between the developing side plate 5311A and the developing side plate 5311B in the first direction. The developing shutter 535 extends in the first direction. The developing shutter 535 is movable between a closing position (see FIGS. 45 to 48) and an opening position (see FIG. 58). In a state where the developing shutter 535 is at the closing position, the developing shutter 535 closes the toner receiving port 531A, toner return port 531B, and second toner return port 531C. In a state where the developing shutter 535 is at the opening position, the developing shutter 535 opens the toner receiving port 531A, toner return port 531B, and second toner return port 531C, i.e., the toner receiving port 531A, toner return port 531B, and second toner return port 531C are open. The developing shutter 535 includes a developing first shutter 535A, a developing second shutter 535B, a developing third shutter 535C, a connection part 535D, and a connection part 535E, and has two holes 535F and 535G. In other words, the developing device 53Y includes the developing first shutter 535A, developing second shutter 535B, and developing third shutter 535C, and has the two holes 535F and 535G.

<13.2.2.4.1 Developing First Shutter 535A>

The developing first shutter 535A is configured to open and close the toner receiving port 531A. In a state where the developing shutter 535 is at the closing position, the developing first shutter 535A closes the toner receiving port 531A. In a state where the developing shutter 535 is at the opening position, the developing first shutter 535A opens the toner receiving port 531A, i.e., the toner receiving port 531A is open. The developing first shutter 535A is positioned at the center portion in the first direction of the developing shutter 535. The developing first shutter 535A extends in the first direction.

<13.2.2.4.2 Developing Second Shutter 535B>

The developing second shutter 535B is configured to open and close the toner return port 531B. In a state where the developing shutter 535 is at the closing position, the developing second shutter 535B closes the toner return port 531B. In a state where the developing shutter 535 is at the opening position, the developing second shutter 535B opens the toner return port 531B, i.e., the toner return port 531B is opened. The developing second shutter 535B is positioned between the developing first shutter 535A and the developing side plate 5311A in the first direction. The developing second shutter 535B is positioned separated from the developing first shutter 535A in the first direction. The developing second shutter 535B extends in the first direction.

<13.2.2.4.3 Developing Third Shutter 535C>

The developing third shutter 535C is configured to opens and close the second toner return port 531C. As illustrated in FIG. 47, in a state where the developing shutter 535 is at the closing position, the developing third shutter 535C closes the second toner return port 531C. In a state where the developing shutter 535 is at the opening position, the developing third shutter 535C opens the second toner return port 531C, i.e., the second toner return port 531C is opened. As illustrated in FIG. 43, the developing third shutter 535C is positioned between the developing first shutter 535A and the developing side plate 5311B in the first direction. The developing third shutter 535C is positioned on the opposite side of the developing first shutter 535A from the developing second shutter 535B in the first direction. The developing third shutter 535C is positioned separated from the developing first shutter 535A in the first direction. The developing third shutter 535C extends in the first direction.

<13.2.2.4.4 Connection Parts 535D, 535E>

The connection part 535D connects the developing first shutter 535A and the developing second shutter 535B. The connection part 535D is positioned between the developing first shutter 535A and the developing second shutter 535B in the first direction. The connection part 535D extends in the first direction. One end portion in the first direction of the connection part 535D is connected to the developing second shutter 535B. The other end portion in the first direction of the connection part 535D is connected to the developing first shutter 535A.

The connection part 535E connects the developing first shutter 535A and the developing third shutter 535C. The connection part 535E is positioned between the developing first shutter 535A and the developing third shutter 535C in the first direction. The connection part 535E extends in the first direction. One end portion in the first direction of the connection part 535E is connected to the developing first shutter 535A. The other end portion in the first direction of the connection part 535E is connected to the developing third shutter 535C.

<13.2.2.4.5 Holes 535F, 535G>

The hole 535F is positioned at one end portion in the first direction of the developing shutter 535. The hole 535F is positioned on the opposite side of the developing second shutter 535B from the developing first shutter 535A in the first direction. The hole 535F is positioned separated from the developing second shutter 535B in the first direction.

The hole 535G is positioned at the other end portion in the first direction of the developing shutter 535. The hole 535G is positioned on the opposite side of the developing third shutter 535C from the developing first shutter 535A in the first direction. The hole 535G is positioned separated from the developing third shutter 535C in the first direction.

<13.2.2.5 Projections 536A, 536B, 537A, 537B>

As illustrated in FIG. 44, the projection 536A is positioned on the opposite side of the developing side plate 5311A from the developing side plate 5311B in the first direction. The projection 536A extends from the developing side plate 5311A. The projection 536A may be assembled to the developing side plate 5311A. The projection 536A extends in the first direction. As illustrated in FIG. 42, the projection 536A is positioned separated from the photosensitive drum 51Y in the direction connecting the first axis A81 and the developing axis A82. The projection 536A is fitted in the hole 542A of the drum side plate 541A.

As illustrated in FIG. 44, the projection 536B is positioned on the opposite side of the developing side plate 5311B from the developing side plate 5311A in the first direction. The projection 536B extends from the developing side plate 5311B. The projection 536B may be assembled to the developing side plate 5311B. The projection 536B extends in the first direction. As illustrated in FIG. 43, the projection 536B is fitted in the hole 542B of the drum side plate 541B.

As illustrated in FIG. 44, the projection 537A is positioned on the opposite side of the developing side plate 5311A from the developing side plate 5311B in the first direction. The projection 537A extends in the first direction. The projection 537A extends along the developing axis A82. In the present embodiment, the projection 537A is one end portion of the shaft of the developing roller 532. The projection 537A may extend from the developing side plate 5311A. The projection 537A may be assembled to the developing side plate 5311A. As illustrated in FIG. 42, the projection 537A is positioned separated from the photosensitive drum 51Y in the direction connecting the first axis A81 and the developing axis A82. The projection 537A is fitted in the hole 543A of the drum side plate 541A.

As illustrated in FIG. 44, the projection 537B is positioned on the opposite side of the developing side plate 5311B from the developing side plate 5311A in the first direction. The projection 537B extends in the first direction. The projection 537B extends along the developing axis A82. In the present embodiment, the projection 537B is the other end portion of the shaft of the developing roller 532. The projection 537B may extend from the developing side plate 5311B. The projection 537B may be assembled to the developing side plate 5311B. The projection 537B is positioned separated from the photosensitive drum 51Y in the direction connecting the first axis A81 and the developing axis A82. As illustrated in FIG. 43, the projection 537B is fitted in the hole 543B of the drum side plate 541B.

The projection 536A is fitted in the hole 542A of the drum side plate 541A, the projection 536B is fitted in the hole 542B of the drum side plate 541B, the projection 537A is fitted in the hole 543A of the drum side plate 541A, and the projection 537B is fitted in the hole 543B of the drum side plate 541B, whereby the developing device 53Y is supported by the drum side plate 541A and drum side plate 541B so as to be movable relative to the photosensitive drum 51Y.

The developing device 53Y is movable in the direction connecting the first axis A81 and the developing axis A82. The direction connecting the first axis A81 and the developing axis A82 is defined as the moving direction of the developing device 53Y.

<13.2.3 Drum Cleaner 55 >

As illustrated in FIG. 41, the drum cleaner 55 is configured to clean the peripheral surface of the photosensitive drum 51Y. The drum cleaner 55 removes, from the peripheral surface of the photosensitive drum 51Y, toner that remains on the peripheral surface of the photosensitive drum 51Y as a result of not having been transferred from the photosensitive drum 51Y to sheet S. The toner that has been removed from the peripheral surface of the photosensitive drum 51Y by the drum cleaner 55 is the collected toner.

The drum cleaner 55 includes a cleaner housing 554 and a cleaning member 555.

The cleaner housing 554 is positioned between the drum side plates 541A (see FIGS. 43) and 541B (see FIG. 43) in the first direction. The cleaner housing 554 extends in the first direction. One end portion in the first direction of the cleaner housing 554 is connected to the drum side plate 541A (see FIG. 43). The other end portion in the first direction of the cleaner housing 554 is connected to the drum side plate 541B (see FIG. 43). As illustrated in FIG. 41, the cleaner housing 554 has an opening 556. The cleaner housing 554 stores therein the collected toner.

The cleaning member 555 is assembled to the cleaner housing 554. The cleaning member 555 extends in the first direction. The cleaning member 555 has a plate-like shape. The cleaning member 555 is configured to clean the peripheral surface of the photosensitive drum 51Y. In more detail, the edge of the cleaning member 555 contacts the peripheral surface of the photosensitive drum 51Y. When the photosensitive drum 51Y rotates, toner on the peripheral surface of the photosensitive drum 51Y contacts the edge of the cleaning member 555 to be removed from the peripheral surface of the photosensitive drum 51Y. The removed toner passes through the opening 556 and then is stored in the cleaner housing 554.

<13.2.4 Toner Pipe 56 >

As illustrated in FIGS. 42 and 43, the toner pipe 56 is positioned on the opposite side of the drum side plate 541A from the drum side plate 541B in the first direction. The toner pipe 56 is fixed to the drum frame 59. In more detail, the toner pipe 56 is fixed to the drum side plate 541A. The toner pipe 56 allows the collected toner to pass therethrough.

The toner pipe 56 has a first end portion 56C and a second end portion 56D. The first end portion 56C is connected to the drum cleaner 55. In more detail, the first end portion 56C is connected to the one end portion in the first direction of the cleaner housing 554. Hence, the toner pipe 56 is communicated with the cleaner housing 554. The second end portion 56D is connected to the protruding part 5313 of the developing housing 531. In other words, the toner pipe 56 is connected to the developing housing 531 of the developing device 53Y. Note that, the toner pipe 56 may be configured to be connected to the toner container 90Y, not to the developing device 53Y. The toner pipe 56 has a collected toner discharge port 561. The collected toner discharge port 561 is a port through which the collected toner in the toner pipe 56 can be discharged. The collected toner discharge port 561 is communicated with the collected toner receiving port 531D of the developing housing 531.

<13.2.5 Seal Member 57>

As illustrated in FIG. 42, the seal member 57 is positioned between the collected toner discharge port 561 of the toner pipe 56 and the collected toner receiving port 531D of the developing housing 531. The seal member 57 seals a portion between the toner pipe 56 and the developing housing 531. The seal member 57 is elastically deformable in accordance with movement of the developing device 53Y relative to the photosensitive drum 51Y. The seal member 57 is made of sponge, for example.

<13.2.6 Collected Toner Conveying Member 58>

The collected toner conveying member 58 is positioned inside the toner pipe 56. The collected toner conveying member 58 is configured to convey the collected toner in the toner pipe 56. In more detail, the collected toner conveying member 58 is configured to convey toner in the toner pipe 56 toward the collected toner discharge port 561. In the present embodiment, the collected toner conveying member 58 is a belt conveyer.

<13.3. Toner Container 90Y>

Next, the toner container 90Y will be described while referring to FIGS. 49 to 60. In the following description of the toner container 90Y, when referring to the first direction, it is assumed that the toner container 90Y has already been attached to the drum cartridge 89Y.

As illustrated in FIG. 49, the toner container 90Y includes a toner housing 61, a toner conveying member 62, a toner conveying member 63, an agitator 64, a toner first shutter 65A, a toner second shutter 65B (see FIG. 50), a toner third shutter 65C (see FIG. 50), the two projections 66A, 66B, a projection 67A (see FIG. 51) and a projection 67B.

<13.3.1 Toner Housing 61>

As illustrated in FIG. 50, the toner housing 61 includes two toner side plates 611A and 611B, a first storage chamber 612, a second storage chamber 613, a third storage chamber 614, a fourth storage chamber 615, and a toner partition wall 616, and has the toner discharge port 617A, the returned toner receiving port 617B, and the second returned toner receiving port 617C. In other words, the toner container 90Y includes the two toner side plates 611A and 611B, first storage chamber 612, second storage chamber 613, third storage chamber 614, fourth storage chamber 615, and toner partition wall 616, and has the toner discharge port 617A, returned toner receiving port 617B, and second returned toner receiving port 617C.

<13.3.1.1 Toner Side Plates 611A, 611B>

The toner side plate 611A is positioned at one end portion in the first direction of the toner housing 61. The toner side plate 611A extends in a direction crossing the first direction. Preferably, the toner side plate 611A extends in a direction orthogonal to the first direction.

The toner side plate 611B is positioned at the other end portion in the first direction of the toner housing 61. The toner side plate 611B is positioned separated from the toner side plate 611A in the first direction. The toner side plate 611B extends in a direction crossing the first direction. Preferably, the toner side plate 611B extends in a direction orthogonal to the first direction.

<13.3.1.2 First Storage Chamber 612>

The first storage chamber 612 is positioned between the toner side plate 611A and the toner side plate 611B in the first direction. The first storage chamber 612 stores therein toner to be supplied to the second storage chamber 613. The first storage chamber 612 extends in the first direction. The first storage chamber 612 includes a first section 6121, a second section 6122, a third section 6123, and a fourth section 6124.

The first section 6121 is positioned at one end portion in the first direction of the first storage chamber 612. The first section 6121 extends in the first direction. The first section 6121 is communicated with the fourth storage chamber 615. The first section 6121 is communicated with the third storage chamber 614 through the fourth storage chamber 615.

The second section 6122 is positioned between the first section 6121 and the toner side plate 611B in the first direction. The second section 6122 is positioned separated from the first section 6121 in the first direction. The second section 6122 extends in the first direction. The second section 6122 is communicated with the fourth storage chamber 615. The second section 6122 is communicated with the third storage chamber 614 through the fourth storage chamber 615.

The third section 6123 is positioned between the second section 6122 and the toner side plate 611B in the first direction. The third section 6123 is positioned separated from the second section 6122 in the first direction. The third section 6123 extends in the first direction. The third section 6123 is communicated with the fourth storage chamber 615. The third section 6123 is communicated with the third storage chamber 614 through the fourth storage chamber 615.

The fourth section 6124 is positioned at the other end portion in the first direction of the first storage chamber 612. The fourth section 6124 is positioned separated from the third section 6123 in the first direction. The fourth section 6124 extends in the first direction. The fourth section 6124 is communicated with the fourth storage chamber 615. The fourth section 6124 is communicated with the third storage chamber 614 through the fourth storage chamber 615.

<13.3.1.3 Second Storage Chamber 613>

The second storage chamber 613 is positioned between the toner side plate 611A and the toner side plate 611B in the first direction. The second storage chamber 613 stores therein toner to be supplied to the developing housing 531 (see FIG. 58). In a state where the toner container 90Y is attached to the drum cartridge 89Y, the second storage chamber 613 is positioned between the developing housing 531 and the first storage chamber 612. In a state where the cartridge 85Y is attached to the image forming apparatus 81, the second storage chamber 613 is positioned further downward than the first storage chamber 612. The second storage chamber 613 has a cylindrical shape. The second storage chamber 613 extends in the first direction. The second storage chamber 613 includes a first section 6131, a second section 6132, and a third section 6133.

The first section 6131 is positioned at one end portion in the first direction of the second storage chamber 613. The first section 6131 extends in the first direction. The first section 6131 is communicated with the first section 6121 of the first storage chamber 612 through a second passage port 616C. In other words, the second storage chamber 613 is communicated with the first storage chamber 612.

The second section 6132 is positioned between the first section 6131 and the toner side plate 611B in the first direction. The second section 6132 extends in the first direction. The second section 6132 is communicated with the second section 6122 of the first storage chamber 612 through a first passage port 616A. The second section 6132 is communicated with the third section 6123 of the first storage chamber 612 through a first passage port 616B (see FIG. 53).

The third section 6133 is positioned at the other end portion in the first direction of the second storage chamber 613. The third section 6133 extends in the first direction. The third section 6133 is communicated with the fourth section 6124 of the first storage chamber 612 through a second passage port 616D (see FIG. 56).

<3.1.4 Third Storage Chamber 614>

The third storage chamber 614 is positioned between the toner side plate 611A and the toner side plate 611B in the first direction. The third storage chamber 614 stores therein toner to be supplied to the first storage chamber 612. The third storage chamber 614 extends in the first direction. In a state where the toner container 90Y is attached to the drum cartridge 89Y and the cartridge 85Y is attached to the image forming apparatus 81, the third storage chamber 614 is positioned further upward than the first storage chamber 612. The third storage chamber 614 has a larger capacity than the first and second storage chambers 612 and 613.

<13.3.1.5 Fourth Storage Chamber 615>

As illustrated in FIG. 49, the fourth storage chamber 615 is communicated with the third storage chamber 614. In a state where the toner container 90Y is attached to the drum cartridge 89Y, the fourth storage chamber 615 is aligned with the first storage chamber 612 in the horizontal direction. The fourth storage chamber 615 is communicated with the first section 6121 of the first storage chamber 612, second section 6122 of the first storage chamber 612, third section 6123 (see FIG. 52) of the first storage chamber 612, and fourth section 6124 (see FIG. 55) of the first storage chamber 612. In other words, the fourth storage chamber 615 is communicated with the first storage chamber 612. That is, the third storage chamber 614 is communicated with the first storage chamber 612 through the fourth storage chamber 615.

<13.3.1.6 Toner Partition Wall 616>

As illustrated in FIG. 50, the toner partition wall 616 is positioned between the first storage chamber 612 and the second storage chamber 613. The toner partition wall 616 separates the first storage chamber 612 and the second storage chamber 613 from each other. The toner partition wall 616 has the two first passage ports 616A, 616B and the two second passage ports 616C, 616D.

The first passage port 616A is positioned between the toner discharge port 617A and the returned toner receiving port 617B in the first direction. The first passage port 616A allows toner to pass therethrough from the first storage chamber 612 to the second storage chamber 613. In more detail, the first passage port 616A allows toner to pass therethrough from the second section 6122 of the first storage chamber 612 to the second section 6132 of the second storage chamber 613.

The first passage port 616B is positioned between the toner discharge port 617A and the second returned toner receiving port 617C in the first direction. The first passage port 616B is positioned separated from the first passage port 616A in the first direction. The first passage port 616B allows toner to pass therethrough from the first storage chamber 612 to the second storage chamber 613. In more detail, the first passage port 616B allows toner to pass therethrough from the third section 6123 of the first storage chamber 612 to the second section 6132 of the second storage chamber 613.

The second passage port 616C is positioned at one end portion in the first direction of the toner partition wall 616. The second passage port 616C is positioned separated from the returned toner receiving port 617B in the first direction. The second passage port 616C allows toner to pass therethrough from the second storage chamber 613 to the first storage chamber 612. In more detail, the second passage port 616C allows toner to pass therethrough from the first section 6131 of the second storage chamber 613 to the first section 6121 of the first storage chamber 612.

The second passage port 616D is positioned at the other end portion in the first direction of the toner partition wall 616. The second passage port 616D is positioned separated from the second returned toner receiving port 617C in the first direction. The second passage port 616D allows toner to pass therethrough from the second storage chamber 613 to the first storage chamber 612. In more detail, the second passage port 616D allows toner to pass therethrough from the third section 6133 of the second storage chamber 613 to the fourth section 6124 of the first storage chamber 612.

<13.3.1.7 Toner Discharge Port 617A, Returned Toner Receiving Port 617B, Second Returned Toner Receiving Port 617C>

The toner discharge port 617A is a port through which toner in the toner container 90Y can be discharged. In more detail, toner in the second section 6132 of the second storage chamber 613 can be discharged through the toner discharge port 617A. The toner discharge port 617A is positioned at the center portion in the first direction of the second storage chamber 613. The toner discharge port 617A is communicated with the inner space of the second section 6132 of the second storage chamber 613. In other words, the toner discharge port 617A is communicated with the inner space of the second storage chamber 613.

The returned toner receiving port 617B can receive the returned toner. The returned toner receiving port 617B can receive the returned toner returned from the toner return port 531B (see FIG. 43) to the toner container 90Y. The returned toner receiving port 617B is positioned between the toner side plate 611A and the toner discharge port 617A in the first direction. The returned toner receiving port 617B is positioned separated from the toner discharge port 617A in the first direction. The returned toner receiving port 617B is communicated with the inner space of the second storage chamber 613. In more detail, the returned toner receiving port 617B is communicated with the inner space of the first section 6131 of the second storage chamber 613.

The second returned toner receiving port 617C can receive the returned toner. The second returned toner receiving port 617C can receive the returned toner returned from the second toner return port 531C (see FIG. 43) to the toner container 90Y. The second returned toner receiving port 617C is positioned between the toner discharge port 617A and the toner side plate 611B in the first direction. The second returned toner receiving port 617C is positioned separated from the toner discharge port 617A in the first direction. The second returned toner receiving port 617C is positioned on the opposite side of the toner discharge port 617A from the returned toner receiving port 617B. The second returned toner receiving port 617C is communicated with the inner space of the second storage chamber 613. In more detail, the second returned toner receiving port 617C is communicated with the inner space of the third section 6133 of the second storage chamber 613.

<13.3.2 Toner Conveying Member 62>

The toner conveying member 62 is positioned inside the second storage chamber 613. The toner conveying member 62 includes two first toner conveying members 62A, 62B and two second toner conveying members 62C, 62D. In other words, the toner container 90Y includes the two first toner conveying members 62A, 62B and the two second toner conveying members 62C, 62D.

The first toner conveying member 62A is configured to convey toner in the second storage chamber 613 in the first direction. In more detail, the first toner conveying member 62A is configured to convey toner in the first section 6131 of the second storage chamber 613 in the first direction. The first toner conveying member 62A is configured to convey toner from the returned toner receiving port 617B toward the second passage port 616C. The first toner conveying member 62A extends in the first direction. The first toner conveying member 62A extends from the returned toner receiving port 617B to the second passage port 616C in the first direction. In the present embodiment, the first toner conveying member 62A is an auger screw. The first toner conveying member 62A is rotatable about an axis A85. The axis A85 extends in the first direction.

The first toner conveying member 62B is configured to convey toner in the second storage chamber 613 in the first direction. In more detail, the first toner conveying member 62B is configured to convey toner in the third section 6133 of the second storage chamber 613 in the first direction. The first toner conveying member 62B is configured to convey toner from the second returned toner receiving port 617C toward the second passage port 616D. The first toner conveying member 62B extends in the first direction. The first toner conveying member 62B extends from the second returned toner receiving port 617C to the second passage port 616D in the first direction. In the present embodiment, the first toner conveying member 62B is an auger screw. The first toner conveying member 62B is rotatable together with the first toner conveying member 62A. The first toner conveying member 62B is rotatable about the axis A85.

The second toner conveying member 62C is configured to convey toner in the second storage chamber 613 in the first direction. In more detail, the second toner conveying member 62C is configured to convey toner in the second section 6132 of the second storage chamber 613 in the first direction. The second toner conveying member 62C is configured to convey toner from the first passage port 616A toward the toner discharge port 617A. The second toner conveying member 62C extends in the first direction. The second toner conveying member 62C extends from the first passage port 616A to the toner discharge port 617A in the first direction. In the present embodiment, the second toner conveying member 62C is an auger screw. The second toner conveying member 62C is rotatable together with the first toner conveying members 62A and 62B. The second toner conveying member 62C is rotatable about the axis A85.

The second toner conveying member 62D is configured to convey toner in the second storage chamber 613 in the first direction. In more detail, the second toner conveying member 62D is configured to convey toner in the second section 6132 of the second storage chamber 613 in the first direction. The second toner conveying member 62D is configured to convey toner from the first passage port 616B toward the toner discharge port 617A. The second toner conveying member 62D extends in the first direction. The second toner conveying member 62D extends from the first passage port 616B to the toner discharge port 617A in the first direction. In the present embodiment, the second toner conveying member 62D is an auger screw. The second toner conveying member 62D is rotatable together with the first toner conveying members 62A, 62B and second toner conveying member 62C. The second toner conveying member 62D is rotatable about the axis A85.

<13.3.3 Toner Conveying Member 63>

The toner conveying member 63 is positioned inside the first storage chamber 612. The toner conveying member 63 includes two third toner conveying members 63A, 63B and two fourth toner conveying members 63C, 63D. In other words, the toner container 90Y includes the two third toner conveying members 63A, 63B and the two fourth toner conveying members 63C, 63D.

The third toner conveying member 63A is configured to convey toner in the first storage chamber 612 in the first direction. In more detail, the third toner conveying member 63A is configured to convey toner in the second section 6122 in the first direction. The third toner conveying member 63A is configured to convey toner toward the first passage port 616A. In more detail, the third toner conveying member 63A is configured to convey toner toward the first passage port 616A positioned at one end side in the first direction of the second section 6122 from the other end side in the first direction of the second section 6122. The third toner conveying member 63A extends in the first direction. In the present embodiment, the third toner conveying member 63A is an auger screw. The third toner conveying member 63A is rotatable about an axis A86. The axis A86 extends in the first direction.

The third toner conveying member 63B is configured to convey toner in the first storage chamber 612 in the first direction. In more detail, the third toner conveying member 63B is configured to convey toner in the third section 6123 in the first direction. The third toner conveying member 63B is configured to convey toner toward the first passage port 616B. In more detail, the third toner conveying member 63B is configured to convey toner from one end side in the first direction of the third section 6123 toward the first passage port 616B positioned at the other end side in the first direction of the third section 6123. The third toner conveying member 63B extends in the first direction. In the present embodiment, the third toner conveying member 63B is an auger screw. The third toner conveying member 63B is rotatable together with the third toner conveying member 63A. The third toner conveying member 63B is rotatable about the axis A86.

The fourth toner conveying member 63C is configured to convey toner in the first storage chamber 612 in the first direction. In more detail, the fourth toner conveying member 63C is configured to convey toner in the first section 6121 in the first direction. The fourth toner conveying member 63C is configured to convey toner from the second passage port 616C positioned at one end side in the first direction of the first section 6121 toward the other end side in the first direction of the first section 6121. The fourth toner conveying member 63C extends in the first direction. In the present embodiment, the fourth toner conveying member 63C is an auger screw. The fourth toner conveying member 63C is rotatable together with the third toner conveying members 63A and 63B. The fourth toner conveying member 63C is rotatable about the axis A86.

The fourth toner conveying member 63D is configured to convey toner in the first storage chamber 612 in the first direction. In more detail, the fourth toner conveying member 63D is configured to convey toner in the fourth section 6124 in the first direction. The fourth toner conveying member 63D is configured to convey toner toward one end side in the first direction of the fourth section 6124 from the second passage port 616D positioned at the other end side in the first direction of the fourth section 6124. The fourth toner conveying member 63D extends in the first direction. In the present embodiment, the fourth toner conveying member 63D is an auger screw. The fourth toner conveying member 63D is rotatable together with the third toner conveying members 63A, 63B and fourth toner conveying member 63C. The fourth toner conveying member 63D is rotatable about the axis A86.

<13.3.4 Agitator 64>

As illustrated in FIG. 49, the agitator 64 is positioned inside the toner housing 61. In more detail, the agitator 64 is positioned inside the third storage chamber 614. The agitator 64 is configured to convey toner in the third storage chamber 614 toward the fourth storage chamber 615 while agitating the toner.

<13.3.5 Toner First Shutter 65A>

As illustrated in FIG. 50, the toner first shutter 65A is positioned at the center portion in the first direction of the second storage chamber 613. The toner first shutter 65A is positioned on the peripheral surface of the second storage chamber 613. The toner first shutter 65A is configured to open and close the toner discharge port 617A. In more detail, the toner first shutter 65A is movable between a closing position (see FIG. 49) and an opening position (see FIG. 58) along the peripheral surface of the second storage chamber 613. As illustrated in FIG. 49, in a state where the toner first shutter 65A is at the closing position, the toner first shutter 65A closes the toner discharge port 617A. In a state where the toner first shutter 65A is at the opening position (see FIG. 58), the toner first shutter 65A opens the toner discharge port 617A, i.e., the toner discharge port 617A is open. The toner first shutter 65A includes two projections 651A and 651B.

The projection 651A is positioned on the peripheral surface of the toner first shutter 65A. The projection 651A extends from the peripheral surface of the toner first shutter 65A. The projection 651A may be assembled to the peripheral surface of the toner first shutter 65A. The projection 651A is positioned at one end portion in the first direction of the toner first shutter 65A. As illustrated in FIG. 57, the projection 651A is fitted into the hole 5312A (see FIG. 43) of the drum cartridge 89Y during attachment of the toner container 90Y to the drum cartridge 89Y.

As illustrated in FIG. 50, the projection 651B is positioned on the peripheral surface of the toner first shutter 65A. The projection 651B extends from the peripheral surface of the toner first shutter 65A. The projection 651B may be assembled to the peripheral surface of the toner first shutter 65A. The projection 651B is positioned at the other end portion in the first direction of the toner first shutter 65A. The projection 651B is fitted into the hole 5312B (see FIG. 43) of the drum cartridge 89Y during attachment of the toner container 90Y to the drum cartridge 89Y.

The projections 651A and 651B are fitted respectively into the holes 5312A and 5312B of the drum cartridge 89Y during attachment of the toner container 90Y to the drum cartridge 89Y, whereby the toner first shutter 65A is fixed to the drum cartridge 89Y.

<13.3.6 Toner Second Shutter 65B>

The toner second shutter 65B is positioned between the toner side plate 611A and the toner discharge port 617A. The toner second shutter 65B is positioned separated from the toner discharge port 617A in the first direction. The toner second shutter 65B is positioned on the peripheral surface of the second storage chamber 613. The toner second shutter 65B is configured to open and close the returned toner receiving port 617B. In more detail, like the toner first shutter 65A, the toner second shutter 65B is movable between a closing position and an opening position along the peripheral surface of the second storage chamber 613. In a state where the toner second shutter 65B is at the closing position, the toner second shutter 65B closes the returned toner receiving port 617B. In a state where the toner second shutter 65B is at the opening position, the toner second shutter 65B opens the returned toner receiving port 617B, i.e., the returned toner receiving port 617B is open. The toner second shutter 65B includes two projections 652A and 652B.

The projection 652A is positioned on the peripheral surface of the toner second shutter 65B. The projection 652A extends from the peripheral surface of the toner second shutter 65B. The projection 652A may be assembled to the peripheral surface of the toner second shutter 65B. The projection 652A is positioned at one end portion in the first direction of the toner second shutter 65B. As illustrated in FIG. 57, during attachment of the toner container 90Y to the drum cartridge 89Y, the projection 652A is fitted into the hole 5312C (see FIG. 43) of the drum cartridge 89Y.

As illustrated in FIG. 50, the projection 652B is positioned on the peripheral surface of the toner second shutter 65B. The projection 652B extends from the peripheral surface of the toner second shutter 65B. The projection 652B may be assembled to the peripheral surface of the toner second shutter 65B. The projection 652B is positioned at the other end portion in the first direction of the toner second shutter 65B. During attachment of the toner container 90Y to the drum cartridge 89Y, the projection 652B is fitted into the hole 5312D (see FIG. 43) of the drum cartridge 89Y.

The projections 652A and 652B are fitted respectively into the holes 5312C and 5312D of the drum cartridge 89Y during attachment of the toner container 90Y to the drum cartridge 89Y, whereby the toner second shutter 65B is fixed to the drum cartridge 89Y.

<13.3.7 Toner Third Shutter 65C>

The toner third shutter 65C is positioned between the toner side plate 611B and the toner discharge port 617A. The toner third shutter 65C is positioned separated from the toner discharge port 617A in the first direction. The toner third shutter 65C is positioned on the peripheral surface of the second storage chamber 613. The toner third shutter 65C is configured to open and close the second returned toner receiving port 617C. In more detail, like the toner first shutter 65A and toner second shutter 65B, the toner third shutter 65C is movable between a closing position and an opening position along the peripheral surface of the second storage chamber 613. As illustrated in FIG. 54, in a state where the toner third shutter 65C is at the closing position, the toner third shutter 65C closes the second returned toner receiving port 617C. In a state where the toner third shutter 65C is at the opening position, the toner third shutter 65C opens the second returned toner receiving port 617C, i.e., the second returned toner receiving port 617C is open. The toner third shutter 65C includes two projections 653A and 653B.

As illustrated in FIG. 50, the projection 653A is positioned on the peripheral surface of the toner third shutter 65C. The projection 653A extends from the peripheral surface of the toner third shutter 65C. The projection 653A may be assembled to the peripheral surface of the toner third shutter 65C. The projection 653A is positioned at one end portion in the first direction of the toner third shutter 65C. As illustrated in FIG. 57, during attachment of the toner container 90Y to the drum cartridge 89Y, the projection 653A is fitted into the hole 5312E (see FIG. 43) of the drum cartridge 89Y.

As illustrated in FIG. 50, the projection 653B is positioned on the peripheral surface of the toner third shutter 65C. The projection 653B extends from the peripheral surface of the toner third shutter 65C. The projection 653B may be assembled to the peripheral surface of the toner third shutter 65C. The projection 653B is positioned at the other end portion in the first direction of the toner third shutter 65C. During attachment of the toner container 90Y to the drum cartridge 89Y, the projection 653B is fitted into the hole 5312F (see FIG. 43) of the drum cartridge 89Y.

The projections 653A and 653B are fitted respectively into the holes 5312E and 5312F of the drum cartridge 89Y during attachment of the toner container 90Y to the drum cartridge 89Y, whereby the toner third shutter 65C is fixed to the drum cartridge 89Y.

<13.3.8 Projections 66A, 66B>

The projection 66A is positioned on an outer surface S81 of the toner housing 61. The outer surface S81 is an outer surface positioned on one side in the first direction of the toner housing 61. The projection 66A protrudes from the outer surface S81. The projection 66A may be assembled to the outer surface S81. During attachment of the toner container 90Y to the drum cartridge 89Y, the projection 66A is fitted into the guide 5315A (see FIG. 43) of the drum cartridge 89Y.

The projection 66B is positioned on an outer surface S82 of the toner housing 61. The outer surface S82 is an outer surface positioned on the other side in the first direction of the toner housing 61. The projection 66B protrudes from the outer surface S82. The projection 66B may be assembled to the outer surface S82. During attachment of the toner container 90Y to the drum cartridge 89Y, the projection 66B is fitted into the guide 5315B (see FIG. 43) of the drum cartridge 89Y.

<13.3.9 Projections 67A, 67B>

As illustrated in FIG. 51, the projection 67A is positioned on the peripheral surface of the second storage chamber 613. The projection 67A is positioned at the one end portion in the first direction of the second storage chamber 613. The projection 67A extends from the peripheral surface of the second storage chamber 613. The projection 67A may be assembled to the peripheral surface of the second storage chamber 613. During attachment of the toner container 90Y to the drum cartridge 89Y, the projection 67A is fitted to the hole 535F of the developing shutter 535.

As illustrated in FIG. 49, the projection 67B is positioned on the peripheral surface of the second storage chamber 613. The projection 67B is positioned at the other end portion in the first direction of the second storage chamber 613. The projection 67B extends from the peripheral surface of the second storage chamber 613. The projection 67B may be assembled to the peripheral surface of the second storage chamber 613. During attachment of the toner container 90Y to the drum cartridge 89Y, the projection 67B is fitted to the hole 535G of the developing shutter 535.

<13.4. Attachment of Toner Container 90Y to Drum Cartridge 89Y>

Next, attachment of the toner container 90Y to the drum cartridge 89Y will be described with reference to FIGS. 41, 43, 49 to 51, 54, 57, and 58.

In a state where the toner container 90Y is detached from the drum cartridge 89Y, the developing shutter 535 is positioned at its closing position (see FIG. 41), the toner first shutter 65A is positioned at its closing position (see FIG. 49), the toner second shutter 65B is positioned at its closing position, and the toner third shutter 65C is positioned at its closing position (see FIG. 54).

When attaching the toner container 90Y to the drum cartridge 89Y, a user positions the second storage chamber 613 to the developing housing 531 as illustrated in FIG. 57.

In more detail, the user fits the projections 66A and 66B (see FIG. 50) of the toner container 90Y respectively into the guides 5315A and 5315B (see FIG. 43) of the cartridge 85Y. Then, the user mounts the toner container 90Y onto the drum cartridge 89Y along the guides 5315A and 5315B such that the second storage chamber 613 is mounted first.

As a result, the projection 651A (see FIG. 50) of the toner first shutter 65A is fitted into the hole 5312A (see FIG. 43) of the developing housing 531, the projection 651B (see FIG. 50) of the toner first shutter 65A is fitted into the hole 5312B (see FIG. 43) of the developing housing 531, the projection 652A (see FIG. 50) of the toner second shutter 65B is fitted into the hole 5312C (see FIG. 43) of the developing housing 531, the projection 652B (see FIG. 50) of the toner second shutter 65B is fitted into the hole 5312D (see FIG. 43) of the developing housing 531, the projection 653A (see FIG. 50) of the toner third shutter 65C is fitted into the hole 5312E (see FIG. 43) of the developing housing 531, the projection 653B (see FIG. 50) of the toner third shutter 65C is fitted into the hole 5312F (see FIG. 43) of the developing housing 531, the projection 67A (see FIG. 51) of the toner container 90Y is fitted into the hole 535F (see FIG. 43) of the developing shutter 535, and the projection 67B (see FIG. 49) of the toner container 90Y is fitted into the hole 535G (see FIG. 43) of the developing shutter 535.

Hence, the toner first shutter 65A, toner second shutter 65B, and toner third shutter 65C are fixed to the developing housing 531, whereby the second storage chamber 613 is positioned to the developing housing 531.

Then, as illustrated in FIGS. 57 and 58, the user pivotally moves the toner housing 61 about the second storage chamber 613. Specifically, the user pivotally moves the toner housing 61 in such a direction that the first storage chamber 612 and third storage chamber 614 approach the bottom plate 5314.

As a result, the developing shutter 535 is pushed by the projections 67A (see FIGS. 51) and 67B (see FIG. 49) of the toner container 90Y to move from the closing position to the opening position. Further, since the toner housing 61 is pivotally moved in such a direction that the first storage chamber 612 and third storage chamber 614 approach the bottom plate 5314 in a state where the toner first shutter 65A, toner second shutter 65B, and toner third shutter 65C are fixed to the developing housing 531, the toner first shutter 65A moves from its closing position to its opening position relative to the toner housing 61, the toner second shutter 65B moves from its closing position to its opening position relative to the toner housing 61, and the toner third shutter 65C moves from its closing position to its opening position relative to the toner housing

Then, as illustrated in FIG. 58, attachment of the toner container 90Y to the drum cartridge 89Y is completed in a state where the developing shutter 535 is at its opening position, the toner first shutter 65A is at its opening position, the toner second shutter 65B is at its opening position, and the toner third shutter 65C is at its opening position.

When the user pivotally moves the toner housing 61 in such a direction that the first storage chamber 612 and third storage chamber 614 are separated from the bottom plate 5314 from a state where the toner container 90Y is attached to the drum cartridge 89Y, the developing shutter 535 is pushed by the projection 67A (see FIG. 51) and projection 67B (see FIG. 49) of the toner container 90Y to move from its opening position to its closing position. Further, since the toner housing 61 is pivotally moved in such a direction that the first storage chamber 612 and third storage chamber 614 are separated from the bottom plate 5314 in a state where the toner first shutter 65A, toner second shutter 65B, and toner third shutter 65C are fixed to the developing housing 531, the toner first shutter 65A moves from its opening position to its closing position relative to the toner housing 61, the toner second shutter 65B moves from its opening position to its closing position relative to the toner housing 61, and the toner third shutter 65C moves from its opening position to its closing position relative to the toner housing 61.

<13.5. Functions and Effects>

Here, in a conventional drum cartridge including a toner cartridge and a developing device, when the amount of toner supplied from the toner cartridge to the developing device is excessively larger than the amount of toner supplied from the developing device to a photosensitive drum, a certain amount of toner may stagnate or staying in the developing device. The toner stagnating in the developing device is deteriorated while being repetitively charged, with the result that the chargeability of the toner tends to decrease. Hence, when the amount of deteriorated toner increases in the developing device, image quality may be degraded.

However, the cartridge 85Y according to the eighth embodiment can suppress toner from stagnating or staying in the developing device 53Y.

(1) According to the cartridge 85Y, as illustrated in FIG. 44, toner in the developing housing 531 can be returned smoothly to the toner container 90Y through the toner return port 531B and returned toner receiving port 617B.

This allows toner to be circulated between the developing housing 531 and the toner container 90Y.

Hence, toner can be suppressed from stagnating or staying in the developing housing 531.

(2) According to the cartridge 85Y, as illustrated in FIG. 50, the first toner conveying member 62A conveys toner in the second storage chamber 613 from the returned toner receiving port 617B toward the second passage port 616C.

Hence, the returned toner that has been introduced into the toner container 90Y through the returned toner receiving port 617B can be suppressed from being accumulated around the returned toner receiving port 617B. Accordingly, the returned toner from the developing device 53Y can be returned smoothly to the toner container 90Y through the returned toner receiving port 617B.

(3) According to the cartridge 85Y, as illustrated in FIG. 44, the first developing conveying member 533 conveys toner in the first developing chamber 530A toward the developing passage port 530D. The second developing conveying member 534 conveys toner in the second developing chamber 530B toward the toner return port 531B.

Hence, in the developing device 53Y, toner can be conveyed smoothly toward the toner return port 531B. Accordingly, toner deteriorated in the first developing chamber 530A of the developing device 53Y can be returned from the toner return port 531B to the toner container 90Y through the second developing chamber 530B and can be mixed with unused toner in the toner container 90Y. As a result, image quality degradation due to the progress of toner deterioration in the developing device 53Y can be suppressed.

(4) According to the cartridge 85Y, as illustrated in FIG. 42, the toner pipe 56 is connected to the developing housing 531.

With the above configuration, the collected toner from the photosensitive drum 51Y can be returned to the developing housing 531 through the collected toner receiving port 531D, mixed with unused toner, and supplied once again to the photosensitive drum 51Y.

### 6. Modification of Eighth Embodiment

As illustrated in FIG. 59, the image forming apparatus 81 may include exposing heads 86Y, 86M, 86C, and 86K in place of the exposing device 86. Further, the image forming apparatus 81 may not necessarily include the drawer 84.

The image forming apparatus 81 according to this modification includes a main body housing 82A in place of the main body housing 82. The main body housing 82A includes a cover 822A and has an opening 821A. The opening 821A is positioned at the upper end portion of the main body housing 82A.

The cover 822A is movable between a closing position (see FIG. 59) and an opening position (see FIG. 60). As illustrated in FIG. 59, in a state where the cover 822A is at the closing position, the cover 822A closes the opening 821A. As illustrated in FIG. 60, in a state where the cover 822A is at the opening position, the cover 822A opens the opening 821A, i.e., the opening 821A is open. The cartridges 85Y, 85M, 85C, and 85K can be replaced through the opening 821A of the main body housing 82A in a state where the cover 822A is at the opening position.

The exposing heads 86Y, 86M, 86C, and 86K are assembled to the cover 822A. The exposing head 86Y exposes the peripheral surface of the photosensitive drum 51Y. The exposing head 86M exposes the peripheral surface of the photosensitive drum 51M. The exposing head 86C exposes the peripheral surface of the photosensitive drum 51C. The exposing head 86K exposes the peripheral surface of the photosensitive drum 51K.

In this modification as well, the same functions and effects as achieved in the above embodiment can be obtained.

The present disclosure includes the following aspects.

(Aspect 1) According to aspect 1, the present disclosure provides a cartridge attachable to and detachable from an image forming apparatus. The cartridge includes a photosensitive drum, a toner container, a developing device, a drum cleaner, and a toner pipe. The photosensitive drum is rotatable about a first axis extending in a first direction. The toner container is configured to store toner therein. The developing device configured to supply toner stored in the toner container to the photosensitive drum. The developing device includes a developing housing and a developing roller. The developing housing is configured to store therein toner supplied from the toner container. The developing roller is supported by the developing housing so as to be rotatable about a developing axis. The developing axis is positioned further downward than the first axis in a state where the cartridge is attached to the image forming apparatus. The drum cleaner is configured to clean a peripheral surface of the photosensitive drum. The drum cleaner is positioned further upward than the photosensitive drum in a state where the cartridge is attached to the image forming apparatus. The toner pipe connected to the developing housing. The toner pipe allows collected toner to pass therethrough. The collected toner is toner that has been removed from the peripheral surface of the photosensitive drum by the drum cleaner. The toner container has a toner discharge port and a returned toner receiving port. The toner discharge port is a port for discharging toner stored in the toner container. The returned toner receiving port is a port for receiving returned toner. The returned toner is toner that is returned from the developing device to the toner container. The developing housing has a toner receiving port, a collected toner receiving port, a toner return port. The toner receiving port is a port for receiving toner discharged from the toner discharge port. The collected toner receiving port is a port for receiving the collected toner from the toner pipe. The toner return port is a port for returning toner to the returned toner receiving port. The toner pipe has one end portion connected to the drum cleaner and another end portion connected to the developing housing. The another end portion of the toner pipe is positioned further downward than the one end portion of the toner pipe in a state where the cartridge is attached to the image forming apparatus.

(Aspect 2) In the cartridge according to aspect 1, the another end portion of the toner pipe is inserted in the collected toner receiving port from above.

(Aspect 3) The cartridge according to aspect 2, further includes a seal member. The seal member seals a portion between an outer peripheral surface of the toner pipe and an inner peripheral surface of the collected toner receiving port.

(Aspect 4) The cartridge according to any one of aspects 1 to 3, further includes a drum first side plate and a drum second side plate. The drum first side plate supports one end portion in the first direction of the photosensitive drum. The drum second side plate supports another end portion in the first direction of the photosensitive drum. The toner pipe is positioned between the drum first side plate and the drum second side plate in the first direction.

(Aspect 5) The cartridge according to any one of aspects 1 to 4, further includes a charging roller. The charging roller is configured to charge the peripheral surface of the photosensitive drum. The charging roller includes a shaft and a roller body. The roller body is rotatable together with the shaft. In a state where the cartridge is attached to the image forming apparatus, the toner pipe passes through an area above the shaft and on one side in the first direction of the roller body to be connected to the developing device.

(Aspect 6) In the cartridge according to any one of aspects 1 to 5, the image forming apparatus includes an exposing device. The exposing device is configured to expose the peripheral surface of the photosensitive drum. In a state where the cartridge is attached to the image forming apparatus, light emitted from the exposing device passes through an area above the developing device and below the drum cartridge to enter the peripheral surface of the photosensitive drum.

(Aspect 7) In the cartridge according to any one of aspects 1 to 6, the developing device further includes a developing first conveying member. The developing first conveying member is configured to convey toner from the toner receiving port toward the toner return port.

(Aspect 8) In the cartridge according to any one of aspects 1 to 7, the toner container further includes a toner first conveying member. The toner first conveying member is configured to convey toner from the returned toner receiving port toward the toner discharge port.

(Aspect 9) In the cartridge according to any one of aspects 1 to 8, the developing device further includes a developing second conveying member. The developing second conveying member is configured to convey toner from the collected toner receiving port toward the toner return port.

(Aspect 10) In the cartridge according to any one of aspects 1 to 9, the collected toner receiving port and the toner return port are positioned at one end portion in the first direction of the developing housing.

(Aspect 11) In the cartridge according to any one of aspects 1 to 10, the collected toner receiving port is positioned outside a developable area in the first direction. The developable area is an area where the developing roller can supply toner to the photosensitive drum.

(Aspect 12) In the cartridge according to any one of aspects 1 to 11, the toner receiving port is positioned at a center portion in the first direction of the developing housing. The developing housing further has a second toner return port. The second toner return port is a port for returning toner to the toner container. The second toner return port is positioned at another end portion in the first direction of the developing housing.

(Aspect 13) In the cartridge according to aspect 12, the toner container further has a second returned toner receiving port. The second returned toner receiving port is a port for receiving toner that is returned from the second toner return port to the toner container.

(Aspect 14) In the cartridge according to aspect 13, the toner container further includes a toner second conveying member. The toner second conveying member is configured to convey toner from the second returned toner receiving port toward the toner discharge port.

(Aspect 15) In the cartridge according to any one of aspects 12 to 14, the developing device further includes a developing third conveying member. The developing third conveying member is configured to convey toner from the toner receiving port toward the second toner return port.

(Aspect 16) In the cartridge according to any one of aspects 1 to 15, the developing device further includes a developing first shutter and a developing second shutter. The developing first shutter is configured to open and close the toner receiving port. The developing second shutter is configured to open and close the toner return port.

(Aspect 17) In the cartridge according to any one of aspects 1 to 16, the toner container further includes a toner first shutter and a toner second shutter. The toner first shutter is configured to open and close the toner discharge port. The toner second shutter is configured to open and close the returned toner receiving port.

(Aspect 18) In the cartridge according to any one of aspects 1 to 17, the toner container can be replaced with respect to the cartridge.

(Aspect 19) The cartridge according to any one of aspects 1 to 18, further includes a collected toner conveying member. The collected toner conveying member is configured to convey toner in the toner pipe.

(Aspect 20) In the cartridge according to any one of aspects 1 to 19, the toner pipe passes through an area on one side in the first direction of the developing device.

(Aspect 21) The cartridge according to any one of aspects 1 to 20, further includes a drum first side plate and a drum second side plate. The drum first side plate supports one end portion in the first direction of the photosensitive drum. The drum second side plate supports another end portion in the first direction of the photosensitive drum. The developing device is supported by the drum first side plate and the drum second side plate so as to be movable relative to the photosensitive drum.

(Aspect 22) According to aspect 22, the present disclosure provides a drum cartridge attachable to and detachable from an image forming apparatus. The drum cartridge includes a photosensitive drum, a developing housing, a developing roller, a drum cleaner, and a toner pipe. The photosensitive drum is rotatable about a first axis extending in a first direction. The developing housing is configured to store therein toner supplied from a toner container. The toner container is attachable to and detachable from the drum cartridge. The developing roller is supported by the developing housing so as to be rotatable about a developing axis. The developing axis is positioned further downward than the first axis in a state where the drum cartridge is attached to the image forming apparatus. The drum cleaner is configured to clean a peripheral surface of the photosensitive drum. The drum cleaner is positioned further upward than the photosensitive drum in a state where the drum cartridge is attached to the image forming apparatus. The toner pipe is connected to the developing housing. The toner pipe allows collected toner to pass therethrough. The collected toner is toner that has been removed from the peripheral surface of the photosensitive drum by the drum cleaner. The developing housing has a toner receiving port, a collected toner receiving port, and a toner return port. The toner receiving port is a port for receiving toner discharged from a toner discharge port of the toner container in a state where the toner container is attached to the drum cartridge. The collected toner receiving port is a port for receiving the collected toner from the toner pipe. The toner return port is a port for returning toner to a returned toner receiving port of the toner container in a state where the toner container is attached to the drum cartridge. The toner pipe has one end portion connected to the drum cleaner and another end portion connected to the developing housing. The another end portion of the toner pipe is positioned further downward than the one end portion of the toner pipe in a state where the drum cartridge is attached to the image forming apparatus.

(Aspect 23) According to aspect 23, the present disclosure provides a cartridge attachable to and detachable from an image forming apparatus. The cartridge includes a photosensitive drum, a toner container, and a developing device. The photosensitive drum is rotatable about a first axis extending in a first direction. The toner container is configured to store toner therein. The developing device is configured to supply toner stored in the toner container to the photosensitive drum. The developing device includes a developing housing and a developing roller. The developing housing is configured to store therein toner supplied from the toner container. The developing roller is rotatably supported by the developing housing. The toner container includes a first storage chamber and a second storage chamber. The second storage chamber is communicated with the first storage chamber. The second storage chamber is positioned further downward than the first storage chamber in a state where the cartridge is attached to the image forming apparatus. The toner container has a toner discharge port and a returned toner receiving port. The toner discharge port is a port for discharging toner stored in the toner container. The returned toner receiving port is a port for receiving returned toner. The returned toner is toner that is returned from the developing device to the toner container. The returned toner receiving port is communicated with the second storage chamber. The developing housing further includes a first developing chamber and a second developing chamber. The first developing chamber accommodates therein a part of the developing roller. The first developing chamber is positioned further downward than the toner container in a state where the cartridge is attached to the image forming apparatus. The second developing chamber is communicated with the first developing chamber. The second developing chamber is positioned further upward than the first developing chamber in a state where the cartridge is attached to the image forming apparatus. The developing housing has a toner receiving port and a toner return port. The toner receiving port is a port for receiving toner discharged from the toner discharge port. The toner return port is a port for returning toner to the returned toner receiving port. The toner return port is communicated with the second developing chamber. In a state where the cartridge is attached to the image forming apparatus, at least a part of the second developing chamber is aligned with the second storage chamber in a horizontal direction.

(Aspect 24) In the cartridge according to aspect 23, the toner receiving port is communicated with the first developing chamber.

(Aspect 25) In the cartridge according to aspect 23 or 24, the toner discharge port is communicated with the second storage chamber.

(Aspect 26) In the cartridge according to any one of aspects 23 to 25, the toner container further includes a first toner conveying member and a toner partition wall. The first toner conveying member is configured to convey toner in the second storage chamber from the returned toner receiving port toward the second passage port. The toner partition wall separates the first storage chamber and the second storage chamber from each other. The toner partition wall has a first passage port and a second passage port. The first passage port allows toner to pass therethrough from the first storage chamber to the second storage chamber. The second passage port allows toner to pass therethrough from the second storage chamber to the first storage chamber.

(Aspect 27) In the cartridge according to aspect 26, the toner container further includes a second toner conveying member. The second toner conveying member is configured to convey toner in the second storage chamber from the first passage port toward the toner discharge port.

(Aspect 28) In the cartridge according to aspect 27, the toner container further includes a third toner conveying member. The third toner conveying member is configured to convey toner in the first storage chamber toward the first passage port.

(Aspect 29) In the cartridge according to any one of aspects 23 to 28, the toner container further includes a third storage chamber. The third storage chamber has a capacity that is larger than both a capacity of the first storage chamber and a capacity of the second storage chamber. The third storage chamber is positioned further upward than the first storage chamber in a state where the cartridge is attached to the image forming apparatus.

(Aspect 30) In the cartridge according to any one of aspects 23 to 29, the developing device further includes a developing partition wall, a first developing conveying member, and a second developing conveying member. The developing partition wall separates the first developing chamber and the second developing chamber from each other. The developing partition wall has a developing passage port. The developing passage port allows toner to pass therethrough from the first developing chamber to the second developing chamber. The first developing conveying member is configured to convey toner in the first developing chamber toward the developing passage port. The second developing conveying member is configured to convey toner in the second developing chamber toward the toner return port.

(Aspect 31) The cartridge according to any one of aspects 23 to 30, further includes a drum cleaner and a toner pipe. The drum cleaner is configured to clean a peripheral surface of the photosensitive drum. The toner pipe is connected to the developing housing. The toner pipe allows collected toner to pass therethrough. The collected toner is toner that has been removed from the peripheral surface of the photosensitive drum by the drum cleaner. The developing housing further has a collected toner receiving port. The collected toner receiving port is a port for receiving the collected toner from the toner pipe.

(Aspect 32) The cartridge according to aspect 31, further includes a collected toner conveying member. The collected toner conveying member is configured to convey toner in the toner pipe.

(Aspect 33) The cartridge according to aspect 31 or 32, further includes a seal member. The seal member seals a portion between the toner pipe and the developing housing.

(Aspect 34) In the cartridge according to any one of aspects 23 to 33, the developing device further includes a developing first shutter and a developing second shutter. The developing first shutter is configured to open and close the toner receiving port. The developing second shutter is configured to open and close the toner return port.

(Aspect 35) In the cartridge according to any one of aspects 23 to 34, the toner container further includes a toner first shutter and a toner second shutter. The toner first shutter is configured to open and close the toner discharge port. The toner second shutter is configured to open and close the returned toner receiving port.

(Aspect 36) In the cartridge according to any one of aspects 23 to 35, the toner container is attachable to and detachable from the cartridge.

(Aspect 37) In the cartridge according to any one of aspects 23 to 36, the developing device is movable relative to the photosensitive drum.

(Aspect 38) According to aspect 38, the present disclosure provides a drum cartridge attachable to and detachable from an image forming apparatus. The drum cartridge includes a photosensitive drum and a developing device. The photosensitive drum is rotatable about a first axis extending in a first direction. The developing device is configured to supply toner stored in a toner container to the photosensitive drum. The toner container is attachable to and detachable from the drum cartridge. The developing device includes a developing housing and a developing roller. The developing housing is configured to store therein toner supplied from the toner container. The developing roller is rotatably supported by the developing housing. The toner container includes a first storage chamber and a second storage chamber. The second storage chamber is communicated with the first storage chamber. he second storage chamber is positioned further downward than the first storage chamber in a state where the drum cartridge having the toner container attached thereto is attached to the image forming apparatus. The toner container has a toner discharge port and a returned toner receiving port. The toner discharge port is a port for discharging toner stored in the toner container. The returned toner receiving port is a port for receiving returned toner. The returned toner is toner that is returned from the developing device to the toner container. The returned toner receiving port is communicated with the second storage chamber. The developing housing further includes a first developing chamber and a second developing chamber. The first developing chamber accommodates therein a part of the developing roller. The first developing chamber is positioned further downward than the toner container in a state where the drum cartridge having the toner container attached thereto is attached to the image forming apparatus. The second developing chamber is communicated with the first developing chamber. The second developing chamber is positioned further upward than the first developing chamber in a state where the drum cartridge having the toner container attached thereto is attached to the image forming apparatus. The developing housing has a toner receiving port and a toner return port. The toner receiving port is a port for receiving toner discharged from the toner discharge port. The toner return port is a port for returning toner to the returned toner receiving port. The toner return port is communicated with the second developing chamber. In a state where the drum cartridge having the toner container attached thereto is attached to the image forming apparatus, at least a part of the second developing chamber is aligned with the second storage chamber in a horizontal direction.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents.

What is claimed is:

1. A cartridge attachable to and detachable from an image forming apparatus, the cartridge comprising:
a photosensitive drum rotatable about a first axis extending in a first direction;
a drum cleaner configured to clean the photosensitive drum;
a toner pipe for conveying collected toner, the collected toner being toner that has been removed from the photosensitive drum by the drum cleaner;
a toner container configured to store therein toner including the collected toner conveyed by the toner pipe; and
a developing device configured to supply toner stored in the toner container to the photosensitive drum, the developing device comprising:
a developing housing configured to store therein toner supplied from the toner container and the collected toner conveyed by the toner pipe; and
a developing roller rotatably supported by the developing housing,
wherein the toner container has:
a toner discharge port for discharging toner stored in the toner container; and
a returned toner receiving port for receiving returned toner, the returned toner being toner that is returned from the developing device to the toner container, and
wherein the developing housing has:
a toner receiving port for receiving toner discharged from the toner discharge port; and
a toner return port for returning toner to the toner container.

2. The cartridge according to claim 1,
wherein the toner pipe is connected to the developing housing, and
wherein the developing housing further has a collected toner receiving port for receiving the collected toner from the toner pipe.

3. The cartridge according to claim 2,
wherein the developing device further comprises:
a developing first conveying member configured to convey toner from the toner receiving port toward the toner return port; and
a developing second conveying member configured to convey toner from the collected toner receiving port toward the toner return port, and
wherein the toner container further comprises:
a toner first conveying member configured to convey toner from the returned toner receiving port toward the toner discharge port.

4. The cartridge according to claim 3,
wherein the developing first conveying member extends in the first direction, the developing first conveying member being configured to convey toner in the first direction, the developing first conveying member having an upstream end and a downstream end in a conveying direction from the toner receiving port toward the toner return port,
wherein the toner return port overlaps the downstream end of the developing first conveying member as viewed in a direction that is orthogonal to the first direction and is directed from the toner return port toward the developing first conveying member, and
wherein the toner receiving port overlaps the upstream end of the developing first conveying member as viewed in a direction that is orthogonal to the first direction and is directed from the toner receiving port toward the developing first conveying member.

5. The cartridge according to claim 2,
wherein the collected toner receiving port is positioned further upward than the toner return port in a state where the cartridge is attached to the image forming apparatus.

6. The cartridge according to claim 2,
wherein the collected toner receiving port and the toner return port are positioned at one end portion in the first direction of the developing housing, and
wherein the collected toner receiving port and the toner return port are positioned outside a developable area, the developable area being an area where the developing roller can supply toner to the photosensitive drum.

7. The cartridge according to claim 2,
wherein at least a part of the collected toner receiving port overlaps the toner return port as viewed in a direction that is orthogonal to the first direction and is directed from the collected toner receiving port toward the toner return port.

8. The cartridge according to claim 6,
wherein the toner receiving port is positioned at a center portion in the first direction of the developing housing, and
wherein the developing housing further has:
a second toner return port for returning toner to the toner container, the second toner return port being positioned at another end portion in the first direction of the developing housing.

9. The cartridge according to claim 8,
wherein the toner container further has:
a second returned toner receiving port for receiving toner that is returned from the second toner return port to the toner container.

10. The cartridge according to claim 9,
wherein the toner container further comprises:
a toner second conveying member configured to convey toner from the second returned toner receiving port toward the toner discharge port, and
wherein the developing device further comprises:
a developing third conveying member configured to convey toner from the toner receiving port toward the second toner return port.

11. The cartridge according to claim 2,
wherein the collected toner receiving port is positioned at one end portion in the first direction of the developing housing,
wherein the toner return port is positioned at another end portion in the first direction of the developing housing, and
wherein the toner receiving port is positioned at the one end portion in the first direction of the developing housing.

12. The cartridge according to claim 2,
wherein the collected toner receiving port is positioned at a center portion in the first direction of the developing housing,
wherein the toner return port is positioned at one end portion in the first direction of the developing housing, and
wherein the developing housing further has a second toner return port for returning toner to the toner container, the second toner return port being positioned at another end portion in the first direction of the developing housing.

13. The cartridge according to claim 12,
wherein the toner container further has:
a second returned toner receiving port for receiving toner that is returned from the second toner return port to the toner container, and
wherein the toner container further comprises:
a toner second conveying member configured to convey toner from the second returned toner receiving port to the toner discharge port.

14. The cartridge according to claim 2,
wherein the developing device further comprises:
a partition wall partitioning an inner space of the developing housing into a first developing chamber and a second developing chamber, the first developing chamber accommodating therein a part of the developing roller, the second developing chamber being communicated with the toner receiving port, the collected toner receiving port, and the toner return port;
a first conveying member positioned inside the first developing chamber; and
a second conveying member positioned inside the second developing chamber.

15. The cartridge according to claim 1,
wherein the developing device further comprises:
a developing first shutter configured to open and close the toner receiving port; and
a developing second shutter configured to open and close the toner return port, and
wherein the toner container further comprises:
a toner first shutter configured to open and close the toner discharge port; and
a toner second shutter configured to open and close the returned toner receiving port.

16. The cartridge according to claim 1,
wherein the toner container can be replaced with respect to the cartridge.

17. The cartridge according to claim 1, further comprising:
a drum frame supporting the photosensitive drum,
wherein the toner pipe is fixed to the drum frame, and
wherein the developing device is supported by the drum frame so as to be movable relative to the photosensitive drum.

18. The cartridge according to claim 17, further comprising:
a seal member positioned around the collected toner receiving port, the seal member sealing a portion between the toner pipe and the developing device.

19. A cartridge attachable to and detachable from an image forming apparatus, the cartridge comprising:
a photosensitive drum rotatable about a first axis extending in a first direction;
a drum cleaner configured to clean the photosensitive drum;
a toner pipe for conveying collected toner, the collected toner being toner that has been removed from the photosensitive drum by the drum cleaner;
a toner container configured to store therein toner including the collected toner conveyed by the toner pipe; and
a developing device configured to supply toner stored in the toner container to the photosensitive drum, the developing device comprising:
a developing housing configured to store therein toner supplied from the toner container and the collected toner conveyed by the toner pipe; and
a developing roller rotatably supported by the developing housing,
wherein the toner container has:
a toner passage port for discharging toner stored in the toner container and for receiving returned toner, the returned toner being toner that is returned from the developing device to the toner container, and
wherein the developing housing has:
a developing passage port for receiving toner discharged from the toner passage port and for returning toner to the toner passage port.

20. The cartridge according to claim 19,
wherein the toner pipe is connected to the developing housing, and
wherein the developing housing further has a collected toner receiving port for receiving the collected toner from the toner pipe.

21. The cartridge according to claim 20,
wherein the collected toner receiving port is positioned further upward than the developing passage port in a state where the cartridge is attached to the image forming apparatus.

22. The cartridge according to claim 19,
wherein the developing device further comprises:
a first conveying member configured to convey toner stored in the developing device in a direction separating from the developing passage port in the first direction; and
a second conveying member configured to convey toner stored in the developing device in a direction approaching the developing passage port in the first direction.

23. The cartridge according to claim 22,
wherein the developing device further comprises a partition wall positioned between the first conveying member and the second conveying member, the partition wall partitioning an inner space of the developing housing into a first developing chamber and a second developing chamber, the first developing chamber accommodating therein a part of the developing roller, the second developing chamber being communicated with the collected toner receiving port,
wherein the first conveying member is positioned inside the first developing chamber, and
wherein the second conveying member is positioned inside the second developing chamber.

24. The cartridge according to claim 23,
wherein the first conveying member and the second conveying member are aligned in a second direction orthogonal to the first direction, and
wherein the partition wall is positioned between one end in the second direction of the developing passage port and another end in the second direction of the developing passage port.

25. The cartridge according to claim 19,
wherein the developing device further comprises a first shutter configured to open and close the developing passage port, and
wherein the toner container further comprises a second shutter configured to open and close the toner passage port.

26. The cartridge according to claim 19,
wherein the toner container can be replaced with respect to the cartridge.

27. The cartridge according to claim 20, further comprising:
a drum frame supporting the photosensitive drum,
wherein the toner pipe is fixed to the drum frame, and
wherein the developing device is supported by the drum frame so as to be movable relative to the photosensitive drum.

28. The cartridge according to claim 27, further comprising:
a seal member positioned around the collected toner receiving port, the seal member sealing a portion between the toner pipe and the developing device.
